(19) United States
(12) Patent Application Publication
(10) Pub. No.: US 2012/0305118 A1
(43) Pub. Date: Dec. 6, 2012

(54) AUTOMATIC FAUCET AND WATER DISCHARGING DEVICE

(75) Inventors: Nobuaki Itazu, Koto-ku (JP); Ryousuke Yoshitani, Koto-ku (JP)

(73) Assignee: LIXIL CORPORATION, Tokyo (JP)

(21) Appl. No.: 13/514,854

(22) PCT Filed: Dec. 10, 2010
(86) PCT No.: PCT/JP2010/072274

§ 371 Date: Aug. 15, 2012

(30) Foreign Application Priority Data
Dec. 10, 2009 (JP) 2009-281028
Dec. 10, 2009 (JP) 2009-281029
Dec. 10, 2009 (JP) 2009-281031
May 31, 2010 (JP) 2010-125401
May 31, 2010 (JP) 2010-125402

(51) Int. Cl. F16K 21/00

(52) U.S. Cl. 137/801

(57) ABSTRACT

An automatic faucet, which has a water spout member and a sensor placed in a front end section of a water spout pipe and automatically ejects water from the spout member by the detection by the sensor. The water spout pipe has a shape, in which a section of the front end side is directed forward and obliquely downward with respect to a user. The water spout member and the sensor are axially inserted into the water spout pipe from the obliquely downward opening of the tip of the water spout pipe, and the sensor is disposed above the water spout member. The water spout member is disposed in a state where the front end face thereof is positioned to the inside of the water spout pipe than the front end face of the sensor.

### TECHNICAL FIELD

The present invention relates to an automatic faucet, which automatically discharges water based on the detection of a detection target using a sensor.

Meanwhile, the present invention relates to an automatic faucet, which automatically discharges water from a water spout based on the detection of the detection target using an optical sensor including a light emitting section and a light receiving section, and specifically, to technical means for suppressing an erroneous detection due to the attachment of water droplets. Meanwhile, the present invention relates to an automatic faucet, specifically, to technical means for suppressing an erroneous detection due to the attachment of water droplets to the sensor. Meanwhile, the present invention relates to a water discharging device including a water spout pipe, specifically, to a water discharging device which includes a cylindrical water spout member mounted to the inside of a tip section of a water spout pipe and forms the water spout of a tip of a water path in the water spout pipe, and a discharging end member for controlling the pattern of the discharged water discharged from the water spout. Meanwhile, the present invention relates to an automatic faucet, which automatically discharges water from the water spout based on the detection using the sensor.

### BACKGROUND ART

Previously, an automatic faucet has been widely used which is provided with a water spout member and a sensor in a front end section (a tip section) of a water spout pipe and discharges water from a water spout member by the detection of a detection target such as a hand using a sensor.

For example, Patent Literature 1 mentioned below discloses this type of automatic faucet.

In the automatic faucet disclosed in Patent Literature 1, a portion of the front end (a tip) of the water spout pipe extends horizontally, an opening face of an opening of the front end side faces downward, and a water spout member and a sensor are placed in an upper position of the opening.

However, in the case of an automatic faucet, the opening of the front end side of the water spout pipe is in a position which is not viewed by a user, and thus there is a problem that where the water is discharged from is not understood by the user, and it is difficult to use the faucet.

Further, since the water spout member extends substantially downward, the water stream of the discharged water from the water spout member becomes a nearly directly downward facing water stream, and in addition, the sensor also similarly faces downward. Thus, expansion of the water stream of the discharged water (the spouted water) is easily superimposed on the detection area of the sensor, and there is a risk of the sensor erroneously detecting the water stream as the detection target.

In addition, since the sensor faces downward, there is a risk of erroneously detecting a basin surface such as a wash basin positioned on the lower side as the detection target.

Meanwhile, Patent Literature 2 discloses an automatic faucet, in which a portion of a front end side of a water spout pipe has a downward shape of an oblique front toward the side a user, an opening is formed, in which an opening face intersects with a pipe axis and forms an oblique downward face, on the front end face of the water spout pipe, and a water spout member and a sensor are axially inserted in the water spout pipe by the opening.

In the case of the automatic faucet disclosed in Patent Literature 2, there is an advantage that the user can easily know where the water is discharged from, but since the water spout member projects further forward than the sensor, there is a concern that the expansion of the water stream discharged from the water spout member may be easily superimposed on the detection area of the sensor. At the same time, the sensor may erroneously detect the water stream discharged from the water spout member as the detection target.

Further, since the water spout member is projected forward than the sensor, there is a problem in that, when cleaning a sensor window, the water spout member to be is disturbed, and thus the cleaning is difficult.

In addition, since the water spout member is projected from the opening of the tip face of the water spout pipe, there is a problem in that the water spout member is seen from a user and causes a user to feel a sense of cumbersome.

Patent Literature 3 similarly discloses an automatic faucet, in which a portion of a front end side of a water spout pipe has an oblique downward shape with respect to a side of a user, and a water spout member and a sensor from an opening of a front end face are placed in the water spout pipe in an inserted state.

In the automatic faucet of Patent Literature 3, since the entire water spout member is placed in an back-side than the opening of the front end face of the water spout pipe in the inserted state, when a user washes their hands or the like, the water spout member is not appeared to the eyes, and the sense of cumbersome is not felt, unlike to the disclosure of Patent Literature 2. However, in the automatic faucet, since the water spout member is projected forward and is positioned with respect to the sensor, the cleaning is also difficult when cleaning the sensor window. In addition, there is a problem in that, if the detection area of the sensor is not narrowly limited, the sensor may erroneously detect the water stream discharged from the water spout member.

Further, previously, an automatic faucet in a public toilet, a lavatory or the like has been widely used which has an optical sensor (hereinafter, simply referred to as a sensor) including a light emitting section and a light receiving section in a water spout pipe and detects a detection target such as a hand of a user by the sensor, and thus automatically discharges water from the water spout based on the detection.

Generally, the sensor determines that there is a detection target when a light receiving amount is greater than the set threshold value.

In such an automatic faucet, previously, in many cases, the light emitting section and the light receiving section is provided in the tip section of the water spout pipe.

However, in the automatic faucet of the related art, a light emitting element such as an LED emitting the light as the light emitting section and the light receiving element such as a photodiode and a phototransistor as the light receiving section have been placed in the tip section of the water spout pipe, a sensor circuit, which includes a light emitting drive circuit for emitting the light using the light emitting element and a photoelectric conversion circuit for converting the light received by the light receiving element into an electric signal to perform the signal processing, has been provided in the tip section of the water spout pipe in a state of being connected to the light emitting element and the light receiving element.

For example, Patent Literature 4 and Patent Literature 2 disclose an automatic faucet, which is formed by providing the light emitting element, the light receiving element, and the sensor including the sensor circuit in the tip section of the water spout pipe.

However, as disclosed in Patent Literature 4 and Patent Literature 2, in the case of the automatic faucet provided with the light emitting element, the light receiving element, and the sensor including the sensor circuit in the tip section of the water spout pipe, a shape of the tip section of the water spout pipe has been inevitably increased, and there is a problem in that the size of the overall water spout pipe along with this, and the design is degraded.

Previously, an automatic faucet has been known, in which a sensor main body including the light emitting element, the light receiving element, and the sensor circuit is placed outside the water spout pipe, an optical fiber on the light emitting side guiding the light from the light emitting element of the sensor main body and an optical fiber on the light receiving side guiding the reflected light from the detection target to the light receiving element are passed inside an inner part of the water spout pipe up to the tip section of the water spout pipe, so that the light emitting section is formed in the tip section of the optical fiber on the light emitting side and the light receiving section is formed in the tip section of the optical fiber on the light receiving side.

For example, Patent Literature 5 discloses an automatic faucet using this type of optical fiber.

In this manner, in a case where the sensor main body is placed outside of the water spout pipe, the optical fibers are passed inside the water spout pipe up to the tip section of the water spout pipe, and the light emitting section and the light receiving section are configured in the tip sections of the optical fibers, it is possible to reduce the size of the water spout pipe compared to a case of providing the sensor main body in the tip section of the water spout pipe.

However, in the case of forming the automatic faucet as below, that is, in a case where the automatic faucet is configured so that the portion of the front end side of the water spout pipe has an oblique forward and downward shape with respect to the side of a user, an opening, in which the opening face forms a face intersecting with the pipe axis and facing obliquely downward on the front end face of the water spout pipe, the light emitting section, the light receiving section and the water spout members are inserted from the opening into the front end section of the water spout pipe in the pipe axis direction in a state of being held by the holding member, each of the light emitting section, the light receiving section and the water spout member is faced forward and obliquely downward, the light emitting section and the light receiving section are positioned above the water spout member. When the water spout of the front end of the water spout member is mounted in a state of being positioned in back-side of a light emitting window of the light emitting section and a light receiving window of the light receiving section of the water spout pipe, regardless of the fact that the light emitting section, the light receiving section and the water spout face in the same direction, the water stream discharged from the water spout changes the direction of the flow to the downward flow by the effect of gravity after the discharging. Thus, there is an advantage that the detection area by the light emitting section and the light receiving section and the discharged water stream is not overlapped each other.

Meanwhile, in a case of positioning the light emitting window and the light receiving window on the front side of the water spout, as shown in FIG. 41, when water droplets W are attached to the lower side to cover over a light emitting window 1200, light from a light emitting section 1204 is refracted downward by the water droplets W and is hit with the water stream S from a water spout 1202, and then the reflected light from the water stream S is easily received by the light receiving section.

Specifically, in a case where the water stream from the water spout is a foam flow with a mixed air, the foam flow has a color similar to white, and thus the reflected light from the water stream is easily received by the light receiving section.

In this case, there is a risk that the sensor erroneously detects the discharged water from the automatic faucet, and even when a user does not hold out his hand, water is continuously discharged.

Specifically, in a case where the light emitting section and the light receiving section, that is the light emitting window on the light emitting side and the light receiving window on the light receiving side are installed near the water spout member by constituting the light emitting section and the light receiving section in the tip section of the optical fiber, the erroneous detection is easily generated.

Additionally, as a related art of the present invention, Patent Literature 6 discloses an automatic faucet, in which, in order to suppress the erroneous detection due to the attachment of the water droplets, an edge of the opening of the lower side of the detection sensor of the water spout cover covering the detection sensor is formed so that an angle formed between the edge and the front face of the detections sensor forms an obtuse angle, and even if the water droplets are applied to the edge of the opening, the water droplets is not attached thereto and flow down along the slope of the edge

However, the opening face of the tip of the water spout is not installed to be tube-axially inserted from the opening intersecting with the pipe axis in the state where the detection sensor and the water spout member are held on the holding member. Further, the detection sensor and the water spout substantially face directly downward, and the edge of the obtuse angle shape of the water spout cover is not provided to suppress the attachment of the water droplets to the detections sensor and is provided to make the water droplets attached to the edge drop to suppress that the water droplets are attached to the edge itself. Accordingly, the automatic faucet is different from the present invention.

Meanwhile, in the related art, an automatic faucet in a public toilet, a lavatory or the like has been widely used, in which the water spout has the sensor (the optical sensor) including the light emitting section and the light receiving section, the sensor detects the detection target such as a hand of a user or the like, and water is automatically discharged based on the detection.

Generally, the sensor determines that there is a detection target when a light receiving amount is greater than the set threshold value.

In such an automatic faucet, in the related art, in many cases, the light emitting section and the light receiving section have been provided in the tip section of the water spout pipe.

However, in the automatic faucet of the related art, a light emitting element such as an LED emitting the light as the light emitting section and the light receiving element such as a photodiode and a phototransistor as the light receiving section have been placed in the tip section of the water spout pipe, a sensor circuit, which includes a light emitting drive circuit for emitting the light using the light emitting element and a photoelectric conversion circuit for converting the light received by the light receiving element into an electric signal to perform the signal processing, has been provided in the tip section of the water spout pipe in a state of being connected to the light emitting element and the light receiving element.

For example, Patent Literature 4 and Patent Literature 2 disclose an automatic faucet, which is formed by providing the light emitting element, the light receiving element, and the sensor including the sensor circuit in the tip section of the water spout pipe.

However, as disclosed in Patent Literature 4 and Patent Literature 2, in the case of the automatic faucet provided with the light emitting element, the light receiving element, and the sensor including the sensor circuit in the tip section of the water spout pipe, a shape of the tip section of the water spout pipe has been inevitably increased, and there is a problem in that the entire water spout pipe is increased along with this, and the design is degraded.

In the related art, an automatic faucet has been known, in which a sensor main body including the light emitting element and the light receiving element and the sensor circuit is placed outside the water spout pipe, an optical fiber on the light projection side guiding the light from the light emitting element of the sensor main body and an optical fiber on the light receiving side guiding the reflected light from the detection target to the light receiving element are passed inside an inner part of the water spout pipe up to the tip section of the water spout pipe, and the light emitting section is formed in the tip section of the optical fiber on the light emitting side and the light receiving section is formed in the tip section of the optical fiber on the light receiving side.

For example, Patent Literature 5 discloses an automatic faucet using this type of optical fiber.

In this manner, in a case where the sensor main body is placed outside of the water spout pipe, the optical fibers are passed inside the water spout pipe up to the tip section of the water spout pipe, and the light emitting section and the light receiving section are configured in the tips of the optical fibers, it is possible to reduce the size of the water spout pipe compared to a case of providing the sensor main body in the tip section of the water spout pipe.

However, regardless whether or not the light emitting section and the light receiving section in the sensor are configured in the light emitting element, the light receiving element, or the tip section of the optical fiber on the light emitting side and the tip section of the optical fiber on the light receiving side, in the related art, the problems as below had been caused when detecting the detection target using the sensor.

That is, as shown in FIG. 42(i), when the water droplets W are attached in a shape to continue from a light emitting window 2204 for emitting the light from a light emitting section 2200 toward the detection target to a light receiving window 2206 for receiving the reflected light from the detection target by a light receiving section 2202, the light from the light emitting section 2200 is reflected by the water droplets W and is received by the light receiving section 2202, the water droplet W is erroneously detected as the detection target, and as a result, water may be discharged.

In Patent Literature 5 mentioned below, in order to suppress the erroneous detection due to the attachment of the water droplets, there is a disclosure, in which, as shown in FIG. 42(ii), all of the light emitting section 2200 and the light receiving section 2202 are covered by a window cover 2208 formed of a light-transmitting resin material from the outside, and the portion of the front side of the light emitting section 2200 and the light receiving section 2202 of the window cover 2208 are used as a common window 2205 for the light emitting and the light receiving. A convergence convex lens 2210 and a limiting convex lens 2212 are provided in the state where the optical axis coincides with the light emitting section 2200 and the light receiving section 2202.

However, if they is covered by the window cover 2208 formed by the light transmitting material connected from the light emitting section 2200 to the light receiving section 2202 in this manner, and the common window 2205 for the light emitting and the light receiving is formed in the window cover 2208, in case that other contaminations such as the toothpaste and the like are attached to the front face (the lower face) of the window 2205, the light from the light emitting section 2200 is reflected by that and enters the light receiving section 2202 through the window cover 2208. As a result, there is a risk that the sensor erroneously detects.

Meanwhile, in the related art, generally, a water discharging device of the automatic faucet, which automatically discharges water from the water spout based on the detection of a hand or the like using the sensor, includes the water spout pipe, a water supply tube inserted into the water spout pipe to guide the supplied water to the water spout, a cylindrical water spout member which is mounted to the inside of the tip section of the water spout pipe in a state of being connected to the water supply tube and forms the water spout of the tip of the water path in the water spout pipe, and then the discharging end member is placed in the water spout, make the water stream pass therethrough, and controls the discharging pattern of the discharged water from the water spout.

In this type of water discharging device, in the related art, the discharging end member has been housed in a dedicated cylindrical housing, this has been held in the housing in the anti pull-out state in the discharging direction of the discharged water, and the housing has been fixed to the water spout member by fixing means such as screw, and then the water spout member has fixed to the water spout pipe by a fixing tool such as a pin, and thus the discharging end member, the housing and the water spout member have been attached to the water spout pipe.

Patent Literature 7 discloses this type of water discharging device as below.

FIG. 43 shows a specific example thereof.

In FIG. 43, reference 3200 is a water spout pipe, reference numeral 3202 is a water supply tube inserted into the inner section thereof, reference numeral 3204 is a water spout member connected to the water supply tube 3202, and reference numeral 3206 is a discharging end member that controls the discharging pattern of the discharged water.

Reference numeral 3208 is a dedicated cylindrical housing of the discharging end member 3206, the discharging end member 3206 is inserted into the housing 3208 and is held by the housing 3208 in the discharging direction of the discharged water in the anti pull-out state.

As shown in FIG. 43(B), the housing 3208 is provided with a female screw section 3210, and the female screw section 3210 of the housing 3208 is screwed to a male screw section of the water spout member 3204. Further, the water spout member 3204 is fixed and attached to the water spout pipe 3200 by the screw 3212 as the fixing member.

Patent Literature 2 also discloses the water discharging device of the same configuration as below.

However, in such a water discharging device, in the tip section of the water spout pipe, there is a need for three components of the discharging end member 3206, the housing 3208, and the water spout member 3204, the number of the required component is large. Further, when the components are attached to the water spout pipe 3200, there is a need to perform the fixing between the housing 3208 and the water spout member 3204 and the fixing between the water spout member 3204 and the water spout pipe 3200 in at least two individual locations. Accordingly, the structure is complicated and the working process is many when assembling. Additionally, when dissembling the components to perform the maintenance work, there is a need for the fixing release and the re-fixing in plural locations. Accordingly, many times are consumed in the maintenance work.

Although the cases of the automatic faucet have been described as above, the problems are commonly generated in the water discharging device which includes the discharging end member and the water spout member in the tip section of the water spout pipe.

Meanwhile, in the related art, an automatic faucet in a public toilet, a lavatory or the like has been widely used, which has a sensor that projects the light from the light projection section provided in the water spout pipe and receives the reflected light from the detection target such as a hand of a user by the light receiving section provided in the water spout pipe to detect the detection target, and then automatically discharges water based on the detection using the sensor.

Generally, the sensor determines that there is a detection target when a light receiving amount is greater than the set threshold value.

In such an automatic faucet, in the related art, in many cases, the light projection section and the light receiving section have been provided in the tip section of the water spout pipe.

However, in the automatic faucet of the related art, a light emitting element such as an LED emitting the light as the light projection section and the light receiving element such as a photodiode and a phototransistor as the light receiving section have been placed in the tip section of the water spout pipe, a sensor circuit, which includes a light emitting drive circuit for emitting the light using the light emitting element and a photoelectric conversion circuit for converting the light received by the light receiving element into an electric signal to perform the signal processing, has been provided in the tip section of the water spout pipe in a state of being connected to the light emitting element and the light receiving element, so that a shape of the tip section of the water spout pipe has been inevitably increased, and there is a problem in that the size of the overall water spout pipe is increased along with this, and the design is degraded.

The problem is also caused in a case of providing the sensor main body including the light emitting element, the light receiving element and the sensor circuit in the tip section of the water spout pipe, as well as a case of providing them in the water spout pipe in other locations.

Thus, it is considered that the sensor main body including the light emitting element, the light receiving element and the sensor circuit on the outside of the water spout pipe, the cord of the optical fiber is extended from the sensor main body and is passed into the water spout pipe, the tip section of the optical fiber on the light projection side and the tip section of the optical fiber on the light receiving side are positioned in the tip section of the water spout pipe, respectively, and the light projection section and the light receiving section are configured in the tip sections. In this manner, it is possible to avoid the situation where the water spout pipe is greatly increased by the sensor main body including the light emitting element, the light receiving element and the sensor circuit.

Herein, in the case of providing the sensor main body on the outside of the water spout pipe, normally, the sensor main body is housed in a function section box accommodating a component such as an electromagnetic valve, in which the sensor main body is placed in a lower space of an attachment base such as a counter.

For example, Patent Literature 8 mentioned below discloses an automatic faucet of a shape, in which the sensor main body including the light emitting element, the light receiving element, and the sensor circuit is placed in a control box (a function section box) at a lower side of a washing counter, the cord of the optical fiber is extended therefrom and is inserted into the water spout pipe.

Additionally, in the disclosure of Patent Literature 8, the light projection section and the light receiving section are placed in a middle section of the water spout pipe in a pipe axial direction, and the cord of the optical fiber is extended to the inner section of the water spout pipe up to the middle position.

However, in such a case, as specifically described in Patent Literature 8, the cord of the optical fiber is exposed at the lower space of the attachment base such as the counter between the water spout pipe and the function section box, and when attaching the faucet and during maintenance work after attaching, during cleaning or the like, the exposed portion of the cord may be erroneously stretched.

In this manner, when the exposed portion of the cord is stretched, the optical fiber is damaged in the water spout pipe by the tensile force, or the tensile force is applied to the tip section of the optical fiber attached to the water spout pipe, that is, the light projection section and the light receiving section, and then they may be away from the normal position or may be damaged, so that the function as the sensor is damaged.

The similar problems are also caused in a case where the sensor main body including the light emitting element, the light receiving element, and the sensor circuit is provided in the tip section of the water spout pipe or the like and the cord of the electric wire is extended from the sensor main body along the inner portion of the water spout pipe, is also extended from the water spout pipe to the lower space of the attachment base and is connected to the function section box placed in the lower space.

When applying the tensile force to the cord of the electric wire exposed at the lower space of the attachment base such as the counter, force is applied to the connection section of the electric wire to the sensor main body in the inner section of the water spout pipe. Accordingly, the electric wire is cut in the connection section or the sensor main body connected thereto may be damaged.

Additionally, as the related art of the present invention, Patent Literature 9 mentioned below discloses that an inner bush made of a rubber is mounted to the cord of the electric wire by the press fitting, and the cord of the electric wire to an attachment hole of the casing by the inner bush and the outer bush attach.

However, the related art intends to seal the gap between the cord and the attachment hole by the inner bush and the outer bush in a liquid-tight manner and is different from the present invention in the object. Additionally, the cord inserted to the cord insertion port of the center section of the inner bush made of the rubber is axially restricted in both of the inner side and the outer side of the casing by the frictional force between the cord and the insertion port inner face, and thus it is different from the present invention.

Further, although Patent Literature 10 mentioned below discloses that the fitting tool mounted to the cord of the electric wire is fitted and fixed to a fixing seat of the cover of the faucet main body in FIG. 6 of Patent Literature 10, when tensile force is applied to the cord of the electric wire to the outside of the cover, the fixing tool is detached from the fixing seat of the cover, and the tensile force is applied to the electric wire cord of the cover inner section. Thus, the problem of the present invention cannot be solved, and it is different from the present invention.

### CITATION LIST

### Patent Literature

[Patent Literature 1] JP-UM-A-2-97449
[Patent Literature 2] JP-A-2002-70096
[Patent Literature 2] JP-A-2007-262727
[Patent Literature 4] JP-A-2009-133103
[Patent Literature 5] JP-A-11-36395
[Patent Literature 6] JP-UM-A-62-26474
[Patent Literature 7] JP-A-2002-275969
[Patent Literature 8] JP-A-6-146356
[Patent Literature 9] JP-A-2000-224740
[Patent Literature 10] JP-A-10-183701

### SUMMARY OF INVENTION

### Technical Problem

The present invention is based on such circumstances, and an object thereof is to provide an automatic faucet that is easily used by a user, is to be easily cleaned when cleaning the sensor window, and is able to suppress the sensor from erroneously detecting the water stream discharged from the water spout member.

Further, another object of the present invention is to provide an automatic faucet having good-looking, in which the front end section of the water spout pipe does not give a user the sense of cumbersome.

Further, an object of the present invention is to provide an automatic faucet, in which the water droplets are attached to the lower side to extend over the light emitting window. Accordingly, it is possible to suppress the optical sensor from erroneously detecting the discharged water stream as the detection target.

Further, an object of the present invention is to provide an automatic faucet including the sensor which can suppress the erroneous detection due to the attachment of the water droplets.

Further, an object of the present invention is to provide a water discharging device, in which the number of the required component is smaller than that of the related art, the structure is also simple, and the work during assembling and during maintenance can be easily performed.

Further, an object of the present invention is to provide an automatic faucet, which can suppress the tensile force from being applied to the cord in the inner section of the water spout pipe, and can appropriately suppress the light projection section and the light receiving section provided in the cord or the water spout pipe from being damaged, even when the tensile force of the detachment direction is applied to the section exposed to the outside of the water spout pipe of the optical fiber or the cord of the electric wire configuring a part of the sensor extended to the inner section of the water spout pipe.

### Solution to Problem

According to a first aspect of the present invention, there is provided an automatic faucet, which is provided with a water spout member and a sensor in a front end section that is a tip section of a water spout pipe, and which discharges water from the water spout member due to a detection of a detection target using a sensor, wherein the water spout pipe has a shape, in which a portion of the front end side is directed forward and obliquely downward with respect to a user and an opening, which has an opening face intersecting with a pipe axis and forms a face facing obliquely downward, is formed on the front end face of the water spout pipe, and wherein the water spout member and the sensor are inserted from the opening into the water spout pipe in a pipe axial direction, and the sensor is installed above the water spout member in a state where the front end face of the water spout member is positioned on the back-side of the water spout pipe than the front end face of the sensor.

According to a second aspect of the present invention, in the first aspect of the present invention, the water spout member is placed in the water spout pipe so that the front end face of the water spout member is positioned on the back-side than the front end face of the water spout pipe.

According to a third aspect of the present invention, an automatic faucet, which is provided with a light emitting section and a light receiving section of an optical sensor, and a water spout member in a front end section that is a tip section of a water spout pipe, and which automatically discharges water from a water spout due to a detection of a detection target using an optical sensor, wherein the water spout pipe has a shape, in which a portion of the front end side is directed forward and obliquely downward with respect to a user and an opening, which has an opening face intersecting with a pipe axis and forms a face facing obliquely downward, is formed on the front end face of the water spout pipe, and wherein the light emitting section, the light receiving section and the water spout member are inserted from the opening into the inner section of the front end section of the water spout pipe in a pipe axial direction in a state of being held by the holding member, each of the light emitting section, the light receiving section and the water spout member is extended to forward and obliquely downward, the light emitting section and the light receiving section are positioned above the water spout member, and the water spout of the front end of the water spout member is mounted in a state of being positioned in back-side of the water spout pipe than the light emitting window of the light emitting section side and the light receiving window of the light receiving section side, and wherein a lower section leading to the light emitting window of the front face of the holding member is a face having a shape, which shifts to the back-side of the water spout pipe, as separating from the light emitting window toward the water spout side.

According to a fourth aspect of the present invention, in the third aspect, a lower section leading to the light receiving window of the front face of the holding member has a face having a shape which shifts to the back-side of the water spout pipe as separating from the light receiving window toward the water spout side and.

According to a fifth aspect of the present invention, in one of the third aspect and the fourth aspect, the light emitting window and the light receiving window are positioned to be projected forward from the front face of the holding member.

According to a sixth aspect of the present invention, in one of third to fifth aspects, the light emitting section is configured by a tip section of the optical fiber on the light emitting side, and the light receiving section is configured by a tip section of the optical fiber on the light receiving side.

According to a seventh aspect of the present invention, an automatic faucet, which is provided with a sensor which has a light emitting section and a light receiving section, and which automatically discharges water from a water spout based on a detection of a detection target using the sensor, wherein a light emitting window for emitting light from the light emitting section toward the detection target and a light receiving window for receiving a reflected light from the detection target by the light receiving section are independently provided on the front face of an installation section of the light emitting section and the light receiving section to be separated from each other, and wherein a portion of the front face of the installation section between the light emitting window and the light receiving window is a concave section having a recessed shape to the back-side as an opposite direction of a detection direction using the sensor than a flat standard face.

According to an eighth aspect of the present invention, in the seventh aspect, the light emitting window and the light receiving window are provided to be projected to a front side of the detection direction from a standard face in the front face of the installation section.

According to an eighth aspect of the present invention, in one of the seventh and eight aspects, the water spout pipe has a shape, in which a section of the front end side close to a user is directed forward and obliquely downward with respect to a user, the water spout member is inserted from the opening of the tip of the water spout pipe into the water spout pipe in a state of setting the front face forming the front face of the installation section to face obliquely downward, and in a state of positioning the front face to the back-side than a front end and a upper section of the water spout pipe, and wherein in a position adjacent to the end of the water spout pipe and the upper section, the light emitting window and the light receiving window are placed on the upper section of the front face of the water spout member.

According to a tenth aspect of the present invention, in the ninth aspect, wherein the water spout pipe has a shape, in which a section of the front end side close to a user is directed forward and obliquely downward with respect to a user, the water spout member is inserted from the opening of the tip of the water spout pipe into the water spout pipe in a state of setting the front face forming the front face of the installation section to face obliquely downward, and in a state of positioning the front face to the back-side than a front end and a upper section of the water spout pipe, and wherein in a position adjacent to the end of the water spout pipe and the upper section, the light emitting window and the light receiving window are placed on the upper section of the front face of the water spout member.

According to an eleventh aspect of the present invention, in one of the ninth and tenth aspects, a water stream passing member, which is positioned in the tip of the water path to pass the water stream and controls a form of the discharged water, is held inside the water spout member forming a cylindrical shape, and wherein the water stream passing member sucks the air from an air suction hole, involves the air in the passing water flow and discharges the air as a foam flow of a mixed air bubble from the water spout, and wherein the concave section communicates with the air suction hole.

According to a twelfth aspect of the present invention, s water discharging device comprising: (a) a water spout pipe; (b) a cylindrical water spout member, which is mounted to an inside of a tip section of the water spout pipe and forms a water spout of a tip of a water path in the water spout pipe; and (c) a discharging end member, which is placed in the water spout to pass a water stream and controls a water discharging pattern from the water spout, wherein the discharging end member is inserted into the device by using the cylindrical water spout member as a housing, and each of the discharging end member and the water spout member is fixed to the water spout pipe by a common fixing member.

According to a thirteenth aspect of the present invention, in the twelfth aspect, a fitting shaft section is provided in the fixing member, a fixing hole passing through a pipe wall is provided in the water spout pipe and a fitting hole fitting the fitting shaft section is provided in the discharging end member and the water spout member in a state of overlapping each other in a direction of passing through the fixing hole and penetrating through the pipe wall of the water spout pipe, and wherein the fitting shaft section of the fixing member is fitted from the outside of the water spout pipe through the fixing hole to the fitting holes of the water spout member and the discharging end member, respectively, and the discharging end member and the water spout member are fixed to the water spout pipe.

According to a fourteenth aspect of the present invention, in the thirteenth aspect, the fixing hole has a hole diameter greater than the fitting holes of the discharging end member and the water spout member, and the fixing member is provided with a circumferential wall section of an outer diameter corresponding thereto, and wherein the fixing member is attached to the water spout pipe in a state of fitting the circumferential wall section to the fixing holes.

According to fifteenth aspect of the present invention, in the fourteenth aspect, in a position facing each other in the radial direction of the circumferential wall section, claw sections caught to an edge section of the fixing hole is provided in a shape projecting in the radial direction, wherein one claw section is fixed to the circumferential wall section, the other claw section is provided in the tip of an elastic piece, and then an elastic claw is configured by the elastic piece and the claw section of the tip, and wherein a claw section of the elastic claw is caught to the end section due to an elastic deformation of the elastic piece by the pushing of the water spout pipe.

According to a sixteenth aspect of the present invention, in the fifteenth aspect, the fixing member is attached in a state where the pair of claw sections is positioned in a left-right direction when viewed from a front with respect to the water spout pipe.

According to a seventeenth aspect of the present invention, in one of the twelfth to sixteenth aspects, the water spout member has a cylindrical insertion section, and the insertion section is inserted into a flexible water supply tube arranged in the water spout pipe and is connected to the water supply tube.

According to an eighteenth aspect of the present invention, An automatic faucet, which is provided with a sensor that projects light from a light projection section provided in a water spout pipe and receives a reflected light from a detection target by a light receiving section provided in the water spout pipe to detect a detection target, and which automatically discharges water based on the detection of the detection target using the sensor, wherein an optical fiber or a cord of an electric wire configuring a part of the sensor is extended into the water spout pipe through an opening of a base end side of the water spout pipe, wherein, in the cord, an engagement convex section projecting from an outer face of the cord to the outside in a radial direction is provided in a fixed state, a receiving section, which brings the cord into contact with the engagement convex section through the opening in a direction of being detached from the water spout pipe, is provided in the water spout pipe, and then an anti pull-out mechanism is configured to receive tension of the detaching direction applied to the cord by the engagement convex section and the receiving section and stops the cord, and wherein the anti pull-out mechanism restricts the movement of the cord in the extraction direction, and allows the movement of the cord to separate the engagement convex section from the receiving section in an opposite direction.

According to a nineteenth aspect of the present invention, in the eighteenth aspect, an anti pull-out member separately formed from the water spout pipe is attached to an inner face of the water spout pipe, and the receiving section is formed of the anti pull-out member.

According to a twentieth aspect of the present invention, in the nineteenth aspect, a water supply tube guiding the supplied water to the water spout is provided in the water spout pipe, wherein a cord insertion port inserting the cord is provided in the receiving section of the anti pull-out member, and a tube insertion port inserting the water supply tube is provided in the anti pull-out member, and wherein the anti pull-out member positions the cord and the water supply tube in the radial direction by the cord insertion port and the tube insertion port.

According to a twenty-first aspect of the present invention, in the twentieth aspect, the cord insertion port and the tube insertion port are provided to be adjacent to each other, and the cord insertion port is configured so that a part of the side of the tube insertion port is partially formed as an opening section, and the cord insertion port and the tube insertion port are continued in the opening section.

According to a twenty-second aspect of the present invention, in one of the nineteenth to twenty-first aspects, the anti pull-out member has a ring shape having elastic deformability in the radial direction, wherein the anti pull-out member is to be pushed into the water spout pipe in a diameter-reduced state and is attached to the inner face of the water spout pipe in a diameter-expanded state after the pushing.

According to a twenty-third aspect, in one of the nineteenth to twenty-second aspects, the anti pull-out member is housed in the inner section of the water spout pipe in a state of not being exposed to the outer section of the water spout pipe.

### Advantageous Effects of Invention

As mentioned above, in the present invention, the shape of the water spout pipe has a shape, in which the front end side is directed forward and obliquely downward with respect to a user, an opening is formed, in which the opening face intersects with the pipe axis and forms a face facing obliquely downward on the front end face of the water spout pipe, the water spout member and the sensor are inserted from the opening into the water spout pipe in the pipe axial direction, and the front end face of the water spout pipe is installed in a state of being positioned on the back-side of the water spout pipe than the front end face of the sensor. According to the present invention, an outlet of the discharged water is easily seen from a user, a usability of the faucet is to be good. Further, the front end face of the water spout member is positioned on the back-side of the water spout pipe than the front end face of the sensor. Accordingly, there is an advantage that, when cleaning the sensor window, the water spout member is not disturbed, and the cleaning of the sensor window is easy.

Further, the water spout member faces forward and obliquely downward in the water spout pipe, a direction of flow of the discharged water from the water spout member is changed to the downward flow by an action of gravity force after the discharging, and the sensor installed above the water spout member faces forward and obliquely downward. Thus, it is possible to make the detection area does not overlap the discharged water stream while widely securing the detection area (at a high angle) of the sensor, so that it is possible for a user to detect the put hand over a wide range while suppressing the sensor from erroneously detecting the water flow.

Further, since the sensor faces obliquely downward, it is possible to solve the problem that the sensor erroneously detects the basin surface.

In the present invention, the water spout member can be placed in the water spout pipe so that the front end face of the water spout member is positioned on the back-side than the front end face of the water spout pipe, that is, all of the water spout member can be placed in the inner section of the water spout pipe (the second aspect).

In such a case, there is no problem that the water spout member is projected from the front end face of the water spout pipe and is seen from a user to feel a sense of cumbersome, the water spout member is to be disappeared from a user, and the appearance of the water spout pipe front end section can be made good.

According to the third aspect, the lower section of the front face of the holding member continued to the light emitting window has the face having the shape, which shifts to the back-side of the water spout pipe, as separating from the light emitting window toward the water spout side. According to the present invention, even if the water droplets are attached to the lower side in the form of covering the light emitting window, the water droplets is lead toward back-side of the water spout pipe to be wet and spread along the face of the shape, which shifts to the inside of the water spout pipe formed on the front face of the holding member continued to the light emitting window and is retracted backward.

Accordingly, it is possible to suppress that light from the light emitting section is refracted downward of the discharged water stream side by the water droplets attached to the lower side of the light emitting window and the sensor erroneously detects the discharged water stream.

Further, in a case where the water droplets are attached to the lower side in the form of covering the light receiving window, the reflected light from the lower side separated from the original light receiving area is received by the light receiving section, and reflected light from the discharged water stream is easily received by the light receiving section.

Accordingly, it is preferable that the lower section of the front face of the holding member continued to the light receiving window according to the fourth aspect also has a face having a shape which shifts to the back-side of the water spout pipe, as separating from the light receiving window toward the water spout side.

Further, it is preferable that the light emitting window and the light projection window are positioned in a position projected forward from the front face of the holding member (the fifth aspect).

As a result, the water droplets hardly set on the light emitting window and the light receiving window, so that it is possible to more effectively suppress that the water droplets are attached to the lower side in the form of partly being applied to the light emitting window and the light receiving window.

As will be apparent from the description mentioned above, the present invention is more effectively applied to a case where the light emitting section is configured by the tip section of the optical fiber on the light emitting side and the light receiving section is configured by the tip section of the optical fiber on the light receiving side, respectively (the sixth aspect).

Further, in the present invention, the automatic faucet, which has the sensor including the light emitting section and the light receiving section, and automatically discharges water from the water spout based on the detection of the detection target using the sensor, can be configured by the form as, which is described below.

That is, the water spout pipe has an inner hollow goose neck shape that is inverted U-shaped, in which the upper section thereof is directed forward with respect to a user, and a flexible water supply tube is inserted into the water spout pipe from the opening of the tip of the water spout pipe.

Further, the water spout pipe has a through opening in a position near the center of the seating section to seat in an attachment base such as a counter, and the water supply tube can be extracted to the outside of the water spout pipe through the through opening,

On the rear face being the backside of the water supply tube of the inner face of the water spout pipe, in an upper part separated from the bottom section, a guide section is provided which guides the lower end of the water supply tube inserted from the opening of the tip of the water spout pipe toward the through opening, and is projected toward the water supply tube side.

The guide section has a longitudinal groove in a center section in the left-right direction when viewed from the front, a left section of the groove forms a left guide section, and the right section forms a right guide section.

The left and right guide sections are configured to a form, in which the guide face of the water supply tube side includes a longitudinal guide face which increases the projection amount from the water spout pipe inner face to the water supply tube side as proceeding downward, and a transverse guide face which is formed along the longitudinal guide face and decreases the projection amount as proceeding toward the groove.

Further, according to the seventh aspect, the light emitting window and the light receiving window are provided on the front face of a installation section (the front section of the installation section) of the light emitting window and the light receiving window, and the portion of the installations section front face between the light emitting window and the light receiving window is a concave section of a recessed shape to the back-side being the opposite direction of the detection direction using the sensor than a flat standard face.

According to the present aspect, even if the water droplets are temporarily attached to the light emitting window and the light receiving window, the water droplets instantly enter the concave section between the light emitting window and the light receiving window, the water droplets can shift thereto, so that it is possible to suppress the water droplets from being continuously attached to the light emitting window and the light receiving window.

The water droplets attached to the light emitting window and the light receiving window, that is, the water droplets attached to the front face of the installation section of the light emitting section and the light receiving section cover the light emitting window and the light receiving window in the shape of being expanded to the front face of the installation section, when the front face of the installation section is the continuous flat face. However, by providing the concave section according to the present invention, the water droplets enter and the water droplets can shift by the use of the property, in which the water droplets tend to expand along an inner face of the concave section and, the property, in which the water droplets tend to shrink by the surface tension.

As a result, the erroneous detection of the sensor due to the attachment of the water droplets can be effectively suppressed, so that it is possible to suppress the problem that the sensor erroneously detects the water droplets as the detection target and thus water is discharged.

Further, in the present invention, since the light emitting window and the light receiving window are independently provided to be separated from each other, as shown in FIG. 42 (ii), it is also possible to solve the problem that the toothpaste and other contaminations are attached to the front face of the window cover, the light from the light emitting section is reflected by the window cover inner section and is transmitted to the light receiving window, and the light generated the erroneous detection is received by the light receiving section.

In the present invention, the light emitting window and the light receiving window can be provided to be projected to the front-side than the standard face on the front face of the installation section (the eighth aspect).

In this manner, the water droplets hardly put on the light emitting window and the light receiving window, and the erroneous detection due to the attachment of the water droplets can be reliably suppressed.

In the present invention, the water spout member is mounted to the inside of the tip section of the water spout pipe, the light emitting section and the light receiving section are installed in the water spout member, the light emitting window and the light receiving window are provided on the front face of the water spout member as the front face of the installation section, and the section between the light emitting window and the light receiving section of the front face of the installation section can be the concave section (the ninth aspect).

In this manner, the recess may be formed on a part of the front face of the water spout member, and the recess, that is, the concave section can be easily formed.

In the ninth aspect, the water spout pipe has the shape, in which the section of the front end side close to a user is directed forward and obliquely downward with respect to a user, the water spout member is inserted from the opening from the tip of the water spout pipe into the water spout pipe in a state of setting the front face of the water spout member forming the front face of the installation section to face obliquely downward, and in a state of positioning the front face thereof to be placed the back-side than the front end and the upper section of the water spout pipe, and in a position adjacent to the front end and the upper section of the water spout pipe, the light emitting window and the light receiving window can be placed on the upper section of the front face of the water spout member (the tenth aspect).

In this manner, the section of the front end side of the water spout pipe has the shape which is directed forward and obliquely downward with respect to a user, and the front end and the upper section of the water spout pipe is projected obliquely downward with respect to a user than the front face of the water spout member, so that the water spout member and the peripheral members thereof is hidden by the front end and the upper section of the water spout pipe and is not to be seen from a user, the sense of cumbersome due to the appearance seen from a user is not caused, and the tip section of the appearance of the water spout pipe can be good.

Meanwhile, in such a case, compared to a case where the front end and the upper section of the water spout pipe are not projected, the water droplets are easily attached to the light emitting window and the light receiving window.

In a case where the front end and the upper section of the water spout pipe are projected forward to form canopy, even when the water droplets are attached to the front face (the front face of the installation section) of the water spout member facing forward and obliquely downward, the water droplets flow down and are naturally and easily removed from the light emitting window and the light receiving window.

Thus, when the front end and the upper section of the water spout pipe is projected like the canopy on the upper side adjacent to the light emitting window and the light receiving window, the water droplets are attached to the canopy, so that the water droplets are easily held. As a result, the light emitting window and the light receiving window are easily covered by the water droplets.

According to the present invention, by the concave section formed in the portion between the light emitting window and the light receiving window, it is possible to effectively suppress the water droplets from remaining in a state of being attached to the light emitting window and the light receiving window.

That is, according to the ninth aspect, it is achieved that the appearance of the water spout pipe front end section can be secured and the erroneous detection due to the attachment of the water droplets can be suppressed, at the same time.

Next, according to the eleventh aspect, the water stream passing member making the water stream flow and defining the form of the discharged water is held inside the water spout member forming the cylindrical shape, the water stream passing member sucks the air from the air suction member to involve air in the water stream, and discharges water as the foam stream with a mixed air bubble from the water spout, and the concave section communicates with the air suction hole. According to the fifth aspect, the water droplets shifted to the concave section can be sucked from the air suction hole and can be discharged from the water spout via the water stream passing member. Accordingly, the water droplets removed to the concave section is removed to suppress the hindrance of the shifting of the next water droplets attached to the concave section.

Further, in the present invention, the automatic faucet, which has the sensor including the light emitting section and the light receiving section, and automatically discharges eater from the water spout based on the detection of the detection target using the sensor, can be configured by the form as, which is described below.

That is, the water spout pipe has an inner hollow goose neck shape that is a inverted U-shaped, in which the upper section thereof is directed forward with respect to a user, and a flexible water supply tube is inserted into the water spout pipe from the opening of the tip of the water spout pipe.

Further, the water spout pipe has a through opening in a position near the center of the seating section seating in an attachment base such as a counter, and the water supply tube can be extracted to the outside of the water spout pipe through the through opening,

On the rear face being the backside of the water supply tube of the inner face of the water spout pipe, in an upper part separated from the bottom section, a guide section is provided which guides the lower end of the water supply tube inserted from the opening of the tip of the water spout pipe toward the through opening, and is projected toward the water supply tube side.

The guide section has a longitudinal groove in a center section in the left-right direction when viewed from the front, a left section of the groove forms a left guide section, and the right section forms a right guide section.

The left and right guide sections are configured to a form, in which the guide face of the water supply tube side includes a longitudinal guide face which increases the projection amount from the water spout pipe inner face to the water supply tube side as proceeding downward, and a transverse guide face which is formed along the longitudinal guide face and decreases the projection amount as proceeding downward, toward the groove.

Further, according to the twelfth aspect, the discharging end member is configured so that the cylindrical water spout member is inserted into the inner section as the housing, each of the discharging end member and the water spout member is fixed to the water spout pipe by the common fixing member. According to the present invention, there is no need for a housing which holds the discharging end member in the inner section in the anti pull-out state required in the related art, the number of the required component can be reduced, each of the discharging end member and the water spout member is fixed to the water spout pipe by the common fixing member. Thus, they can be fixed to the water spout pipe in single point, the structure can be simplified, and the workability during assembling work and during maintenance work is good, so that it is possible to easily perform the assembling and the maintenance work.

Herein, the discharging end member can be inserted and fitted to the water spout member in the fitted state.

In the present invention, a fitting shaft section is provided in the fixing member, a fixing hole passing through a pipe wall is provided in the water spout pipe and a fitting hole fitting the fitting shaft section is provided in the discharging end member and the water spout member in a state of overlapping each other in a direction of passing through the fixing hole and penetrating through the pipe wall of the water spout pipe, the fitting shaft section of the fixing member is fitted from the outside of the water spout pipe through the fixing hole to the fitting holes of the water spout member and the discharging end member, respectively, and thus they are fixed to the water spout pipe (the thirteenth aspect).

In this manner, by simply fitting the fitting shaft section of the fixing member to each fitting hole of the water spout member and the discharging end member, they can be easily fixed and attached to the water spout pipe by the common fixing member.

Further, in the present invention, the fixing member can be attached to the water spout pipe so that the fixing hole has the diameter greater than the respective fitting holes of the discharging end member and the water spout member, the fixing member is provided with a circumferential wall section having the corresponding outer diameter, and the circumferential wall is fitted to the fixing hole (the fourteenth aspect).

In this manner, the fixing strength of the fixing member itself with respect to the water spout pipe can be strengthened, and the fixing strength with respect to the water spout pipe of the discharging end member and the water spout member can be increased.

Further, the fixing member can also be fixed to the water spout pipe to not be projected from the water spout pipe.

According to the fifteenth aspect, in positions facing each other in the radial direction of the circumferential wall section in the fixing member, claw sections caught to an edge section of the fixing hole is provided in a shape projecting in the radial direction, and then one claw section is provided to the circumferential wall section in the fixed state, and the other claw section is provided in the tip of an elastic piece, an elastic piece is configured by the elastic piece and the claw section, and a claw section of the elastic claw configured to be caught to the end section due to an elastic deformation of the elastic piece by the pushing of the water spout pipe.

According to the fifteenth aspect, the fixing member can be easily fixed to the water spout pipe by small force, so that it is possible to increase the fixing force of the fixing member to the water spout pipe and the reliability of the fixing, so that it is possible to avoid the anxiety that the fixing member is detached from the water spout pipe.

For example, unlike the description mentioned above, when the elastic claws are provided in each of the position facing in the radial direction in the circumferential wall section, and the respective elastic claws are temporarily pushed into the fixing holes along with the elastic deformation of the respective elastic pieces, the resistance of the elastic deformation due to the pair of elastic pieces is increased, there is a need for strong force when pushing, and the fixing work to the water spout pipe is difficult.

Meanwhile, when the claw section of the elastic claw is caught by the edge section of the fixing hole while elastically deforming the elastic piece by small force, and the catch of the respective claw sections to the edge sections of the fixing holes is reduced, the fixing member attached to the water spout pipe is easily detached from the water spout pipe.

When avoiding the anxiety that the fixing member is detached from the water spout pipe to increase the catch of the claw section in each elastic claw to the fixing hole edge section, when pushing the elastic claw, there is a need for strong force as much, and the workability of the pushing work is degraded similarly to above.

On the contrary, according to the fixing structure of the fifteenth aspect, the fixing member can be easily fixed to the water spout pipe by weak force, and after the fixing, the detachment of the fixing member from the water spout pipe can be effectively suppressed.

In the fixing structure of the fifteenth aspect, the claw section of the fixing side is firstly caught by the edge section of the fixing hole while the fixing member being obliquely to the fixing hole, and then, the elastic claw section in the opposite direction in the radial direction is pushed in the fixing hole, the elastic claw is pushed in the fixing hole along with the elastic deformation, the claw section of the elastic claw in the pushed position is caught by the edge section of the fixing hole, and the fixing member is suppressed from detaching from the water spout pipe.

In the fixing structure of the fifteenth aspect, when catching the one claw section provided in the fixed state to the edge section of the fixing hole, there is no need for strong pushing force, and thus it is possible to greatly secure the catching margin of the claw section to the fixing hole edge section.

Meanwhile, since the elastic claw may be provide only in one side in the radial direction, by reducing the catching margin of the claw section in the elastic claw to the fixing hole edge section, the pushing of the elastic claw can be easily performed by small force. Despite, in the fifteenth aspect, since the catching margin of the claw section of the fixing side and the claw section of the elastic claw with respect to the entire fixing hole edge section can be greatly secured, the fixing member can be easily fixed to the water spout pipe, and also it is possible to appropriately suppress the fixing member from being detached from the water spout pipe.

In this case, the fixing member can be attached in the state where the pair of claw sections is positioned in the left-right direction when viewed from the front side with respect to the water spout pipe (the sixteenth aspect).

In this manner, it is possible to suitably suppress that the discharging end member and the water spout member rattle with respect to the water spout pipe in the front-back direction (the pipe axial direction) when viewed from a user. Thus, the relative assembling position in the front-back direction of the discharging end member and the water spout member with respect to the water spout pipe can be preferably positioned in a preset suitable position.

In the present invention, the water spout member can be connected to the water supply tube by inserting the cylindrical insertion section into the flexible water supply tube arranged in the water spout pipe (the seventeenth aspect).

According to the eighteenth aspect, in the optical fiber or the cord of the electric wire configuring a part of the sensor, the engagement convex section protruding outward in the radial direction from the outer face is provided in a fixed state, the receiving section bringing the engagement convex section into contact in a direction detaching the cord outward from the water spout pipe through the opening of the base end side of the water spout pipe is provided in the inner section of the water spout pipe, the anti pull-out mechanism for stopping the cord by receiving the tension of the extraction direction applied to the cord is configured by the engagement convex section and the receiving section, and the anti pull-out mechanism restricts the cord in the detachment direction, the engagement convex section is configured as the one direction restriction allowing the movement of the code to separate from the receiving section in the opposite direction.

Accordingly, even if the cord is stretched outward such as the lower side of the water spout pipe, it is possible to suppress tensile strength from being applied to the cord of the water spout pipe inner section by the action of the anti pull-out mechanism.

When the tensile force is applied to the cord in the outside of the water spout pipe, the engagement section provided in the cord comes into contact with the receiving section provided in the inner section of the water spout pipe in the tension direction of the cord, and the tensile force is received by the engagement convex section and the receiving section, and thus it is suppressed that the tensile force is applied to the section extended to the water spout pipe inner section of the cord.

Accordingly, even when the cord is stretched on the outside of the water spout pipe, force is not applied to the connection section of the cord of the water spout pipe, so that it is possible to effectively suppress that the optical fiber and the electric wire are cut or damaged in the connection section or the light projection section and the light receiving section attached to the water spout pipe or the sensor main body is dislocated or detached.

In the present invention, the anti pull-out mechanism has one directivity which restricts the movement of the cord only one direction of the axial direction.

That is, the movement of the cord is restricted on the outside such as the downside of the water spout pipe, the engagement convex section is allowed to be separated from the receiving section in the opposite direction, and the movement of the cord in the opposite direction is allowed.

That is, in the water spout pipe inner section, a free state is obtained, in which the cord is freely movable in the opposite direction (in regard to the direction facing the water spout) of the extraction direction to the outside of the water spout pipe in the back-side of the engagement convex section.

This thing has the meaning as below.

When the light projection section and the light receiving section attached to the water spout pipe, the sensor main body or the like need the component exchange and the maintenance during breakdown, it is preferable to detach the component from the water spout pipe on the front face side of the attachment base such as the counter through the opening of the tip side being the opposite side of the base end side of the water spout pipe.

Otherwise, in a case where the light projection section, the light receiving section, the sensor main body or the like are attached to the water spout pipe, when performing the component exchanging, the maintenance or the like of the water spout member or the like, it is preferable to detach them together with the water spout member or the like from the water spout pipe.

In this manner, it is possible to easily perform the maintenance work such as the component exchange with good workability.

When the movement of the cord extended to the inner section of the water spout pipe is restricted in the waters spout pipe toward the tip side of the water spout pipe, the light projection section, the light receiving section, the sensor main body, the water spout member or the like can not be detached to the outside of the water spout pipe.

In the present invention, the cord extended into the inner section of the water spout pipe is allowed to be moved toward the tip section of the water spout pipe, and thus the maintenance of each component can be easily performed at good workability.

In the present invention, the water spout pipe is provided with the anti pull-out member formed as a separate body to the inner face of the water spout pipe, and the receiving section can be provided in the anti pull-out member (the nineteenth aspect).

In this manner, the receiving section can be simply provided in the inner section of the water spout pipe.

In the present invention, the water supply tube guiding the supplied water is provided in the inner section of the water spout pipe, the cord insertion port inserting the cord is provided in the receiving section of the anti pull-out member, the tube insertion port inserting the water supply tube is provided in the anti pull-out member, and the cord and the water supply tube can be positioned in the radial direction by the cord insertion port and the tube insertion port (the twentieth aspect).

In this manner, the anti pull-out member can be appropriately positioned together with the cord extended to the inner section of the water spout pipe and the water supply tube in the inner section of the water spout pipe, so that it is possible to place the cord and the water supply tube in the inner section of the water spout pipe in a correctly objective position and to accommodate them in the inner section of the water spout pipe.

In this case, the cord insertion port and the tube insertion port are provided to be adjacent to each other, the cord insertion port is partially formed in the section of the side of the tube insertion port as the opening section, and make the cord insertion port and the tube insertion port communicate with each other in the opening section (the twenty-first aspect).

In this manner, the cord can be simply inserted into the cord insertion port through the opening section and can enter into the inserted state. Meanwhile, in a state of inserting the water supply tube into the tube insertion port, the water supply tube becomes a wall, so that it is possible to suitably suppress the cord in the cord insertion port from being detached from the cord insertion port to the tube insertion port side through the opening section.

According to the twenty-first aspect, in order to suppress the detachment of the cord from the opening, it is possible to avoid the necessity of providing a separate closing member in the opening section. Thus, there is no problem that the component number is increased due to the provision of the closing member and the number of the process for the assembling thereof is increased.

Further, since the water supply tube acts as a wall, the cord is suppressed from being detached from the opening section. Thus, it is possible to widely form the opening section. Accordingly, it is possible to easily perform the fitting work of the cord to the cord insertion port through the opening section.

That is, since it is suppressed that the cord fitted to the cord insertion port is detached from the opening section, it is also considered to narrow the width of the opening section. However, in this case, it is difficult to perform the work of fitting the cord into the cord insertion port through the opening section.

In the twenty-first aspect, the water supply tube acts as the wall suppressing that the cord is detached from the cord insertion port through the opening section. Thus, the opening section can be widely formed. Accordingly, it is more easily perform the work of fitting the cord into the cord insertion port through the opening section.

The anti pull-out member is formed in a ring shape having elastic deformability in the radial direction, and the anti pull-out member is to be pushed into the inner section of the water spout pipe in the radius-decreased state and can be attached to the inner face of the water spout pipe in the radius-increased state after the pushing (the twenty-second aspect).

In this manner, the cord is inserted into the anti pull-out member on the outside such as the downside of the water spout pipe in advance, the anti pull-out member is subjected to the radius decrease and elastic deformation and is pushed into the inner section of the water spout pipe, and the anti pull-out member can be easily attached to the inner face of the water spout pipe. At the same time, the cord can be inserted into the anti pull-out member in the water spout pipe, and the workability of the cord to the anti pull-out member can be easily performed.

In a case where the cord insertion port and the tube insertion port are provided in the anti pull-out member according to the twentieth aspect, the cord and the water supply tube can be inserted into the cord insertion port and the tube insertion port of the anti pull-out member on the outside such as the downside of the water spout pipe in advance. At the same time as the assembling of the anti pull-out member to the water spout pipe inner face, the cord and the water supply tube can be inserted to the anti pull-out member in the water spout pipe, and the insertion work of the cord and the water supply tube to the anti pull-out member can be easily performed.

In the cases, the anti pull-out member can be housed in the inner section of the water spout pipe and can be housed in the outer section of the water spout pipe in the non-exposed state (the twenty-third aspect).

When the anti pull-out member is contacted in the exposed section to the outside of the water spout pipe, in some cases, the anti pull-out member may be detached from the water spout pipe. However, if the anti pull-out member is housed in the inner section of the water spout pipe according to the twenty-third aspect, such a disadvantage can be avoided.

### BRIEF DESCRIPTION OF DRAWINGS

FIG. 1 is an overall view of an automatic faucet according to an embodiment of the present invention.

FIG. 2 is a longitudinal cross-sectional view of a water spout pipe in the embodiment.

FIG. 3 is a cross-sectional view of a major parts of a tip section of the water spout pipe in the embodiment.

FIG. 4 is a view of a sensor and a holding member in the embodiment.

FIG. 5 is an explanatory view that shows an advantage of the present embodiment compared to a comparative example.

FIG. 6 is an overall view of an automatic faucet according to an embodiment of the present invention.

FIG. 7 is a longitudinal cross-sectional view of the water spout pipe in the embodiment.

FIG. 8 is a cross-sectional view of major parts of the tip section of the water spout pipe of the embodiment.

FIG. 9 is a view of a water spout unit in the embodiment.

FIG. 10 is a view of major parts of the tip section of the water spout pipe in the embodiment.

FIG. 11 is an enlarged view of major parts of the water spout unit in the embodiment.

FIG. 12 is an explanatory view of an operation of the embodiment.

FIG. 13 is a view of a comparative example for explaining the advantage of the embodiment.

FIG. 14 is a view that shows a guide section of an inner section of the water spout pipe in the embodiment together with a comparative example.

FIG. 15 is a view that shows a form example of an insertion section of an optical fiber and an insertion port corresponding thereto together with a comparative example.

FIG. 16 is an overall view of the automatic faucet according to an embodiment of the present invention

FIG. 17 is a longitudinal cross-sectional view of the water spout pipe in the embodiment.

FIG. 18 is a cross-sectional view of major parts of the tip section of the water spout pipe of the embodiment.

FIG. 19 is a view of a water spout unit in the embodiment.

FIG. 20 is a view of major parts of the tip section of the water spout pipe in the embodiment.

FIG. 21 is an enlarged view of major parts of the water spout unit in the embodiment.

FIG. 22 is a view that shows a guide section of an inner section of the water spout pipe in the embodiment together with a comparative example.

FIG. 23 is a view that shows a form example of an insertion section of an optical fiber and an insertion port corresponding thereto together with a comparative example.

FIG. 24 is an overall view of the automatic faucet, which includes a water discharging device according to an embodiment of the present invention.

FIG. 25 is a longitudinal cross-sectional view of the water spout pipe in the embodiment.

FIG. 26 is a cross-sectional view of major parts of the tip section of the water spout pipe of the embodiment.

FIG. 27 is a view of a water spout unit in the embodiment.

FIG. 28 is a perspective view that shows a state before assembling a discharging end member and a water spout member to the water spout pipe in the embodiment.

FIG. 29 is a view, in which the state shown in FIG. 28 is viewed from a bottom face side.

FIG. 30 is a single item view of a fixing member in the embodiment.

FIG. 31 is a view that shows an assembling order of the fixing member to the water spout pipe in the embodiment.

FIG. 32 is an overall view of an automatic faucet according to an embodiment of the present invention.

FIG. 33 is a longitudinal cross-sectional view of the water spout pipe in the embodiment.

FIG. 34 is a cross-sectional view of major parts of the tip section of the water spout pipe of the embodiment.

FIG. 35 is a view of a water spout unit in the embodiment.

FIG. 36 is a view that shows a state before assembling the water spout unit to the water spout pipe in the embodiment.

FIG. 37 is an enlarged view of major parts of a base end side of the water spout pipe in the embodiment.

FIG. 38 is a view that shows a state before inserting an anti pull-out member in the embodiment to the water spout pipe.

FIG. 39 is a cross-sectional view taken along a line i-i and a line ii-ii of FIG. 37.

FIG. 40 is a view of another embodiment of the present invention.

FIG. 41 is a view for explaining problems of an automatic faucet of the related art.

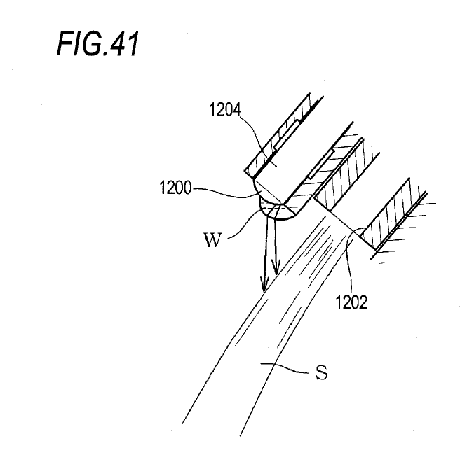

FIG. 42 is a view for explaining problems of an automatic faucet of the related art.

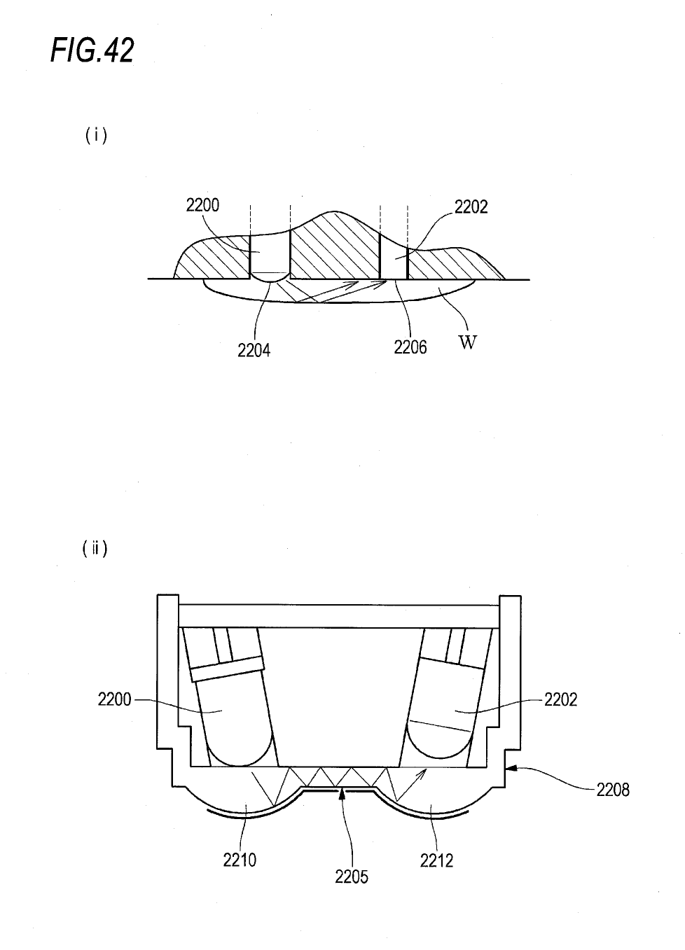

FIG. 43 is a view that shows an example of a water discharging device of the related art.

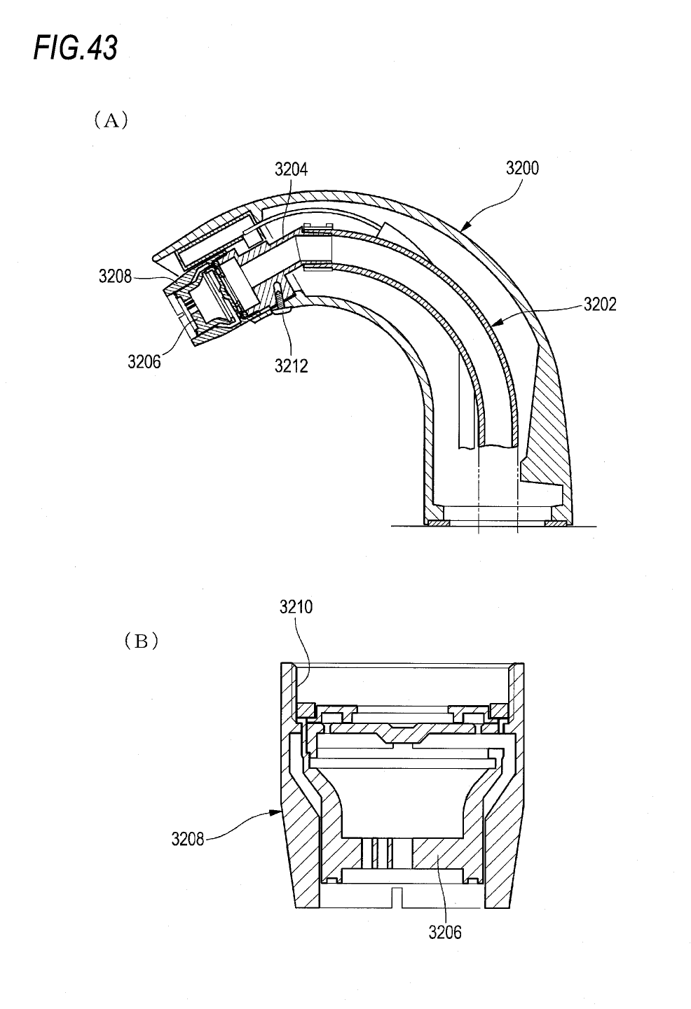

### DESCRIPTION OF EMBODIMENTS

Next, an embodiment of the present invention will be described in detail based on the drawings.

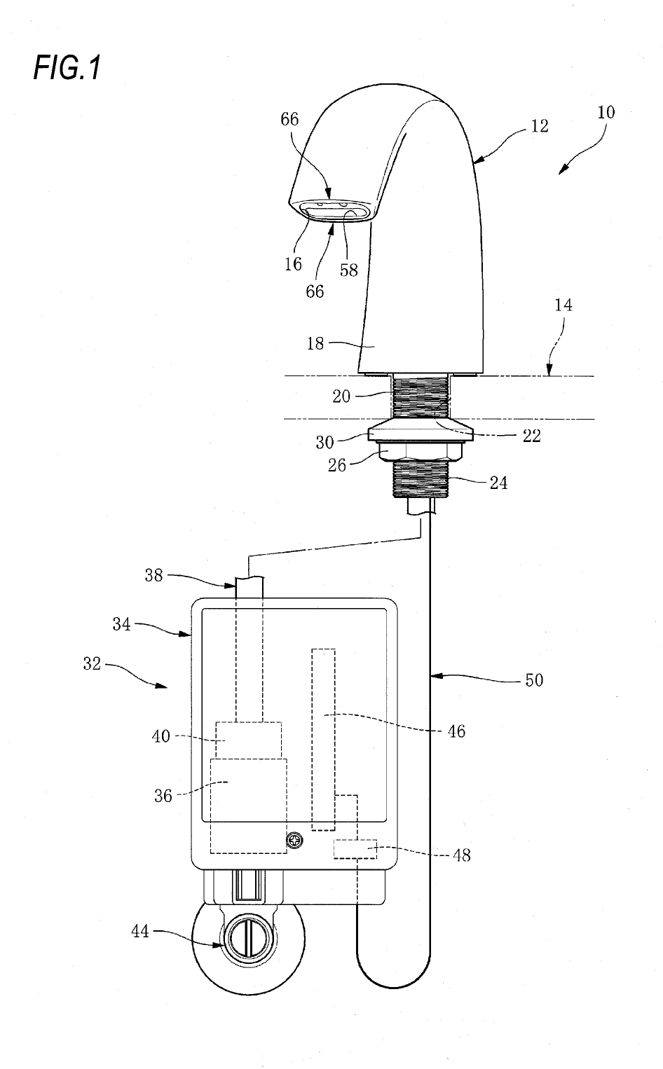

In FIG. 1, reference numeral 10 is an automatic faucet of the present embodiment, and reference numeral 12 is a water spout pipe in the automatic faucet 10. Herein, the water spout pipe 12 is made of a metal.

The water spout pipe 12 is installed in the form of standing from a counter (an attachment base) 14, an upper section thereof forms a inversed U-shaped goose neck with respect to a user.

That is, a portion of a front end side (a tip side) of a user side forms a shape facing forward and obliquely downward with respect to a user, and, an opening 16, in which an opening face intersects with a pipe axis at an angle close to a substantially right angle and an oblique downward face is formed on the front end face thereof.

Herein, the opening 16 has a substantially elliptical shape, in which the cross-sectional shape is long in the left-right direction when viewed from the front.

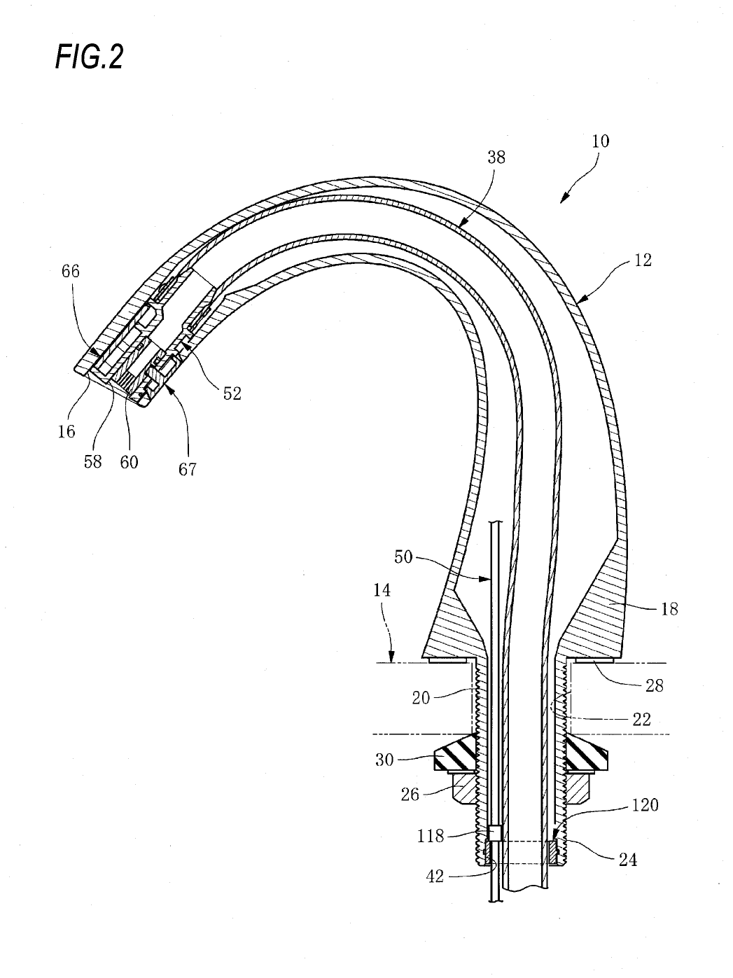

As shown in FIG. 2, the water spout pipe 12 integrally has a seating section 18 and an insertion pipe 20 extended downward from the seating section 18 at a base end side thereof.

The insertion pipe 20 is inserted into an attachment hole 22 of the counter 14 and is projected up to the downside of the counter 14, and a fixing nut 26 is screwed into a male screw section 24 provided on an outer circumferential face thereof.

The water spout pipe 12 seats the seating section 18 on the upper face of the counter 14, and is attached to the counter 14 in a state of interposing the counter 14 from both sides of the upper and lower sides via packing 28 and 30 by the seating section 18 and the fixing nut 26.

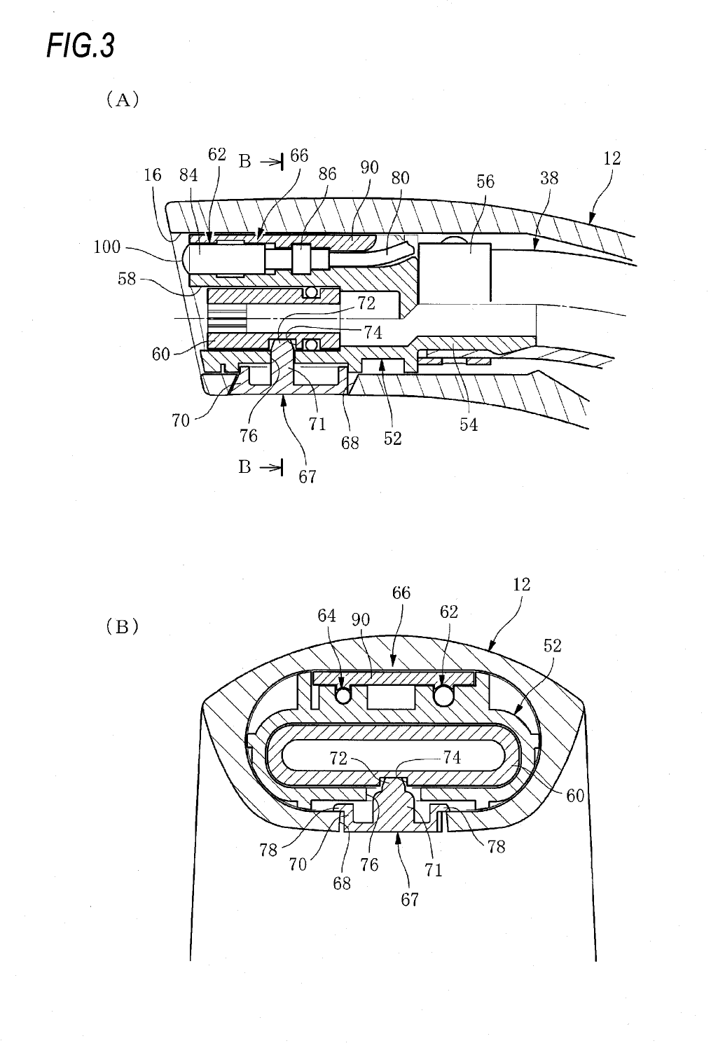

Meanwhile, as shown in FIG. 3, in the inner section of the front end section of the water spout pipe 12, a cylindrical holding member 52 holding a water spout member 60 described below in an inner section is housed.

In the present example, since the holding member 52 made of resin (herein, POM resin (polyacetal resin), a transverse cross-sectional shape forms a substantially elliptical shape corresponding to the shape of the front end section of the water spout pipe 12 as a whole.

The holding member 52 integrally includes an elliptical insertion section 54, and when the insertion section 54 is pressed against a water supply tube 38 mentioned below, the insertion section 54 is connected and fixed to the water supply tube 38 by a band-shaped clamping member 56 that clamps the water supply tube 38 from the outer circumferential face.

The water spout member 60 is inserted into the inner section of the holding member 52 and is held therein.

The water spout member 60 makes the water stream sent through the water supply tube 38 pass in the axial direction and discharges water from an opening of a front end (a left end of the drawing). Herein, the water spout member 60 rectifies and discharges the water stream.

The water spout member 60 can discharge water sent through the water supply tube 38 as the foam stream with the discharge pattern or as the shower stream or by other various discharge patterns.

The water spout member 60 has a cylindrical shape of a transverse cross-sectional shape that forms a flattened elliptical shape, and is inserted and placed in the inner section of the holding member 52 in a state, in which the front end face thereof is positioned on the back-side than the front end face of the water spout pipe 12 and the front end face of the holding member 52.

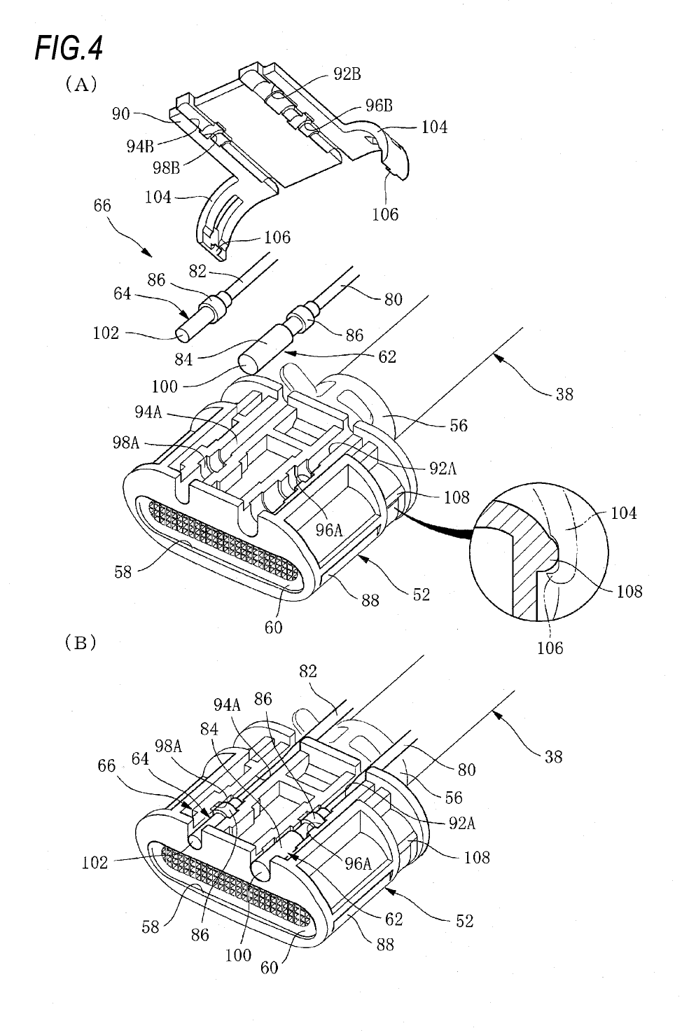

As shown in FIG. 4, the holding member 52 has a cover 90 that covers the main body section 88 and an upper face thereof. A light projection section 62 and a light receiving section 64 configuring a sensor (herein, an optical sensor, specifically, a sensor of an infrared light type or a reflection type) 66 for detecting a detection target such as a hand are fixed and held to the holding member 52 to be interposed between the main body section 88 and the cover 90.

In the present embodiment, the sensor 66 is installed in a state where the front end face there (the left end face of FIG. 3(A)) is positioned on the front side than the front end face of the water spout member 60. That is, the water spout member 60 is installed in the water spout pipe 12 so that the front end face of the water spout member 60 is positioned on the back-side of the water spout pipe 12 than the front end face of the sensor 66.

Further, the front end faces of the light projection section 62 and the light receiving section 64 configuring the sensor 66 are positioned in the same position in the pipe axial direction of the water spout pipe 12.

As will be apparent from FIG. 3, the sensor 66 is also placed in a state where the front end face thereof is positioned slightly on the back-side of the water spout pipe 12 than the front end face of the water spout pipe 12.

In the present embodiment, the water spout member 60 and the holding member 52 are commonly fixed to the fixing hole 68 with respect to the water spout pipe 12 by the fixing member 67 shown in FIG. 3.

The fixing member 67 is a member of a circular push button type, and integrally has a circular outer circumferential wall section 70, a first fitting convex section 71 standing from the center section thereof, and a second fitting convex section 72 of a small diameter projected upward from the upper end of the first fitting convex section 71. The fixing member 67 is attached to the water spout pipe 12 in a state of fitting the second fitting convex section 72 to a fitting hole 74 of the water spout member 60, fitting the first fitting convex section 71 to a penetrated fitting hole 76 of the holding member 52, and fitting the outer circumferential wall section 70 to the circular fixing hole 68 of the water spout pipe 12, and thus the fixing member 67 is fixed in a state of positioning the water spout member 60 and the holding member 52 in the water spout pipe 12.

Further, as shown in FIG. 3(B), the fixing member 67 has a pair of left-right claws 78 when viewed from front and is detached from the water spout pipe 12 by engaging the claws 78 with the edge section of the fixing hole 68.

In FIG. 4, reference numeral 80 is an optical fiber on the light projection side, reference numeral 82 is an optical fiber on the light receiving side, and the tip sections of the optical fiber 80 of the light projection side and the optical fiber 82 on the light receiving side configure the light projection section 62 and the light receiving section 64.

Further, the light projection section 62 is provided with a lens 84 for making the projected light have the directivity.

Further, the optical fibers 80 and 82 are integrally provided with annular convex sections 86 for fixing them to the holding member 52 in an axially positioned state.

Meanwhile, the main body section 88 of the holding member 52 is provided with deep holding grooves 92A and 94A extended in the axial direction of the optical fibers 80 and 82, the corresponding shallow holding grooves 92B and 94B are also provided on the side of the cover 90, and the optical fibers 80 and 82 are fitted and held to the holding grooves 92A, 92B, 94A and 94B.

The holding grooves 92A, 92B, 94A and 94B are provided with concave sections 96A, 96B, 98A, and 98B corresponding to the convex section 86 of the optical fibers 80 and 82, the optical fiber 80 is fixed and held to the holding member 52 in the axially positioned state by the concave and convex fitting between the convex section 86 and the concave sections 96A and 96B, and the optical fiber 82 is fixed and held to the holding member 52 in the axially positioned state by the concave and convex fitting between the convex section 86 and the concave sections 98A and 98B.

Additionally, the holding member 52 is formed with a pair of U-shaped recess sections in a front end thereof, and the light projection window 100 of the front end face of the light projection section 62 and the light receiving window 102 of the front end face of the light receiving section 64 are positioned therein.

Further, the cover 90 is integrally formed with a pair of curved elastic arms 104, and the cover 90 is assembled to the main body section 88 by elastically engaging the claws 106 of the tip of the pair of elastic arms 104 to the corresponding engagement protrusion 108 of the main body section 88.

In FIG. 1, reference numeral 32 is a main body function section placed below the counter 14, reference numeral 34 is a function section box of the main body function section 32, and an electromagnetic valve 36 is accommodated therein.

The electromagnetic valve 36 opens and closes the water supply path supplying the water from the water supply source pipe to the water spout member 60, and the lower end of the water supply tube 38 is connected to the electromagnetic valve 36 via the joint 40.

The water supply tube 38 is a member forming a part of the water supply path, is extended upward from the function section box 34, and enters from the opening 42 of the base end (a lower end) of the water spout pipe 12 shown in FIG. 2 to the inner section of the water spout pipe 12.

The water supply tube 38 extends the inner section of the water spout pipe 12 up to the front end section thereof.

Further, in this example, the water supply tube 38 has flexibility, and thus is formed by a polyurethane resin.

Additionally, in FIG. 1, reference numeral 44 indicates a stopcock.

In the inner section of the function section box 34, a control section 46 including a microcomputer as a main element, and a substrate 48 holding the light emitting element and the light receiving element are accommodated.

The control section 46 controls the operation of the electromagnetic valve 36, opens the electromagnetic valve 36 based on the detection of the detection target using the sensor 66, and closes the electromagnetic valve 36 when the sensor 66 does not detect the detection target.

The optical fiber 80 of the light projection side is extended from the light emitting element, and the optical fiber 82 on the light receiving side is extended from the light receiving element. The optical fibers 80 and 82 are extended from the function section box 34, and enter from the opening section 42 of the base end of the water spout pipe 12 into the inner section thereof.

The optical fibers 80 and 82 extend the inner section of the water spout pipe 12 up to the front end section.

Additionally, reference numeral 50 indicates a cord of the optical fiber which bundles two optical fibers 80 and 82 into one piece.

In the present embodiment, when the sensor 66 detects the detection target, normally, a hand provided by a user, the electromagnetic valve 36 is opened under the control using the control section 46, and water is automatically discharged from the water spout member 60 of FIG. 3.

Further, when a user retracts a hand and is away from the detection area by the sensor 66, the sensor 66 does not detect the hand, the electromagnetic valve 36 is closed under the control of the control section 46, and the water discharging from the water spout member 60 is stopped.

According to the present embodiment mentioned above, the shape of the section of the front end side of the water spout pipe 12 forms a shape facing forward and obliquely downward with respect to a user. Since the opening 16 of the front end face of the water spout pipe 12 has an opening face intersecting with the pipe axis and has an oblique downward face, the outlet of the discharged water is easily seen from a user, the using of the faucet can be good. Since the front end face of the water spout member 60 is positioned on the back-side of the water spout pipe 12 than the front end face of the sensor 66, when cleaning the sensor window, the water spout member 60 is not disturbed, and the cleaning of the sensor window is easy.

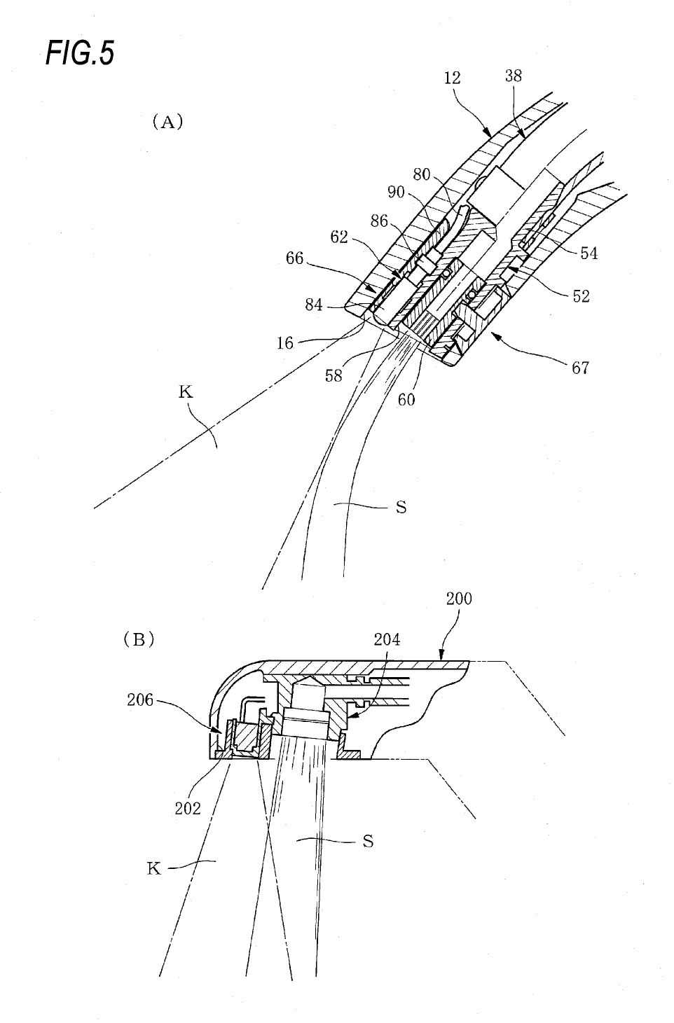

Further, for example, as shown in a comparative example (disclosed in Patent Literature 1) of FIG. 5(B), the section of the front end side of the water spout pipe 200 faces in the horizontal direction, the opening face of the opening 202 of the front end side faces downward, the water spout member 204 and the sensor 206 are placed in the upper position of the opening 202. Thus, the opening 202 of the front end side of the water spout pipe 200 is in a position which is not seen from a user, it is unclear that the discharged water is discharged from which location, and the water spout is not used, and in addition, the water stream S of the discharged water from the water spout member 204 becomes the water stream of substantially directly downward, and the sensor 206 also faces downward. Thus, the width of the discharged water stream S easily overlaps the detection area K of the sensor 206, and the sensor 206 erroneously detects the basin surface such as the washing bowl positioned below. However, according to the present embodiment, such problems can be solved.

In the present embodiment, the water spout member 60 is directed forward and obliquely downward in the water spout pipe 12, the water stream S discharged from the water spout member 60 changes the direction of the stream to the downward stream by the action of gravity force after the discharge, and the sensor 66 installed over the water spout member 60 is directed forward and obliquely downward. Thus, the detection area K cannot overlap the discharged water S while securing widely (at a high angle) if the detection area K of the sensor 66, and a user can detect the stretched had over a wide range while suppressing the sensor 66 from erroneously detecting the water stream S.

Further, since the sensor 66 faces obliquely downward, it is also possible to solve the problem that the sensor 66 erroneously detects the basin surface.

Further, in the present embodiment, since the water spout member 60 is placed in the water spout pipe 12 so that the front end face of the water spout member 60 is positioned on the back-side than the front end face of the water spout pipe 12, the water spout member 60 is not appeared to a user and not make the user feel a sense of cumbersome, the water spout member 60 cannot be seen from a user, and the appearance of the front end face of the water spout pipe 12 can be good.

The embodiment of the present embodiment has been described in detail as an example.

For example, the present invention can also be applied to a form of an automatic faucet, in which a sensor including a light emitting element, a light receiving element and a circuit connected thereto is placed in a front end section of the water spout pipe and can be applied to an automatic faucet, which includes a water spout pipe having other various form other than the above example. The present invention can be configured by the form added with various modifications in the scope without departing from the gist thereof.

Next, individual embodiments of the present embodiment will be described in detail based on the drawings.

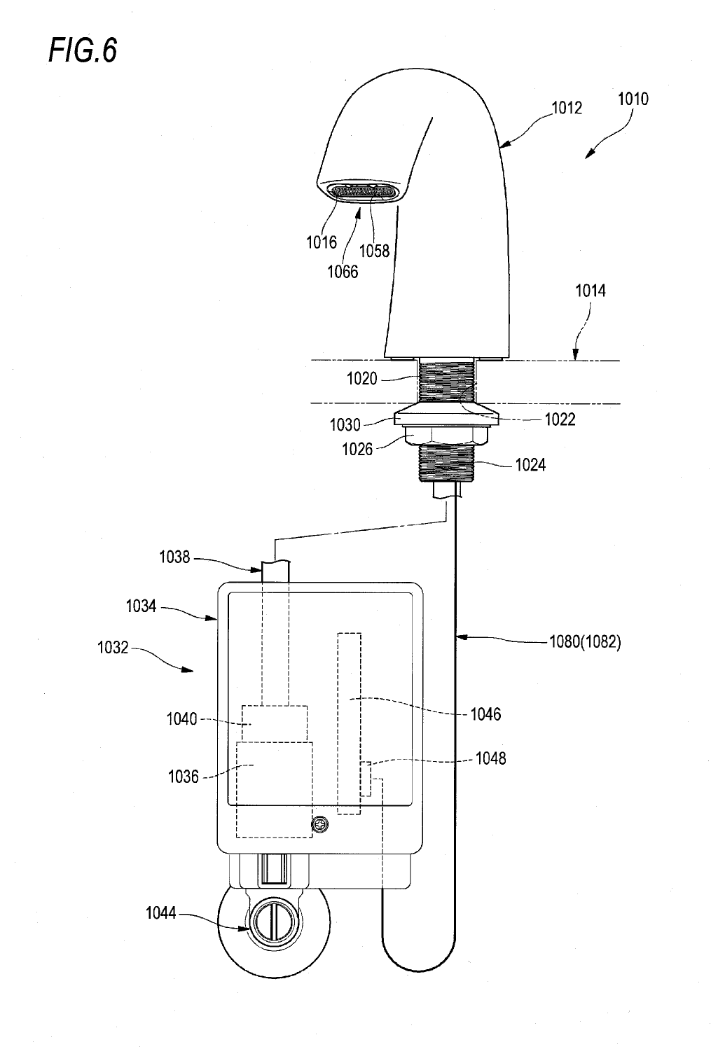

In FIG. 6, reference numeral 1010 is an automatic faucet of the present embodiment, and reference numeral 1012 is a water spout pipe in the automatic faucet. Herein, the water spout pipe 1012 is made of a metal or casting.

The water spout pipe 1012 is installed in the form standing from a counter (an attachment base) 1014, and an upper section forms a goose neck shape that is inverted U-shaped with respect to a user.

That is, a portion of the front end side (a tip side) of a user side forms a shape facing forward and obliquely downward with respect to a user, and the front end face thereof is formed with an opening 1016 which has an opening face intersecting with the pipe axis at an angle substantially similar to a right angle and a face facing obliquely downward.

Herein, the opening 1016 has a substantially elliptical shape, in which a transverse cross-section face shape thereof is long in the left-right direction when viewed from the front.

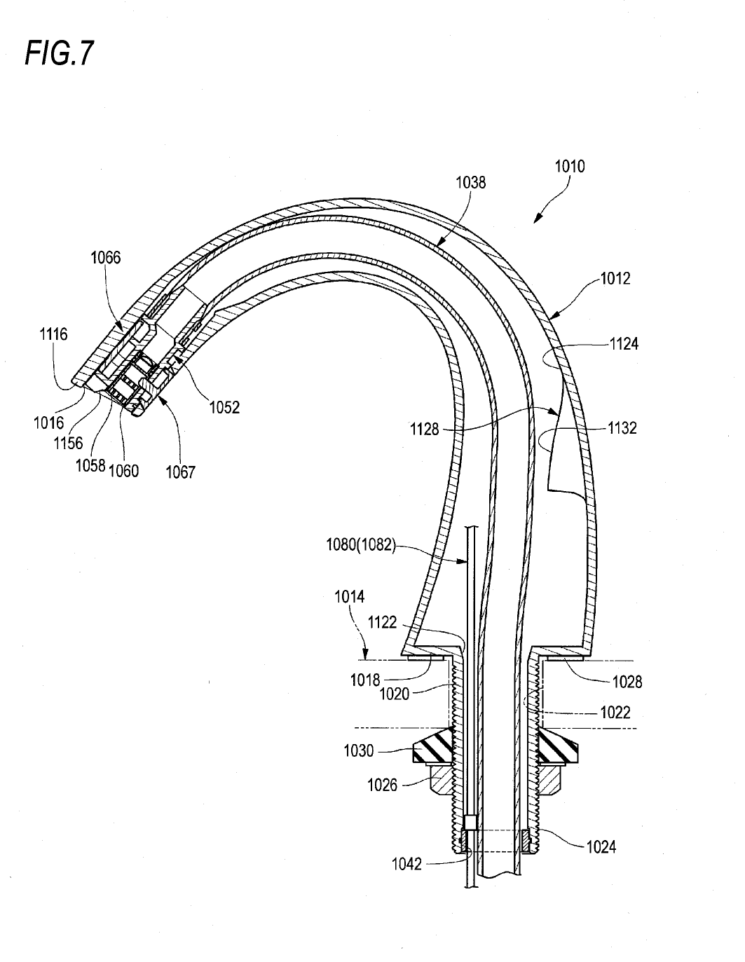

As shown in FIG. 7, the water spout pipe 1012 has a seating section 1018 on a base end side thereof, and an insertion pipe 1020 is extended downward from the seating section 1018.

The insertion pipe 1020 is inserted through an attachment hole 1022 of the counter 1014 and is projected to the lower side of the counter 1014, and a fixing nut 1026 is screwed into a male screw section 1024 provided on an outer circumferential face thereof.

The water spout pipe 1012 is set so that the seating section 1018 seats on the upper face of the counter 1014, and is attached to the counter 1014 in a state of interposing the counter 1014 from both sides of up and down via packings 1028 and 1030 by the seating section 1018 and the fixing nut 1026.

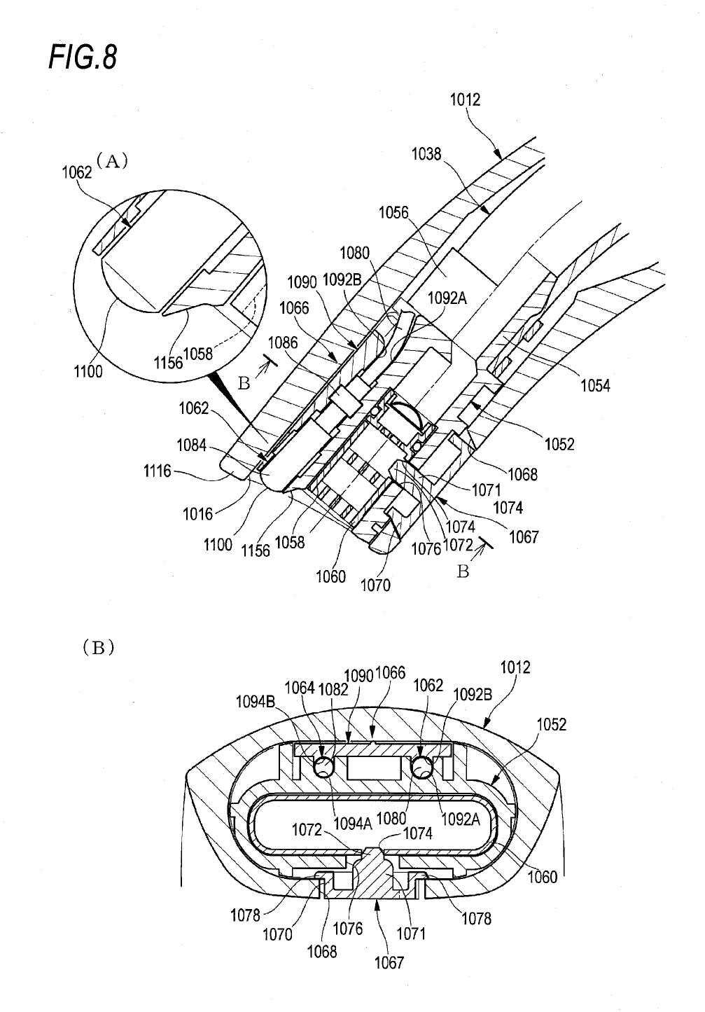

Meanwhile, as shown in FIG. 8, in the inner section of the front end section of the water spout pipe 1012, a cylindrical holding member 1052 holding a water spout member 1060 described later in the inner section is housed.

In the present example, the holding member 1052 is made of resin (herein, POM resin (polyacetal resin)), and a transverse cross-sectional shape is a substantially elliptical shape corresponding to the shape of the front end section of the water spout pipe 1012.

The holding member 1052 integrally includes a cylindrical insertion section 1054. When the insertion section 1054 is pressed into the water supply tube 1038 described later, the holding section 1052 is connected and fixed to the water supply tube 1038 by a band-shaped clamping member 1056 clamping the water supply tube 1038 from the outer circumferential face.

In the holding member 1052, the water spout member 1060 is inserted into the inner section thereof and is held therein.

The water spout member 1060 discharges water from the water spout 1058 of the front end (the left end of the drawing) by making the water stream sent through the water supply tube 1038 pass axially. Herein, the water spout member 1060 discharges water sent through the water supply tube 1038 as the foam stream with a mixed air bubble from the water spout 1058.

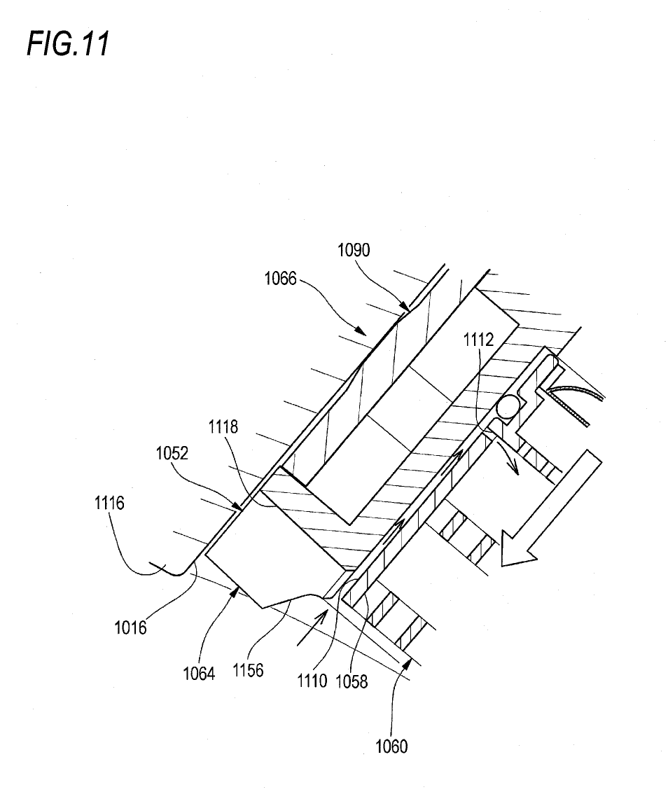

Specifically, as shown in FIG. 11, on the outer circumference side of the water spout member 1060, a communication path 1110 opened to the front outside is formed, an air suction hole 1112 is provided in the water spout member 1060, and the water spout member 1060 sucks the air from air suction hole 1112 through the communication path 1110 and involves the sucked air in the water stream, and discharges the foam stream with the mixed air bubble from the water spout 1058.

The water spout member 1060 has a transverse cross-sectional shape forming a flattened ellipse shape, and is inserted and placed in the inner section of the holding member 1052 in the state where the front end thereof is positioned on the back-side than the front end of the water spout pipe 1012 and the front end of the holding member 1052.

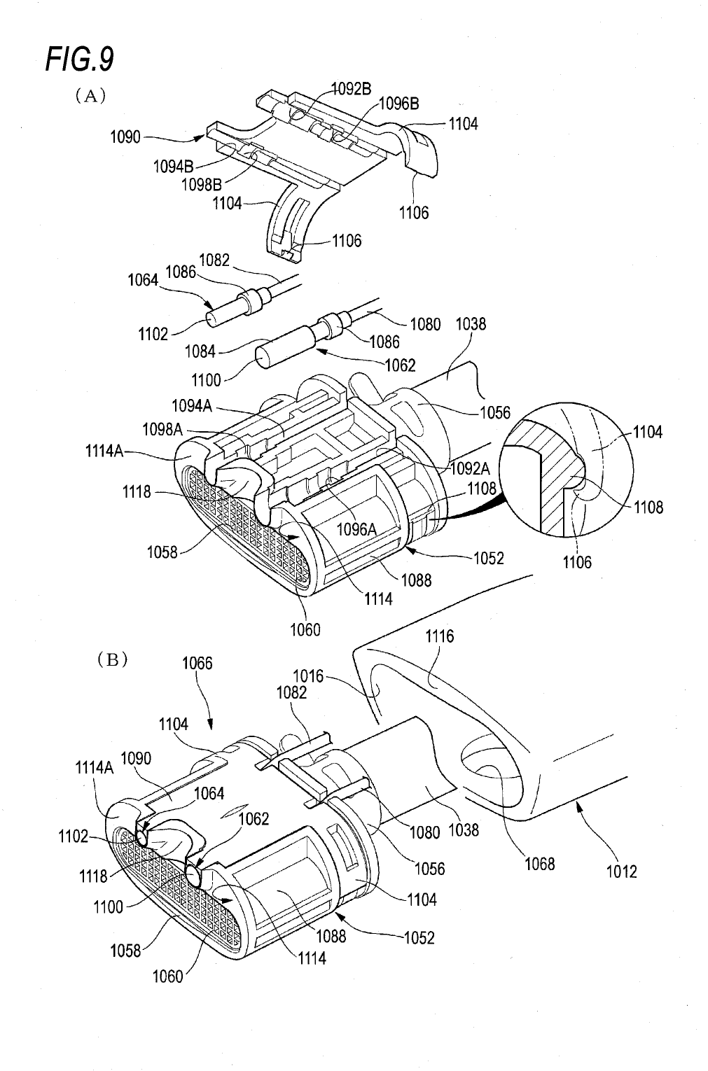

As shown in FIG. 9, the holding member 1052 has a main body section 1088, and a cover 1090 that covers the upper face thereof. The light emitting section 1062 and the light receiving section 1064 in the sensor (herein, a sensor of an infrared light type of a reflection type) for detecting the detection target such as a hand are fixed and held in the holding member 1052 to be interposed by the main body section 1088 and the cover 1090.

In the embodiment, the light emitting section 1062 and the light receiving section 1064 are installed in a state of being positioned on the front side than the front end of the water spout member 1060. That is, the water spout member 1060 is installed in the water spout pipe 1012 so that the tip of the water spout member 1060 is positioned on the back-side of the water spout pipe 1012 than the respective tips of the light emitting section 1062 and the light receiving section 1064.

Additionally, the front ends of the light emitting section 1062 and the light receiving section 1064 are always positioned in the same position in the pipe axial direction of the water spout pipe 1012.

As will be apparent from FIG. 8, the light emitting section 1062 and the light receiving section 1064 are placed in the state where the front end thereof is slightly positioned on the back-side of the water spout pipe 1012 than the front end of the water spout pipe 1012.

In the present embodiment, the water spout member 1060 and the holding member 1052 configure a water spout unit 1066 together with the light emitting section 1062 and the light receiving section 1064, which is described below.

Additionally, in the water spout unit 1066, the water spout member 1060 and the holding member 1052 are commonly fixed to the water spout pipe 1012 in the fixing hole 1068 by the fixing member 1067 shown in FIG. 8.

The fixing member 1067 is a circular push-button type member and integrally has a circular outer circumferential wall section 1070, a first fitting convex section 1071 standing from the center section thereof, and a second fitting convex section 1072 of a small diameter protruding upward from the upper end of the first fitting convex section 1071. The fixing member 1067 is attached to the water spout pipe 1012 in a state of fitting the second fitting convex section 1072 to the through fitting hole 1074 of the water spout member 1060, fitting the first fitting convex section 1071 to the through fitting hole 1076 of the holding member 1052, and fitting the outer circumferential wall section 1070 to the circular fixing hole 1068 of the water spout pipe 1012. Thus, the fixing member 1067 fixes the water spout member 1060 and the holding member 1052 to the water spout pipe 1012 in the positioned state.

Further, as shown in FIG. 8(B), the fixing member 1067 has a pair of left-right claws 1078 when viewed from the front and is stopped from the water spout pipe 1012 by engaging the claws 1078 to the edge section of the fixing hole 1068.

In FIG. 9, reference numeral 1080 is an optical fiber on a light emitting side, reference numeral 1082 is an optical fiber on a light receiving side, and the light emitting section 1062 and the light receiving section 1064 are configured by the tip section of the optical fiber 1080 on the light emitting side and the optical fiber 1082 on the light receiving side.

Additionally, the light emitting section 1062 is provided with a lens 1084 for making the projected light to have directivity.

Additionally, the optical fibers 1080 and 1082 are integrally provided with an annular convex section 1086 for fixing them to the holding member 1052 in the axially positioned state.

Meanwhile, the main body section 1088 of the holding member 1052 is provided with deep holding grooves 1092A and 1094A extended in the axial direction of the optical fibers 1080 and 1082. Further, the corresponding shallow holding grooves 1092B and 1094B are also provided on the side of the cover 1090. The optical fibers 1080 and 1082 are fitted and held to the holding grooves 1092A, 1092B, 1094A and 1094B.

The holding grooves 1092A, 1092B, 1094A and 1094B are provided with concave sections 1096A, 1096B, 1098A and 1098B corresponding to the convex section 1086 of the optical fibers 1080 and 1082. The optical fiber 1080 is fixed and held to the holding member 1052 in the axially positioned state by the concave and convex fitting between the convex section 1086 and the concave sections 1096A and 1096B, and optical fiber 1082 is fixed and held to the holding member 1052 in the axially positioned state by the concave and convex fitting between the convex section 1086 and the concave sections 1098A and 1098B.

Additionally, in the front end of the holding member 1052, a circular recess section formed by the main body section 1088 and the cover 1090 is formed, and the respective front end sections of the light emitting section 1062 and the light receiving section 1064 are fitted thereto.

In the present embodiment, the front end of the light emitting section 1062 forms a light emitting window 1100, and the front end of the light receiving section 1064 forms a light receiving window 1102.

Further, the cover 1090 is integrally formed a pair of curved elastic arms 1104, and the cover 1090 is assembled to the main body section 1088 by elastically engaging the claws 1106 of the tips of the pair of elastic arms 1104 with the corresponding engaging protrusions 1108 of the main body section 1088.

In FIG. 6, reference numeral 1032 is a main body function section placed below the counter 1014, and reference numeral 1034 is a function section box of the main body function section 1032 and an electromagnetic valve 1036 is accommodated therein.

The electromagnetic valve 1036 is a valve that opens and closes the water supply path supplying the water from the water supply source pipe to the water spout member 1060, and the lower end of the water supply tube 1038 is connected to the electromagnetic valve 1036 via the joint 1040.

The water supply tube 1038 is a member forming a part of the water supply path, is extended upward from the function section box 1034, and enters from the opening 1042 of the lower end of the insertion pipe 1020 integrally formed in the water spout pipe 1012 shown in FIG. 7 into the inner section of the water spout pipe 1012.

The water supply tube 1038 extends the inner section of the water spout pipe 1012 up to the front end section,

Additionally, in the example, the water supply tube 1038 has flexibility and thus is formed by a polyurethane resin.

Additionally, in FIG. 6, reference numeral 1044 indicates a stopcock.

In the inner section of the function section box 1034, a control section 1046 including a microcomputer as a main element, and a sensor main body 1048 including the sensor as a main element are accommodated.

The control section 1046 controls the operation of the electromagnetic valve 1036, opens the electromagnetic valve 1036 based on the detection of the detection target using the sensor, and closes the electromagnetic valve 1036 when the sensor does not detect the detection target.

The sensor main body 1048 has a light emitting element such as an LED emitting the light (herein, an infrared light), a photodiode, a light receiving element such as a phototransistor, and a sensor circuit which includes a light emitting driving circuit that performs the light emitting using the light emitting element, and a photoelectric conversion circuit that converts the light received by the light receiving element into the electric signal and processes the signal.

The optical fiber 1080 on the light emitting side is projected from the light emitting element of the sensor main body 1048, and the optical fiber 1082 on the light receiving side is extended from the light receiving element. The optical fibers 1080 and 1082 are extended from the function section box 1034 and enters from the opening 1042 into the inner section of the water spout pipe 1012.

The optical fibers 1080 and 1082 extend the inner section of the water spout pipe 1012 up to the front end section.

In the present embodiment, when the sensor detects a detection target, normally, a hand provided by a user, the electromagnetic valve 1036 is opened under the control using the control section 1046, then and water is automatically discharged from the water spout member 1060 of FIG. 8.

When a user retracts a hand from the detection area by the sensor, the sensor does not detect the hand, and then the electromagnetic valve 1036 is closed under the control of the control section 1046, and the water discharge from the water spout member 1060 is stopped.

The holding member 1052 becoming the installation section of the light emitting section 1062 and the light receiving section 1064 is inserted from the opening 1016 of the tip of the water spout pipe 1012 into the inner section thereof, in a state of making the front face face obliquely downward with respect to a user, and in a state of receding and positioning the front face on the back-side than the front end and the upper section of the water spout pipe 1012.

Similarly, the water spout member 1060 is held in the holding member 1052 in the inserted state, in a state of making the front face, that is, the water spout 1058 face obliquely downward with respect to a user.

Moreover, on the front face of the holding member 1052, the light emitting window 1100 of the front end of the light emitting section 1062 and the light receiving window 1102 of the front end of the light receiving section 1064 are exposed forward and obliquely downward.

The notch section, to which the front end section of the light emitting section 1062 and the front end section of the light receiving section 1064 are each fitted, is formed in the section partially projected than the front face of the holding member 1052, specifically the flat standard face 114A, and thus, the light emitting window 1100 and the light receiving window 1102 are positioned in the position projected forward and obliquely downward from the front face 1114 of the holding member 1052.

Further, the light emitting window 1100 and the light receiving window 1102 are provided on the upper section of the front face of the holding member 1052 at the same height.

That is, in the immediately lower position adjacent to the canopy section 1116 formed from the tip and the upper section of the water spout pipe 1012 projected obliquely downward and forward to the front face 1114, that is, the upper section, the light emitting window 1100 and the light receiving window 1102 are positioned.

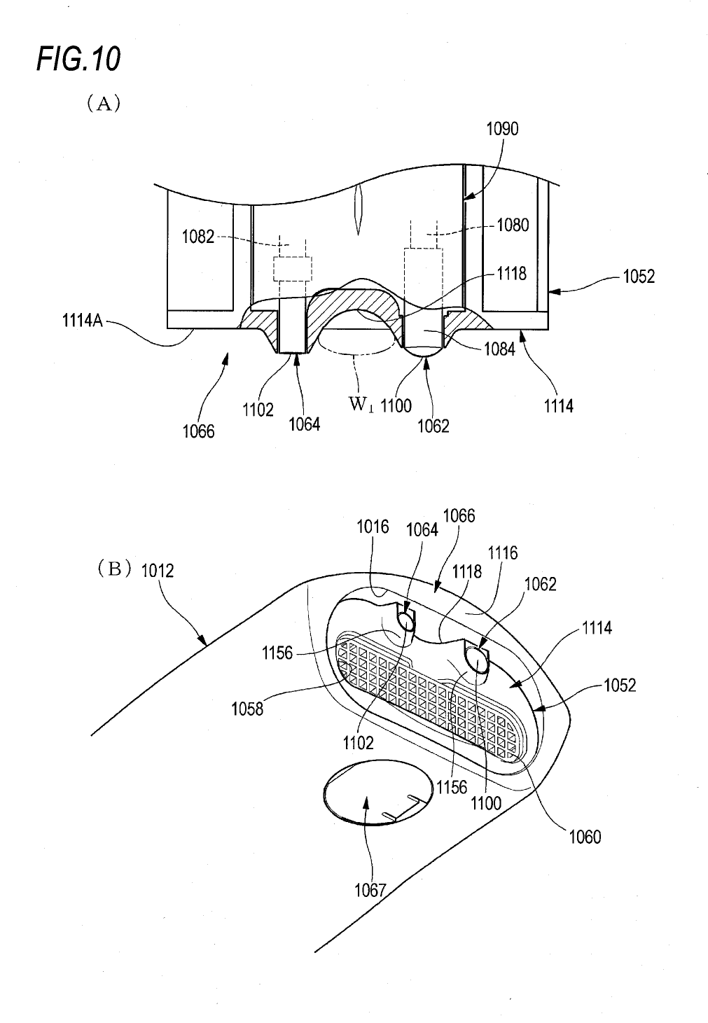

Further, in the present embodiment, as shown in FIGS. 9 and 10, a section of the front face 1114 of the holding member 1052 between the light emitting window 1100 and the light receiving window 1102 is a concave section 1118 recessed to the back-side being the opposite direction of the detection direction using the sensor than the standard face 1114A.

Herein, the bottom face of the concave section 1118 having the plane cross-sectional shape is a face of a continued curved shape.

Moreover, the tip of the communication path 1110 shown in FIG. 11 is opened to the concave section 1118. That is, the air suction hole 1112 shown in FIG. 11 is provided in the concave section 1118 via the communication path 1110 in the communicating state.

The water spout member 1060 sucks air from the air suction hole 1112 through the concave section 1118 and the communication path 1110, and involves the sucked air in the water stream and discharges water of the foam stream with the mixed air bubble from the water spout 1058.

In the embodiment, even when the water droplets W₁ are temporarily attached to the light emitting window 1100 and the light receiving window 1102 in the extended form, as shown in FIG. 10, the water droplets W₁ are instantly retracted to the concave section 1118 between the light emitting window 1100 and the light receiving window 1102, and the water droplets W₁ can be moved, so that it is possible to suppress that the water droplets W₁ are attached to be extended to the light emitting window 1100 and the light receiving window 1102.

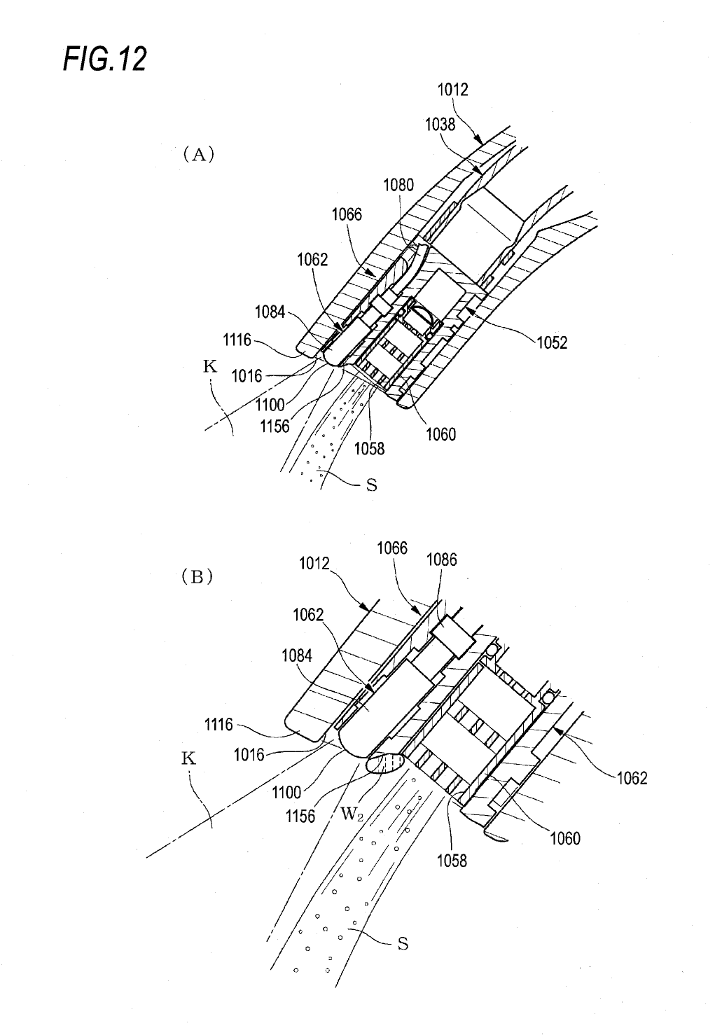

In the present embodiment, as shown in FIGS. 8, 10 and 11, the lower section leading to the light emitting window 1100 of the front face 1114 of the holding member 1052 is formed as a receding face of a water droplet W₂ (see FIG. 12) having a shape which, as separating from the light emitting window 1100 toward the water spout 1058 side, shifts to the back-side of the water spout pipe 1012.

Similarly, the lower section leading to the light receiving window 1102 is also formed as a receding face 1156 of a water droplet W₂ having a shape which, as separating from the light receiving window 1102 toward the water spout 1058 side, shifts to the back-side of the water spout pipe 1012.

In the present embodiment, the receding face 1156 is an inclined face, but this may be other shapes other than the curved face of the concave shape.

In the present embodiment, the light emitting section 1062, the light receiving section 1064, and the water spout member 1060 face forward and obliquely downward, respectively, and the water spout 1058 of the tip of the water spout member 1060 is positioned on the back-side of the water spout pipe 1012 than the light emitting window 1100 and the light receiving window 1102. Thus, as shown in FIG. 12(A), in spite that the direction of the water spout 1058 and the directions of the light emitting section 1062 and the light receiving section 1064 is same, that is, the light emitting window 1100 and the light receiving window 1102 are the same direction, as shown in FIG. 12(A), the direction of the water stream S discharged from the water spout 1058 is changed to the downward stream by the action of gravity force after the discharging, and thus there is an advantage in that the detection area K using the light emitting section 1062 and the light receiving section 1064 cannot overlap the water stream S.

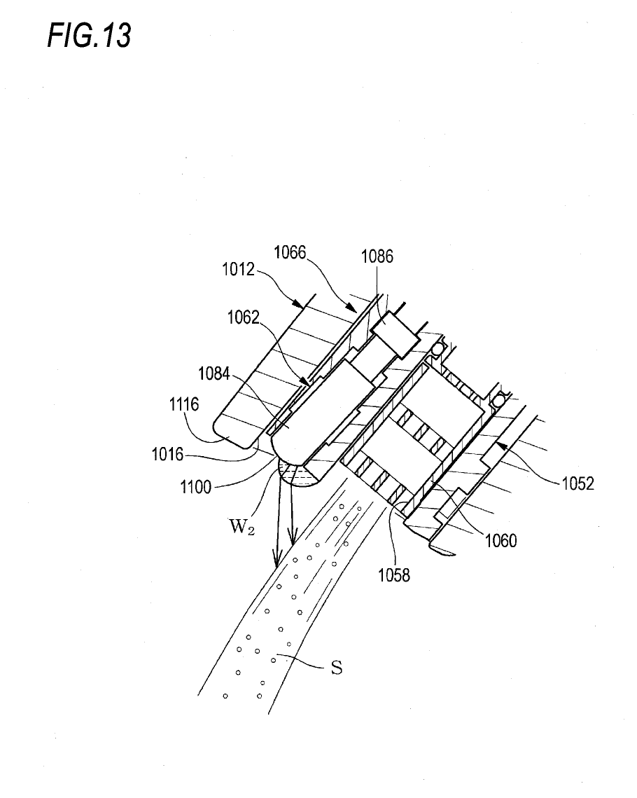

However, as shown in a comparative example of FIG. 13, the lower section of the light emitting window 1100 of the front face of the holding member 1052 forms the flat face 1158A of the right angle direction of the optical axis. In addition, in a case where the flat face 1158A forms a shape having the angle 1160A, when the water droplets W₂ are attached to the light emitting window 1100 in the covering form (the hanging shape), and the water droplets W₂ are still attached thereto.

Then, light emitted from the light emitting window 1100 is refracted by the water droplets W₂ and proceeds to the water stream S. As a consequence, the light reflected by the water droplets W₂ is received by the light receiving section 1064 through the light receiving window 1102, and the water stream S may be erroneously detected as the detection target.

In the present embodiment, even if the water droplets W₂ are temporarily attached in the form as shown in FIG. 13, that is, in the form covering the light emitting window 1100, the water droplets W₂ are retracted to the receding face 1156 side to be expanded along the receding face 1156 of the inclined shape as shown in FIG. 12(B). Thus, it is possible to suppress that the light emitted from the light emitting window 1100 is refracted by the water droplets W₂ and emitted to the water stream S.

In the present embodiment, since the receding face 1156 of the similar inclined shape is also formed on the downside of the light receiving window 1102, it is possible to suppress the water droplets W₂ are attached to the lower side thereof in the state covering the light receiving window 1102 in the side of the light receiving window 1102 and stays in that state.

When the water droplets W₂ are attached to the lower side in the form to cover the light receiving window 1102, the light from the lower side from the original light receiving area enters the light receiving window 1102 and is received by the light receiving section 1064. Thus, the reflected light from the water stream S is removed by the light receiving section 1064, and the water stream S may be erroneously detected. However, in the present embodiment, on the lower side of the light receiving window 1102, the receding face 1156 is also formed, it is possible to more reliably suppress that the sensor erroneously detects the water stream S as the detection target.

Further, in the present embodiment, since the light emitting window 1100 and the light receiving window 1102 are projected and positioned from the front face of the holding member 1052, the water droplets W₂ are hard to put on the light emitting window 1100 and the light receiving window 1102, so that it is possible to more reliably suppress the erroneous detection due to the attachment of the water droplets W₂.

In the present embodiment, when assembling the water supply tube 1038, as shown in FIG. 9, the water supply tube 1038 is inserted from the opening 1016 of the tip of the water spout pipe 1012 (at this time, the tip section of the water supply tube 1038 is connected to the water spout unit 1066, and the water spout unit 1066 is also inserted from the opening 1016 into the inner section of the water spout pipe 1012), and the other end side of the water supply tube 1038 is extracted to the lower outside through the through opening 1122 formed near the center of the seating section 1018 of the stepped shape forming the bottom section of the hollow section in the water spout pipe 1012.

At this time, the other side of the water supply tube 1038 abuts the back face 1124 becoming the face of the back side of the water supply tube 1038 of the inner face of the water spout pipe 1012, and moves the inner face of the water spout pipe 1012 toward the seating section 1018 along the back face.

For this reason, the other end of the water supply tube 1038, that is, the lower end abuts the seating section 1018 forming the stepped shape of the water spout pipe 1012, and then the water supply tube 1038 cannot be pushed into the inner section of the water spout pipe 1012.

That is, the lower end of the water supply tube 1038 enters the through opening 1122 and then cannot be extracted to the outside through the insertion pipe 1020.

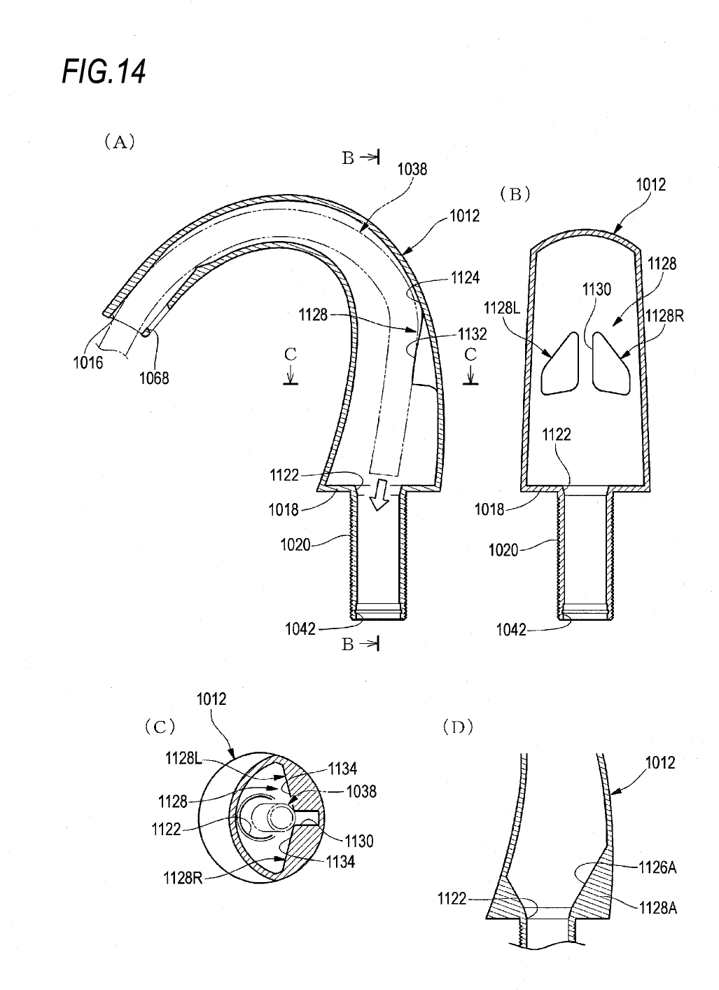

At this time, as shown in FIG. 14(D), it is considered that a section of the upper position of a certain height from the seating section 1018 of the water spout pipe 1012 is configured as the guide section 1128A having the slope guide face 1126A, and the lower face of the water supply tube 1038 is guided and is led toward the through opening 1122 by the guide face 1126A of the guide section 1128A.

However, in this case, in the section provided with the guide section 1128, the water spout pipe 1012 becomes partially too thick, and the guide section 1128 may guide the lower end of the water supply tube 1038 while positioning the lower end of the water supply tube 1038 in two axes direction of the left-right direction and the right angle direction of the paper face perpendicular thereto. The thick guide section 1128 may be provided over a wide range around the pipe axis of the water spout pipe 1012. For this reason, when casting the water spout pipe 1012, the sink is generated by the existence of the guide section 1128 forming the partial thick section, and the sink appears on the appearance, and thus it is actually difficult to adopt that as the solving means.

Thus, in the present embodiment, as shown in FIG. 14, the guide section 1128 is provided in a position separated from the seating section 1018 of the water spout pipe 1012 by a predetermined distance, on the back face 1124 of the water spout pipe 1012.

Herein, the guide section 1128 has a longitudinal groove 1130 in a center in the left-right direction when viewed from the front, the left section of the groove 1130 forms the left guide section 1128L and the right section thereof forms the right guide section 1128R.

The guide face of the water supply tube 1038 of the left-right guide sections 1128L and 1128R increase the projection amount from the back face 1124 to the water supply tube 1038, as proceeding downward, as shown in FIG. 14(A), and includes the longitudinal guide face 1132 inclined obliquely downward toward the through opening 1122.

Further, as shown in FIG. 14(C), the guide face includes a transverse guide face 1134 of the inclined shape continuously decreasing the projection amount, as proceeding toward the groove 1130. Herein, the transverse guide face 1134 is continuously formed downward from the upper end of the longitudinal guide face 1132 along the longitudinal guide face 1132.

In the present embodiment, when the water supply tube 1038 is inserted and pushed from the other end side into the inner section of the water spout pipe 1012 through the opening section 1016 of the tip of the water spout pipe 1012, the other end of the water supply tube 1038 firstly abuts the upper section of the back face 1124 of the water spout pipe 1012, specifically, the back face 1124 of the upper section forming the inverted U-shape, is guided to the back face 1124 forming the curved shape and is moved downward. Moreover, when reaching the position of the guide section 1128, the other end side of the water supply tube 1038 is guided to the guide section 1128 and is moved downward.

At this time, the position of the other end side of the water supply tube 1038 is guided to the center of the right angle direction of the paper face by the transverse guide face 1134 in the guide section 1128, and the other end side is guided to the through opening 1122 of the seating section 1018 by the guidance action of the longitudinal guide face 1132 while maintaining the position thereof.

Accordingly, when pushing the water supply tube 1038, the other end automatically enters the inner section of the through opening 1122 of the seating section 1018, and then is inserted through the insertion pipe 1020 and is extracted to the lower outside of the water spout pipe 1012. The shape of the longitudinal guide face 1132 of the guide section 1128 is set in advance.

Herein, since the guide section 1128 is provided on the upper section separated from the seating section 1018 of the water spout pipe 1012 by a predetermined distance, the projection amount toward the water supply tube 1038 can be reduced compared to that shown in FIG. 14(D). Further, since the longitudinal deep groove 1130 is provided in the left-right center of the guide section 1128, by partially providing the thick section in the water spout pipe 1012 for the guide section 1128, the thickness can be reduced as compared to that shown in FIG. 14(D). Further, since the thick section is circumferentially divided by the groove 1130, that is, since the thick section is not circumferentially continued, even if the guide section 1128 is provided, the occurrence of the sink when casting the water spout pipe 1012 can be suppressed, so that it is possible to suppress that the sink appears on the appearance of the water spout pipe 1012 and the appearance of the water spout pipe 1012 is degraded.

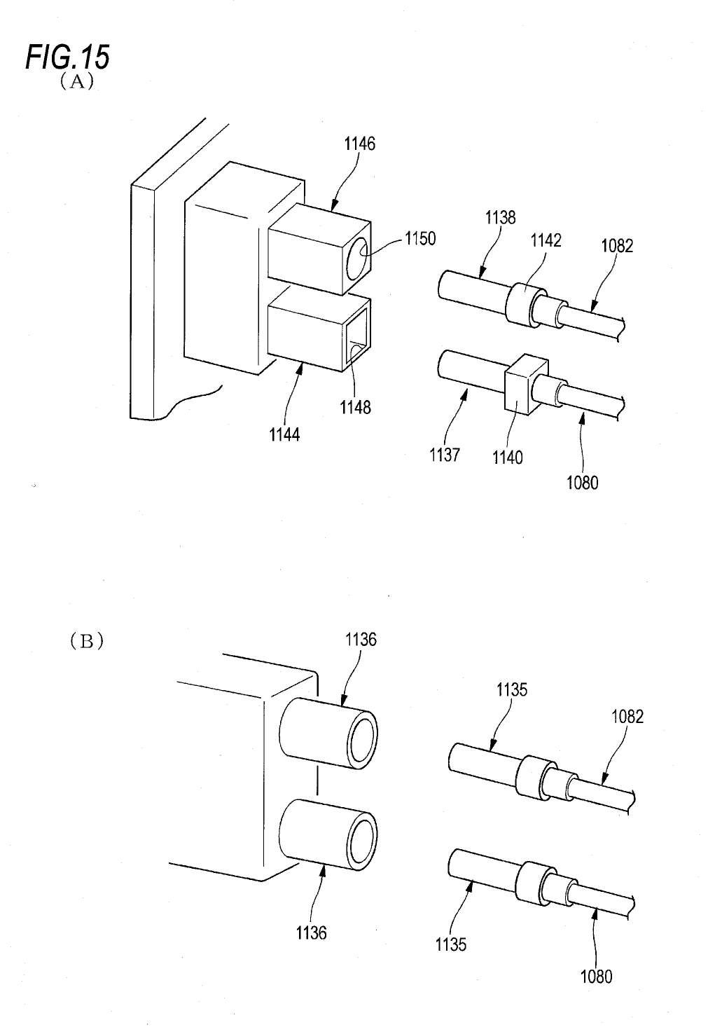

Further, as shown in FIG. 15(B), when inserting and connecting the respective insertion sections of the optical fibers 1080 on the light emitting side and the optical fiber 1082 on the light receiving side into the insertion port of the inner section of the function section box 1034, if the insertion sections of the optical fibers 1080 on the light emitting side and the optical fiber 1082 on the light receiving side are the insertion sections 1135 having the same shape, the two insertion sections 1135 and the insertion port 1136 can be used by the same shape, and then the required cost can be reduced. Meanwhile, in this case, the optical fibers 1080 on the light emitting side and the optical fiber 1082 on the light receiving side may be erroneously inserted to the insertion port 1136 of a side different from the original counterpart, and an erroneous insertion may occur.

Accordingly, in order to suppress this, as shown in FIG. 15(B), the insertion section 1137 of the optical fibers 1080 on the light emitting side and the insertion section 1138 of the optical fiber 1082 on the light receiving side have the shape different from each other. Specifically, for example, one of the shape of the fitting protrusion section 1142 is the fitting protrusion section 1140 of a rectangular shape, and the other is the fitting protrusion section 1142 of the circular shape, the fitting hole of the insertion port 1144 of the counterpart side is corresponding to the fitting hole 1148 of the rectangular shape, the other fitting hole is the fitting hole 1150 of the circular shape, and the insertion sections 1137 and 1138 are inserted to the insertion ports 1144 and 1146. Thus, the insertion to the erroneous counterpart side, that is, the erroneous insertion can be appropriately suppressed.

Further, one of the fitting protrusion sections 1140 and 1142 has a large shape and the other thereof has a small shape, one of the fitting holes 1148 and 1150 has a large shape and the other thereof has a small shape accordingly, and thus the erroneous insertion can be suppressed. Otherwise, the insertion sections 1137 and 1138 are not formed as separate insertion sections but an integral insertion section, and the insertion ports 1144 and 1146 are an integral insertion port. Accordingly, the erroneous insertion can also be suppressed.

An embodiment of the present invention has been described in detail, but this is an example. According to the present invention, the holding member of the water spout member and the holding member of the light emitting section and the light receiving section can also be as separate holding members. Further, the present invention can also be applied to a case where the light emitting section and the light receiving section are configured in the tip section of the optical fiber, as well as a case where they are configured in the light emitting element and the light receiving element. Thus, the present invention can be configured by the forms with various modifications added in the scope without departing from the gist thereof.

Further, another embodiment of the present invention will be described in detail based on the drawings.

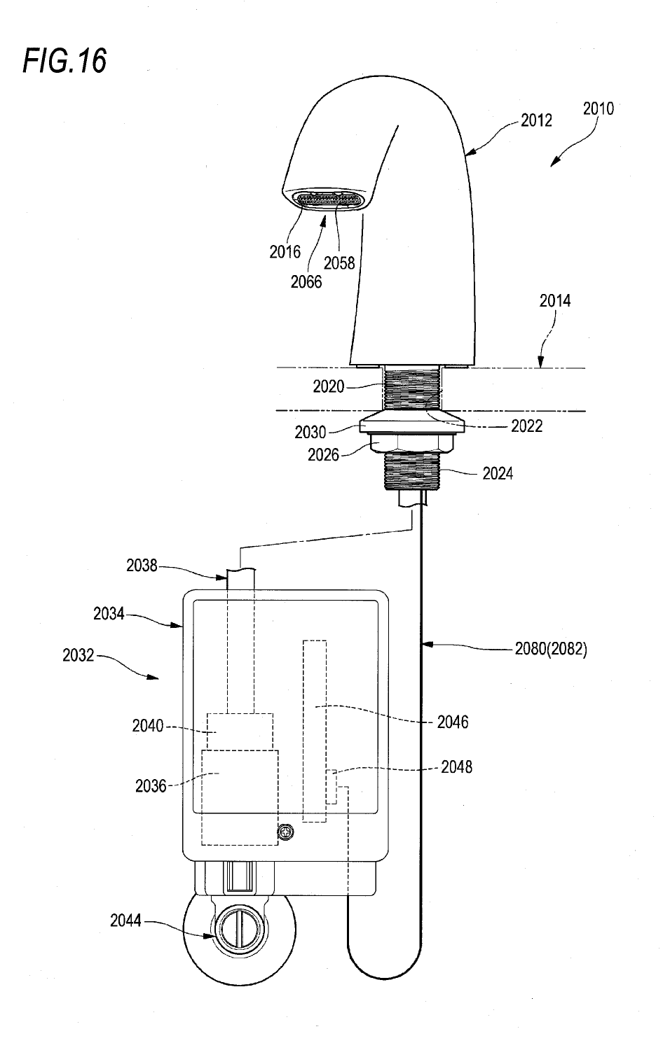

In FIG. 16, reference numeral 2010 is an automatic faucet of the present embodiment, and reference numeral 2012 is a water spout pipe in the automatic faucet (Herein, the water spout pipe 2012 is made of a metal or casting).

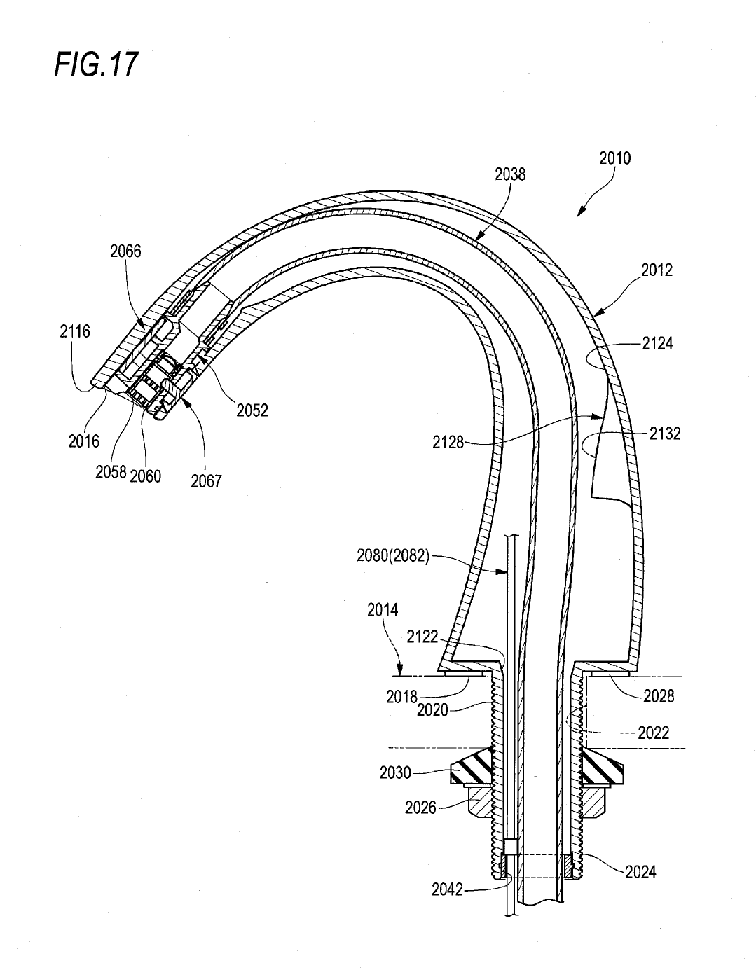

The water spout pipe 2012 is installed in the form standing from a counter (an attachment base) 2014, and an upper section forms a goose neck shape that is inverted U-shaped with respect to a user. The tip face thereof is directed forward and obliquely downward to a user. As shown in FIGS. 16 and 17, the water spout pipe 2012 is formed with a substantially elliptical opening 2016 corresponding to the transverse cross-sectional shape of the water spout pipe 2012 on the tip face thereof.

As shown in FIG. 17, the water spout pipe 2012 has a seating section 2018 on a base end side thereof, and an insertion pipe 2020 is extended downward from the seating section 2018.

The insertion pipe 2020 is inserted through an attachment hole 2022 of the counter 2014 and is projected to the lower side of the counter 2014, and a fixing nut 2026 is screwed into a male screw section 2024 provided on an outer circumferential face thereof.

The water spout pipe 2012 is set so that the seating section 2018 seats on the upper face of the counter 2014, and is attached to the counter 2014 in a state of interposing the counter 2014 from both sides of up and down via packings 2028 and 2030 by the seating section 2018 and the fixing nut 2026.

In FIG. 16, reference numeral 2032 is a main body function section placed below the counter 2014, and reference numeral 2034 is a function section box of the main body function section 2032 and an electromagnetic valve 2036 is accommodated therein.

The electromagnetic valve 2036 is a valve that opens and closes the water supply path supplying the water from the water supply source pipe to the water spout 2058 (FIG. 17), and the lower end of the water supply tube 2038 is connected to the electromagnetic valve 2036 via the joint 2040.

The water supply tube 2038 is a member forming a part of the water supply path, is extended upward from the function section box 2034, and enters from the opening 2042 of the lower end of the insertion pipe 2020 integrally formed in the water spout pipe 2012 into the inner section of the water spout pipe 2012.

The water supply tube 2038 extends the inner section of the water spout pipe 2012 up to the tip section.

Additionally, in the example, the water supply tube 2038 has flexibility and is formed by a polyurethane resin.

Additionally, in FIG. 16, reference numeral 2044 indicates a stopcock.

In the inner section of the function section box 2034, a control section 2046 including a microcomputer as a main element, and a sensor main body 2048 including the sensor as a main element are accommodated.

The control section 2046 controls the operation of the electromagnetic valve 2036, opens the electromagnetic valve 2036 based on the detection of the detection target using the sensor, and closes the electromagnetic valve 2036 when the sensor does not detect the detection target.

The sensor main body 2048 has a light emitting element such as an LED emitting the light (herein, an infrared light), a photodiode, a light receiving element such as a phototransistor, and a sensor circuit which includes a light emitting driving circuit that performs the light emitting using the light emitting element, and a photoelectric conversion circuit that converts the light received by the light receiving element into the electric signal and processes the signal.

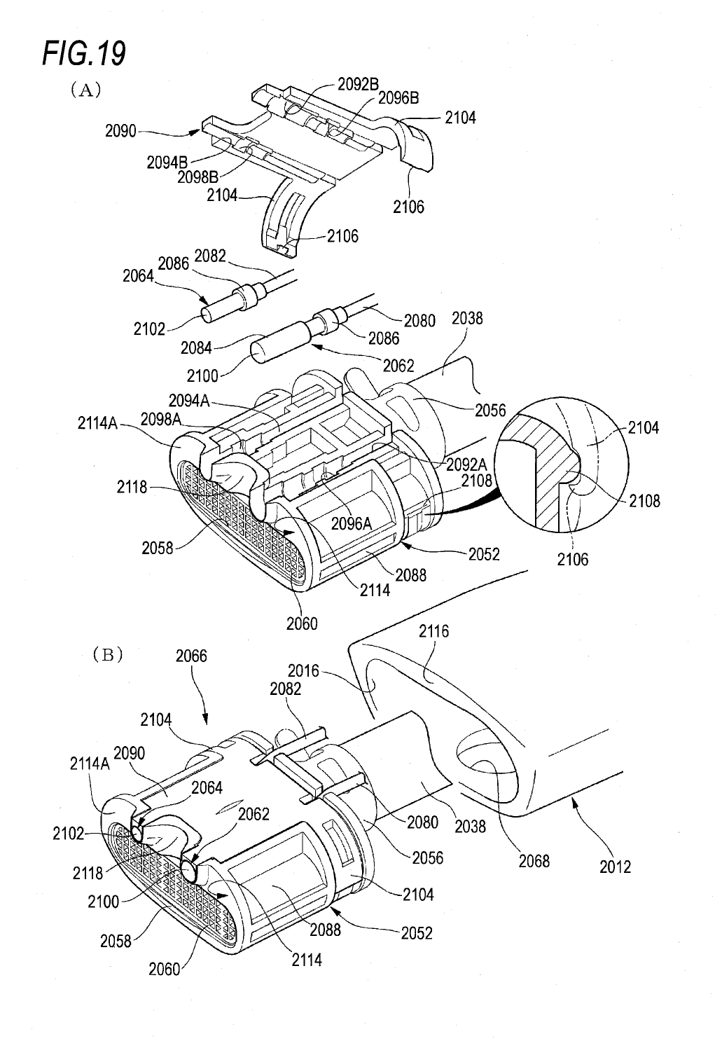

The optical fiber 2080 (see FIG. 19) on the light emitting side is projected from the light emitting element of the sensor main body 2048, and the optical fiber 2082 on the light receiving side is extended from the light receiving element.

As shown in FIG. 17, the two optical fibers 2080 and 2082 enter from the opening 2042 of the lower end of the insertion pipe 2020 into the inner section of the water spout pipe 2012, and are extended into the inner section of the water spout pipe 2012 up to the tip section thereof.

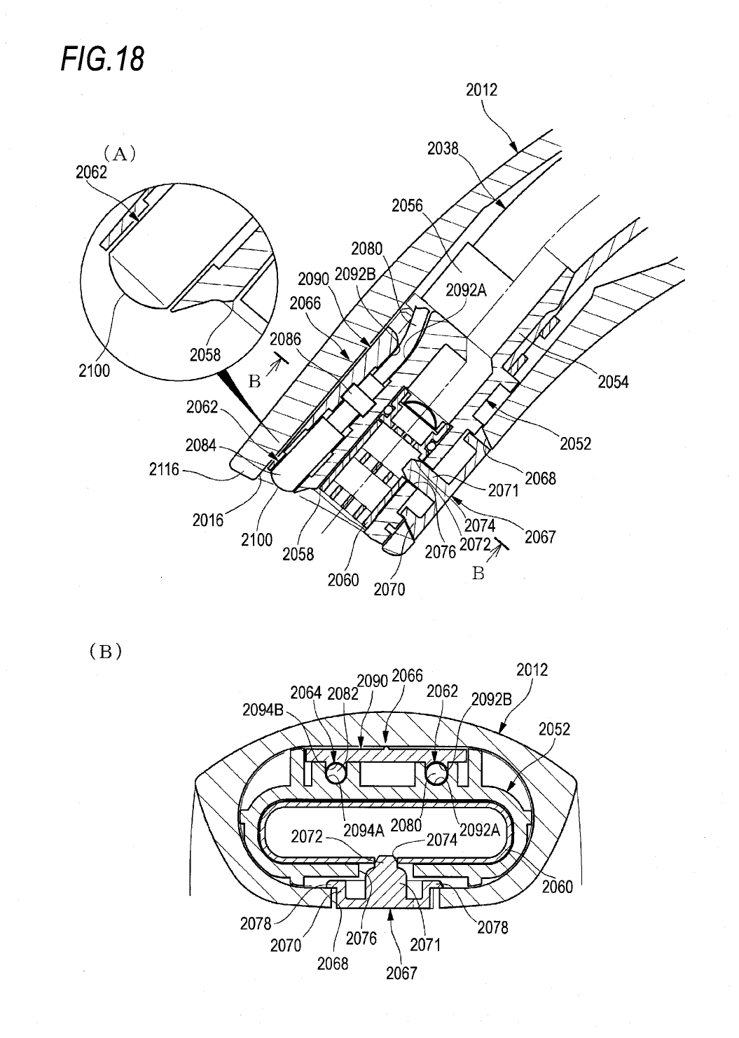

As shown in FIG. 18, in the inner section of the tip section of the water spout pipe 2012, a water spout member 2052 is housed.

In the present example, the water spout member 2052 is made of resin (herein, POM resin (polyacetal resin)), and has a cylindrical shape of a substantially elliptical shape corresponding to the shape of the tip section of the water spout pipe 2012 as a whole.

The water spout member 2052 integrally includes a cylindrical insertion section 2054. When the insertion section 2054 is pressed into the water supply tube 2038, the water spout member 2052 is connected and fixed to the water supply tube 2038 by a hand-shaped clamping member 2056 clamping the water supply tube 2038 from the outer circumferential face.

As shown in FIG. 19, the opening of the tip of the water spout member 2052 is the water spout 2058, and a water stream passing member 2060 is placed in the water spout 2058 for making the water stream pass thereof and controlling and defining the form (the pattern) of the discharged water from the water spout 2058.

The water stream passing member 2060 has a cylindrical shape having a transverse cross-sectional shape of a flattened elliptical shape, the water stream passing member 2060 is inserted into the inner section of the water spout member 2052 forming the cylindrical shape in the fitted state, is positioned slightly on the back-side of the water spout 2058, and is held in the water spout member 2052.

That is, in the present embodiment, a dedicated housing for the water stream passing member 2060, which accommodates and holds the water stream passing member 2060 in the inner section in the anti pull-out state, is not provided, and the water stream passing member 2060 houses the water spout member 2052 as the housing in the inner section thereof.

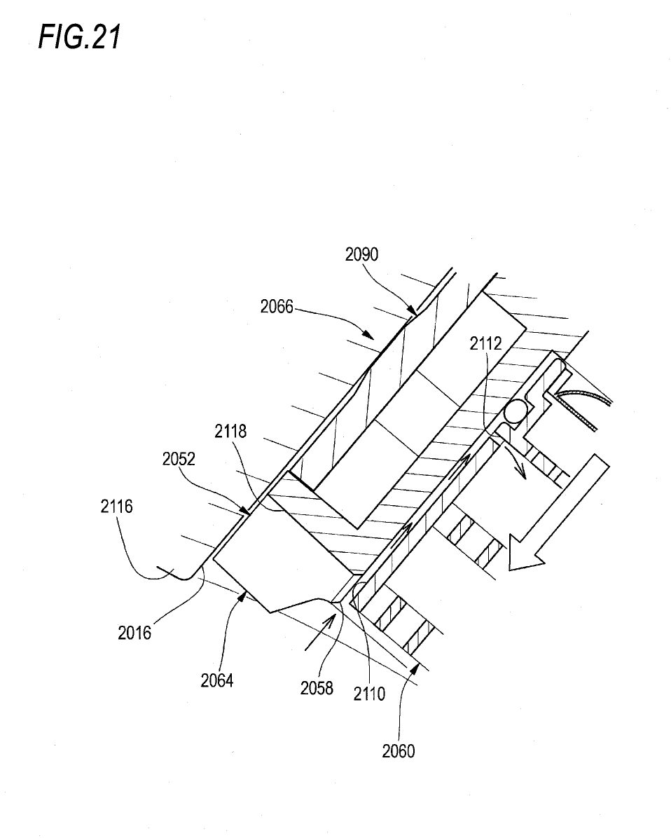

In the present embodiment, the water stream passing member 2060 makes the water stream sent from the water supply tube 2038 pass itself, sucks the air into the inner section through the communication path 2110 and the air suction hole 2112 opened to the outside of FIG. 21 at that time, involves the air in the water stream, and discharges that as the foam stream with the mixed air bubble from the water spout 2058.

In the embodiment, the water stream passing member 2060 and the water spout member 2052 configure a water spout unit 2066 together with the light emitting section 2062 and the light receiving section 2064, which is described below.

Moreover, in the water spout unit 2066, the water stream passing member 2060 and the water spout member 2052 are commonly fixed in the fixing hole 2068 provided in the water spout pipe 2012 by the fixing member 2067 shown in FIG. 18.

The fixing member 2067 is a circular push-button type member, and integrally has a circular outer circumferential wall section 2070, a first fitting convex section 2071 standing from the center section thereof, and a second fitting convex section 2072 of a small diameter protruding upward from the upper end of the first fitting convex section 2071. The fixing member 2076 is attached to the water spout pipe 2012 in a state of fitting the second fitting convex section 2072 to the through fitting hole 2074 of the water stream passing member 2060, fitting the first fitting convex section 2071 to the through fitting hole 2076 of the water spout member 2052, and fitting the outer circumferential wall section 2070 to the circular fixing hole 2068 of the water spout pipe 2012. Thus, the fixing member 2067 fixes the water stream passing member 2060 and the water spout member 2052 to the water spout pipe 2012 in the positioned state.

Additionally, as shown in FIG. 18(B), the fixing member 2067 has a pair of left-right claws 2078 when viewed from the front, and is stopped from the water spout pipe 2012 by engaging the claws 2078 to the edge section of the fixing hole 2068.

In FIG. 19, reference numeral 2080 is an optical fiber on a light projection side, reference numeral 2082 is an optical fiber on a light receiving side, and the light emitting section 2062 and the light receiving section 2064 are configured by the tip section of the optical fiber 2080 on the light emitting side and the optical fiber 2082 on the light receiving side.

Additionally, the light emitting section 2062 is provided with a lens 2084 for making the projected light have directivity.

Additionally, the optical fibers 2080 and 2082 are integrally provided with an annular convex section 2086 for fixing them to the water spout member 2052 in the axially positioned state.

In the present embodiment, the water spout member 2052 has a main body section 2088 and a cover 2090 that covers the upper face thereof.

The main body section 2088 is provided with deep holding grooves 2092A and 2094A extended in the axial direction of the optical fibers 2080 and 2082. Further, the corresponding shallow holding grooves 2092B and 2094B are also provided on the side of the cover 2090. The optical fibers 2080 and 2082 are fitted and held to the holding grooves 2092A, 2092B, 2094A and 2094B.

The holding grooves 2092A, 2092B, 2094A and 2094B are provided with concave sections 2096A, 2096B, 2098A and 2098B corresponding to the convex section 2086 of the optical fibers 2080 and 2082. The optical fiber 2080 is fixed and held to the water spout member 2052 in the axially positioned state by the concave and convex fitting between the convex section 2086 and the concave sections 2096A and 2096B, and optical fiber 2082 is fixed and held to the water spout member 2052 in the axially positioned state by the concave and convex fitting between the convex section 2086 and the concave sections 2098A and 2098B.

Further, the cover 2090 is integrally formed a pair of curved elastic arms 2104, and the cover 2090 is assembled to the main body section 2088 by elastically engaging the claws 2106 of the tips of the pair of elastic arms 2104 with the corresponding engaging protrusions 2108 of the main body section 2088.

In the present embodiment, the sensor is configured by the sensor main body 2048 shown in FIG. 16, the light emitting section 2062 configured in the optical fibers 2080 and 2082 extended therefrom and the tip sections thereof, and the light receiving section 2064. When the sensor detects a detection target, normally, a hand provided by a user, the electromagnetic valve 2036 is opened under the control using the control section 2046, and water is automatically discharged from the water spout 2058 of FIG. 18.

When a user retracts a hand from the detection area by the sensor, the sensor does not detect the hand, and then the electromagnetic valve 2036 is closed under the control of the control section 2046, and the water discharge from the water spout 2058 is stopped.

The water spout member 2052 becoming the installation section of the light emitting section 2062 and the light receiving section 2064 is inserted from the opening 2016 of the tip of the water spout pipe 2012 into the inner section thereof, in a state of making the front face (the front face of the installation section) face obliquely downward with respect to a user, and in a state of receding and positioning the front face on the back-side than the front end and the upper section of the water spout pipe 2012.

As shown in FIGS. 18, 19 and 20, the water spout member 2052 is provided with a notch section having a circular front shape, the respective tip sections of the light emitting section 2062 and the light receiving section 2064 are fitted thereto, and the tip of the light emitting section 2062 and the tip of the light receiving section 2064 form a light emitting window 2100 and a light receiving window 2102 which are separated from each other and are independent.

In the present embodiment, the light emitting window 2100 and the light receiving window 2102 are not covered by a window cover formed of a light transmitting material connected from the light emitting window 2100 to the light receiving window 2102, but each of them is provided on the front face 2114 of the water spout member 2052 in the exposed state to be separated from each other in left-right and independent.

Herein, the light emitting window 2100 and the light receiving window 2102 are provided on the upper section of the front face 2114 of the water spout member 2052 at the same height.

That is, in the immediately lower position adjacent to the canopy section 2116 formed of the tip and the upper section of the water spout pipe 2012 projected obliquely downward and forward to the front face 2114, the light emitting window 2100 and the light receiving window 2102 are provided on the front face 2114 of the water spout member 2052.

Herein, the light emitting window 2100 and the light receiving window 2102 are formed in the form of being projected to the front side of the standard face 2114A in the front face 2114 of the water spout member 2052, that is, the standard face 2114A forming the continued flat face (strictly, they are formed in the section partially projected forward than the standard face 2114).

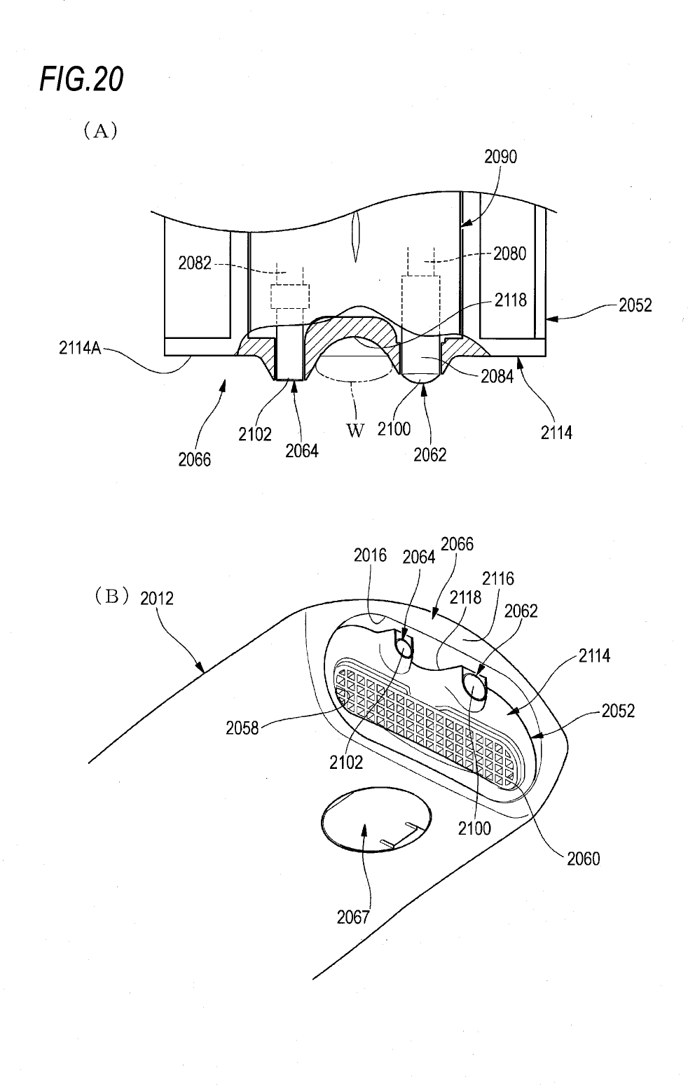

In the present embodiment, as shown in FIGS. 19 and 20, a section of the front face 2114 of the water spout member 2052 between the light emitting window 2100 and the light receiving window 2102 is a concave section 2118 recessed to the back-side being the opposite direction of the detection direction using the sensor than the standard face 2114A.

Herein, the bottom face of the concave section 2118 having the plane cross-sectional shape is a face of a continued curved shape.

Moreover, the tip of the communication path 2110 shown in FIG. 21 is opened to the concave section 2118. That is, the air suction hole 2112 shown in FIG. 21 is provided in the concave 2118 via the communication path 2110 in the communicating state.

The water stream passing member 2060 sucks air from the air suction hole 2112 through the concave section 2118 and the communication path 2110, and involves the sucked air in the water stream and discharges water of the foam stream with the mixed air bubble from the water spout 2058.

According to the embodiment as mentioned above, even when the water droplets W are temporarily attached to the light emitting window 2100 and the light receiving window 2102, the water droplets W are instantly retracted to the concave section 2118 between the light emitting window 2100 and the light receiving window 2102, and the water droplets W can be moved, so that it is possible to suppress that the water droplets W are attached to be extended to the light emitting window 2100 and the light receiving window 2102.

The water droplets enter the concave section 2118 and the water droplets can shift, by the use of the property, in which the water droplets W attached to the light emitting window 2100 and the light receiving window 2102, tend to expand along an inner face of the concave section 2118 on the contact side to the front face 2114 of the water spout member 2052 and the property, in which the water droplets W tend to shrink by the surface tension on the non-contact side.

As a consequence, the erroneous detection of the sensor due to the attachment of the water droplets W can be effectively suppressed, so that it is possible to suppress the problem that the sensor erroneously detects the water droplets W as the detection target and thus water is discharged.

Further, in the present invention, the light emitting window 2100 and the light receiving window 2102 are not covered by the window cover formed of a light transmitting material connected from the light emitting window 2100 to the light receiving window 2102, and the light emitting window and the light receiving window are independently provided to be separated from each other. Thus, it is also possible to solve the problem that the toothpaste and other contaminations are attached to the front face of the window cover, the light from the light emitting section 2062 is reflected by the window cover inner section and is transmitted to the light receiving window 2102, and the light is received by the light receiving window 2102 to cause the erroneous detection.

Further, in the present invention, the light emitting window 2100 and the light receiving window 2102 are provided to be projected to the front side than the standard face 2114A on the front face 2114. Thus, the water droplets W hardly put on the light emitting window 2100 and the light receiving window 2102, and the erroneous detection due to the attachment of the water droplets W can be reliably suppressed.

Further, in the present invention, the water spout member 2052 is provided with the light emitting window 2062 and the light receiving window 2064, the light emitting window 2100 and the light receiving window 2102 are provided on the front face 2114 of the water spout member 2052, and the section between the light emitting window 2100 and the light receiving window 2102 of the front face 2114 is the concave section 2118. Thus, the recess may be formed on a part of the front face 2114 of the water spout member 2052, and the recess, that is, the concave section 2118 can be easily formed.

In the present embodiment, the water spout pipe has the shape, in which the section of the front end side of the water spout pipe 2012 close to a user is directed forward and obliquely downward with respect to a user, the water spout member 2052 is inserted from the opening 2016 from the tip of the water spout pipe 2012 into the water spout pipe 2012 in a state of setting the front face 2114 of the water spout member to face obliquely downward, and in a state of positioning the front face 2114 thereof to enter the inside than the canopy section 2116 of the front end and the upper section of the water spout pipe 2012, and in a position adjacent to the canopy section 2116, the light emitting window 2100 and the light receiving window 2102 are placed on the upper section of the front face 2114 of the water spout member 2052.

In this manner, the section of the front end side of the water spout pipe 2012 has the shape which is directed forward and obliquely downward with respect to a user, and the canopy section 2116 of the front end and the upper section of the water spout pipe 2012 is projected obliquely downward with respect to a user than the front face 2114 of the water spout member 2052. Accordingly, the water spout member 2052 and the peripheral members thereof is hidden by the canopy section 2116 of the water spout pipe 2012, and is hardly seen from a user, the sense of cumbersome due to the appearance of the eyes of a user is not caused, and the appearance of the tip section of the water spout pipe 2012 can be good.

Meanwhile, in such a case, compared to a case where the front end and the upper section of the water spout pipe 2012 are not projected, the water droplets W are easily attached to the light emitting window 2100 and the light receiving window 2102.

In this manner, in a case where the front end and the upper section of the water spout pipe 2012 are not formed as the canopy section 2116 projected forward, even when the water droplets W are attached to the front face 2114 of the water spout member 2052 facing forward and obliquely downward, the water droplets W flow down, and thus are naturally and easily removed from the light emitting window 2100 and the light receiving window 2102.

When the canopy section 2116 of the water spout pipe 2012 is projected on the upper side adjacent to the light emitting window 2100 and the light receiving window 2102, the water droplets W are attached to the canopy section 2116. Accordingly, the water droplets W are easily held over the lower face of the canopy section 2116 and the upper section of the front face 2114 of the water spout member 2052. As a consequence, the light emitting window 2100 and the light receiving window 2102 are easily covered from the water droplets.

According to the present embodiment, by the concave section 2118 formed in the section between the light emitting window 2100 and the light receiving window 2102, it is possible to effectively suppress the water droplets from remaining in a state of being attached to the light emitting window 2100 and the light receiving window 2102.

That is, according to the present embodiment, the appearance of the water spout pipe 2012 front end section can be secured, and the erroneous detection due to the attachment of the water droplets W can be suppressed.

In the present embodiment, when assembling the water supply tube 2038, as shown in FIG. 19, the water supply tube 2038 is inserted from the opening 2016 of the tip of the water spout pipe 2012 (at this time, the tip section of the water supply tube 2038 is connected to the water spout unit 2066, and the water spout unit 2066 is also inserted into the inner section of the water spout pipe 2012) in the inner section of the water spout pipe 2012, and the other end side of the water supply tube 2038 is extracted to the lower outside through the through opening 2122 formed near the center of the seating section 2018 of the stepped shape forming the bottom section of the hollow section in the water spout pipe 2012.

At this time, the other end side of the water supply tube 2038 abuts the back face 2124 becoming the face of the back side of the water supply tube 2038 of the inner face of the water spout pipe 2012, and moves the inner face of the water spout pipe 2012 downward toward the seating section 2018 along the back face.

For this reason, the other end of the water supply tube 2038, that is, the lower end abuts the seating section 2018 forming the stepped shape of the water spout pipe 2012, and then the water supply tube 2038 cannot be pushed into the inner section of the water spout pipe 2012.

That is, the lower end of the water supply tube 2038 enters the through opening 2122 and then cannot be extracted to the outside through the insertion pipe 2020.

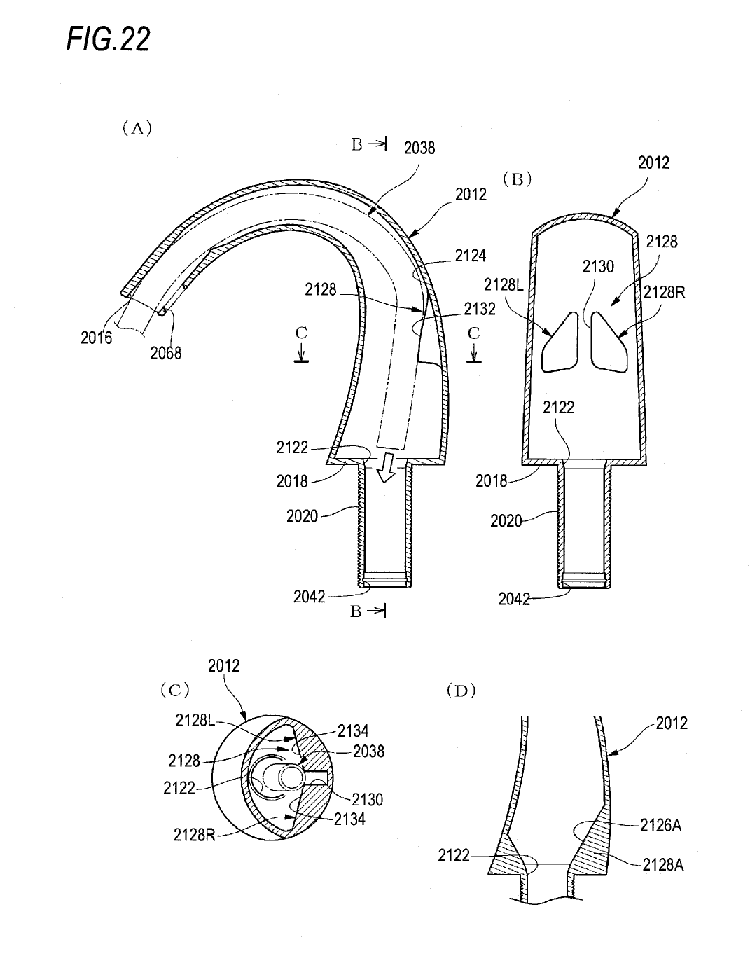

At this time, as shown in FIG. 22(D), it is considered that a section of the upper position of a certain height from the seating section 2018 of the water spout pipe 2012 is configured as the guide section 2128A having the slope guide face 2126A, and the lower end of the water supply tube 2038 is guided and led toward the through opening 2122 by the guide face 2126A of the guide section 2128A.

However, in this case, in the section provided with the guide section 2128, the water spout pipe 2012 becomes partially too thick, and the guide section 2128 may guide the lower end of the water supply tube 2038 while positioning the lower end of the water supply tube 2038 in two axes direction of the left-right direction and the right angle direction of the paper face perpendicular thereto. The thick guide section 2128 may be provided over the wide range around the pipe axis of the water spout pipe 2012. For this reason, when casting the water spout pipe 2012, the sink is generated by the existence of the guide section 2128 forming the partial thick section, and the sink appears on the appearance, and thus it is actually difficult to adopt that as the solving means.

Thus, in the present embodiment, as shown in FIG. 22, the guide section 2128 is provided in a position separated upward from the seating section 2018 of the water spout pipe 2012 by a predetermined distance, on the back face 2124 of the water spout pipe 2012.

Herein, the guide section 2128 has a longitudinal groove 2130 in a center in the left-right direction when viewed from the front, the left section of the groove 2130 forms the left guide section 2128L and the right section thereof forms the right guide section 2128R.

The left-right guide sections 2128L and 2128R increase the projection amount from the back face 2124 to the water supply tube 2038 on the guide face of the water supply tube 2038 side, as proceeding downward as shown in FIG. 22(A), and includes the longitudinal guide face 2132 inclined obliquely downward toward the through opening 2122.

Further, as shown in FIG. 22(C), the guide face includes a transverse guide face 2134 of the inclined shape continuously decreasing the projection amount, as proceeding toward the groove 2130. Herein, the transverse guide face 2134 is continuously formed downward from the upper end of the longitudinal guide face 2132 along the longitudinal guide face 2132.

In the present embodiment, when the water supply tube 2038 is inserted and pushed from the other end side into the inner section of the water spout pipe 2012 through the opening section 2016 of the tip of the water spout pipe 2012, the other end of the water supply tube 2038 firstly abuts the upper section of the back face 2124 of the water spout pipe 2012, specifically, the back face 2124 of the upper section forming the inverted U-shape, is guided to the back face 2124 forming the curved shape and is moved downward. Moreover, when reaching the position of the guide section 2128, the other end side of the water supply tube 2038 is guided to the guide section 2128 and is moved downward.

At this time, the position of the other end side of the water supply tube 2038 is guided to the center of the right angle direction of the paper face by the transverse guide face 2134 in the guide section 2128, and the other end side is guided to the through opening 2122 of the seating section 2018 by the guidance action of the longitudinal guide face 2132 while maintaining the position thereof.

Accordingly, when pushing the water supply tube 2038, the other end automatically enters the inner section of the through opening 2122 of the seating section 2018, and then is inserted through the insertion pipe 2020 and is extracted to the lower outside of the water spout pipe 2012. The shape of the longitudinal guide face 2132 of the guide section 2128 is set in advance.

Herein, since the guide section 2128 is provided on the upper section separated from the seating section 2018 of the water spout pipe 2012 by a predetermined distance, the projection amount toward the water supply tube 2038 can be reduced compared to that shown in FIG. 22(D). Further, since the longitudinal deep groove 2130 is provided in the left-right centers of the guide section 2128, by partially providing the thick section in the water spout pipe 2012 for the guide section 2128, the thickness can be reduced as compared to that shown in FIG. 22(D). Further, since the thick section is circumferentially divided by the groove 2130, that is, since the thick section is not circumferentially continued, even if the guide section 2128 is provided, the occurrence of the sink when casting the water spout pipe 2012 can be suppressed, and thus, it is possible to suppress that the sink appears on the appearance of the water spout pipe 2012 and the appearance of the water spout pipe 2012 is degraded.

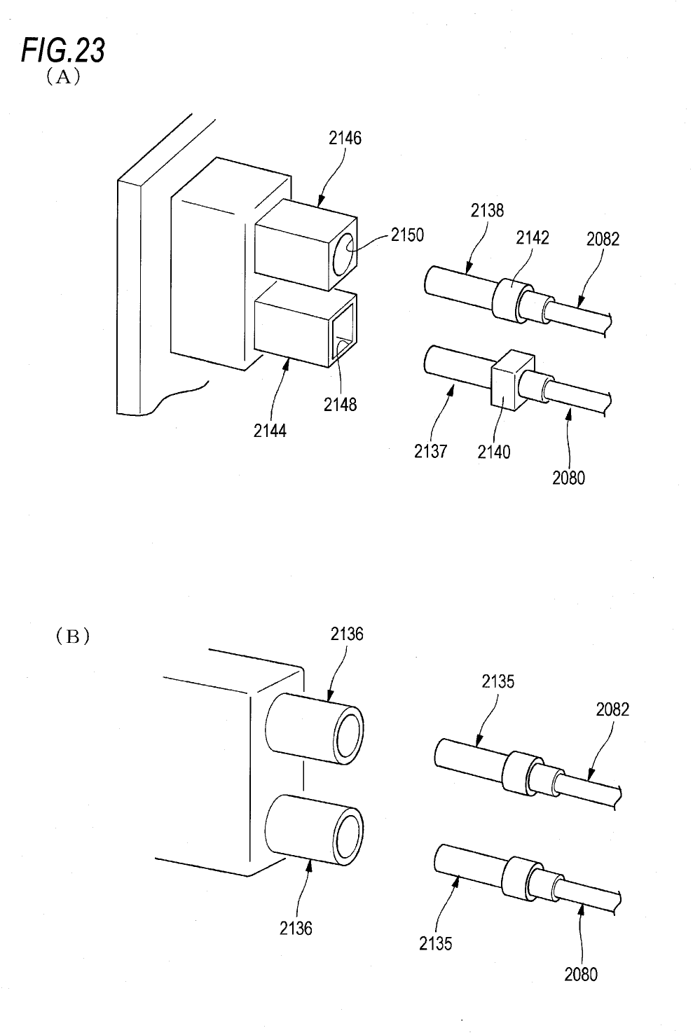

Further, as shown in FIG. 23(B), when inserting and connecting the respective insertion sections of the optical fibers 2080 on the light emitting side and the optical fiber 2082 on the light receiving side to the insertion port of the inner section of the function section box 2034, if the insertion sections of the optical fiber 2080 on the light emitting side and the optical fiber 2082 on the light receiving side are the insertion sections 2135 having the same shape, they are inserted into the insertion port 2136 of the same shape the two insertion sections 2135 and the insertion port 2136 can be used by the same shape, and then the required cost can be reduced. Meanwhile, in this case, the optical fiber 2080 on the light emitting side and the optical fiber 2082 on the light receiving side may be erroneously inserted to the insertion port 2136 of a side different from the original counterpart, and an erroneous insertion may occur.

Accordingly, in order to suppress this, as shown in FIG. 23(B), the insertion section 2137 of the optical fiber 2080 on the light emitting side and the insertion section 2138 of the optical fiber 2082 on the light receiving side have the shape different from each other. Specifically, for example, one of the shape of the fitting protrusion section 2142 is the fitting protrusion section 2140 of a rectangular shape, and the other is the fitting protrusion section 2142 of the circular shape, the fitting hole of the insertion port 2144 of the counterpart side is accordingly the fitting hole 2148 of the rectangular shape, the other fitting hole is the fitting hole 2150 of the circular shape, and the insertion sections 2137 and 2138 are inserted to the insertion ports 2144 and 2146. Thus, the insertion to the erroneous counterpart side, that is, the erroneous insertion can be appropriately suppressed.

Further, one of the fitting protrusion sections 2140 and 2142 has a large shape and the other thereof has a small shape, one of the fitting holes 2148 and 2150 has a large shape and the other thereof has a small shape accordingly, and thus the erroneous insertion can be suppressed. Otherwise, the insertion sections 2137 and 2138 are not formed as separate insertion sections but an integral insertion section, and the insertion ports 2144 and 2146 are an integral insertion port accordingly. Accordingly, the erroneous insertion can also be suppressed.

An embodiment of the present invention has been described in detail, but this is an example. The present invention can also be applied to a case where the light emitting section and the light receiving section are configured in the tip section of the optical fiber, as well as a case where they are configured in the light emitting element and the light receiving element. Thus, the present invention can be configured by the forms with various modifications added in the scope without departing from the gist thereof.

Further, another embodiment of the present invention will be described in detail based on the drawings.

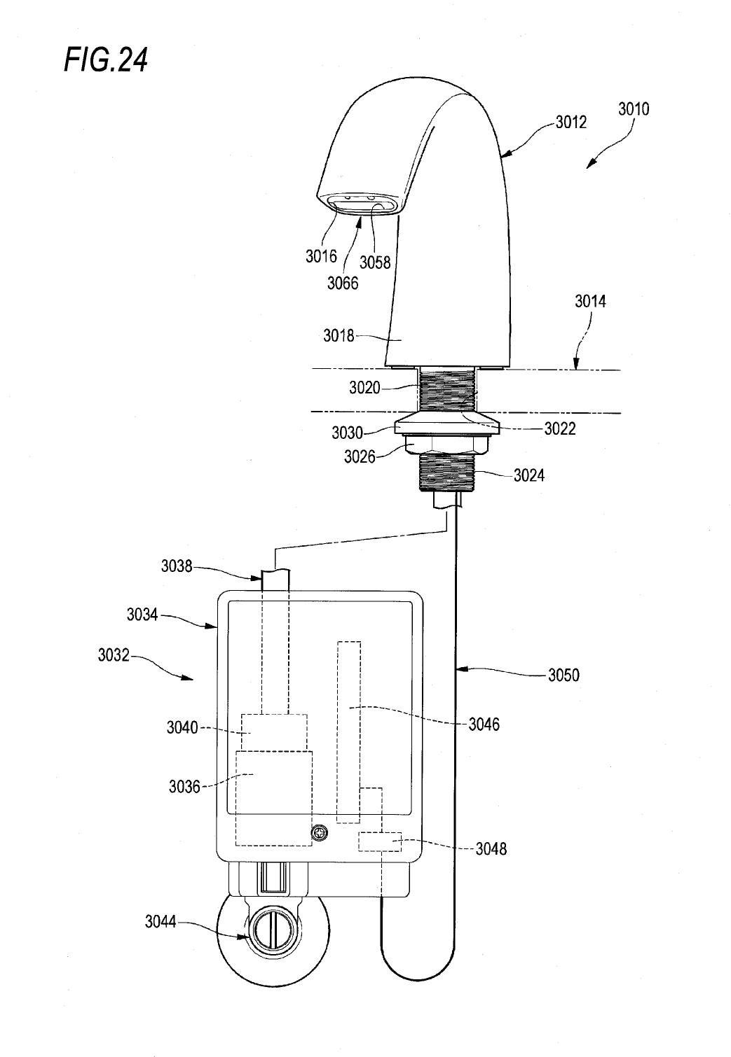

In FIG. 24, reference numeral 3010 is an automatic faucet including the water discharging device of the present embodiment, and reference numeral 3012 is a water spout pipe in the water discharging device. Herein, the water spout pipe 3012 is made of a metal.

The water spout pipe 3012 is installed in the form standing from a counter (an attachment base) 3014, and an upper section forms a goose neck shape that is inverted U-shaped with respect to a user. The tip face thereof is directed forward and obliquely downward to a user.

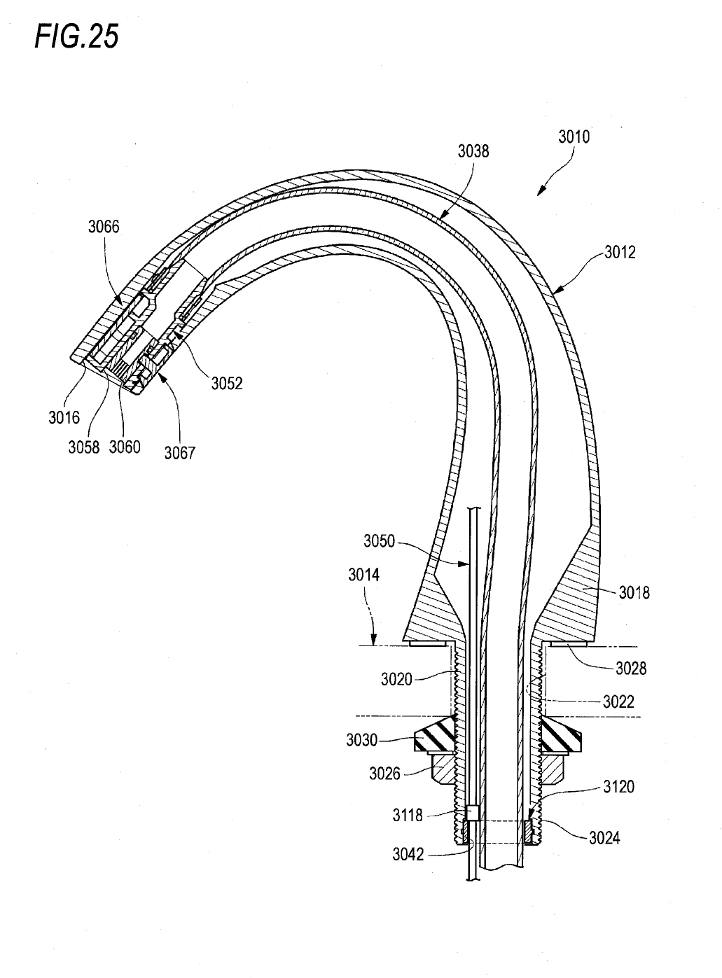

As shown in FIGS. 24 and 25, the water spout pipe 3012 is formed with a substantially elliptical opening 3016 corresponding to the transverse cross-sectional shape of the water spout pipe 3012 on the tip face thereof.

As shown in FIG. 25, the water spout pipe 3012 has a seating section 3018 on a base end side thereof, and an insertion pipe 3020 is extended downward from the seating section 3018.

The insertion pipe 3020 is inserted through an attachment hole 3022 of the counter 3014 and is projected to the lower side of the counter 3014, and a fixing nut 3026 is screwed into a male screw section 3024 provided on an outer circumferential face thereof.

The water spout pipe 3012 is set so that the seating section 3018 seats on the upper face of the counter 3014, and is attached to the counter 3014 in a state of interposing the counter 3014 from both sides of up and down via packings 3028 and 3030 by the seating section 3018 and the fixing nut 3026.

In FIG. 24, reference numeral 3032 is a main body function section placed below the counter 3014, and reference numeral 3034 is a function section box of the main body function section 3032 and an electromagnetic valve 3036 is accommodated therein.

The electromagnetic valve 3036 is a valve that opens and closes the water supply path supplying the water from the water supply source pipe to the water spout 3058 (FIG. 25), and the lower end of the water supply tube 3038 is connected to the electromagnetic valve 3036 via the joint 3040.

The water supply tube 3038 is a member forming a part of the water supply path, is extended upward from the function section box 3034, and enters from the opening 3042 of the lower end of the insertion pipe 3020 integrally formed in the water spout pipe 3012 into the inner section of the water spout pipe 3012.

The water supply tube 3038 extends the inner section of the water spout pipe 3012 up to the tip section.

Additionally, in the example, the water supply tube 3038 has flexibility and is formed by a polyurethane resin.

Additionally, in FIG. 24, reference numeral 3044 indicates a stopcock.

In the inner section of the function section box 3034, a control section 3046 including a microcomputer as a main element, and a sensor main body 3048 including the sensor as a main element are accommodated.

The control section 3046 controls the operation of the electromagnetic valve 3036, opens the electromagnetic valve 3036 based on the detection of the detection target using the sensor, and closes the electromagnetic valve 3036 when the sensor does not detect the detection target.

The sensor main body 3048 has a light emitting element such as an LED emitting the light (herein, an infrared light), a photodiode, a light receiving element such as a phototransistor, and a sensor circuit which includes a light emitting driving circuit that performs the light emitting using the light emitting element, and a photoelectric conversion circuit that converts the light received by the light receiving element into the electric signal and processes the signal.

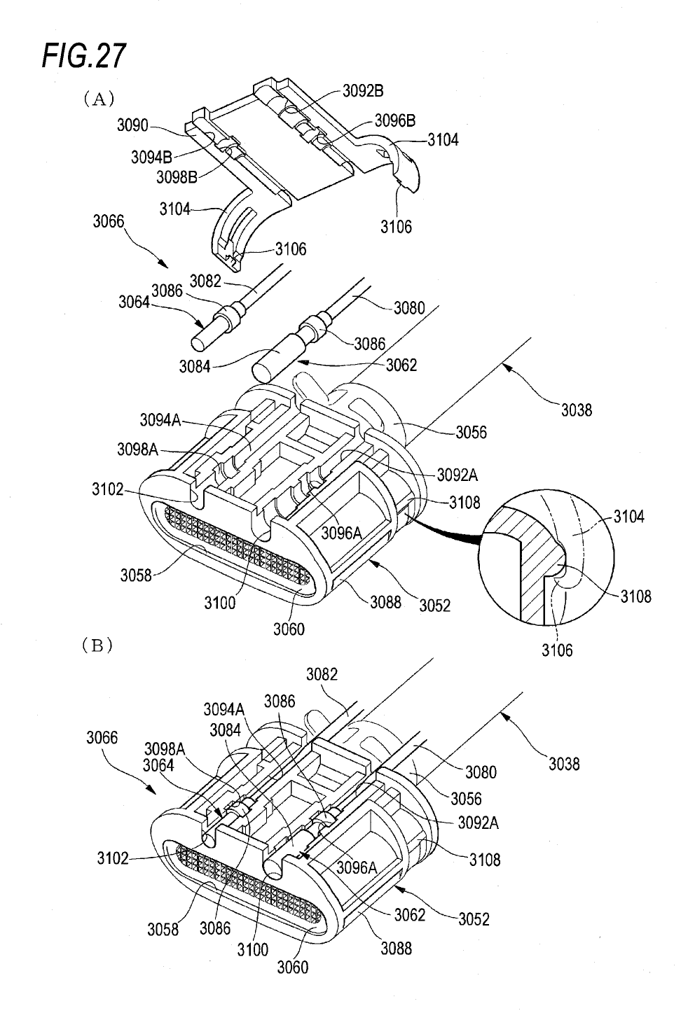

The optical fiber 3080 (see FIG. 27) on the light emitting side is projected from the light emitting element of the sensor main body 3048, and the optical fiber 3082 on the light receiving side is extended from the light receiving element.

Reference numeral 3050 is a cord of the optical fiber, which bundles the two optical fibers 3080 and 3082 into one piece, is extended from the sensor main body 3048, and enters from the opening 3042 of the base end of the water spout pipe 3012 as shown in FIG. 25 into the inner section of the water spout pipe 3012.

The cord 3050 extends the inner section of the water spout pipe 3012 up to the tip section thereof.

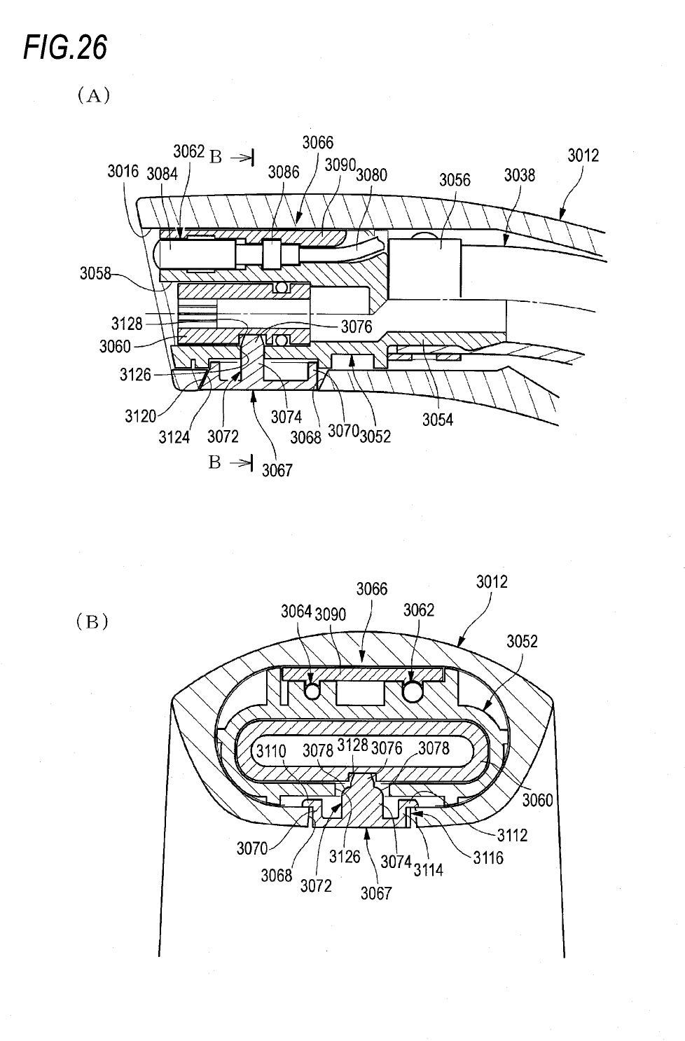

As shown in FIG. 26, in the inner section of the front end section of the water spout pipe 3012, a water spout member 3052 is housed.

In the present example, the water spout member 3052 is made of resin (herein, POM resin (polyacetal resin)), and has a cylindrical shape of a substantially elliptical shape corresponding to the shape of the tip section of the water spout pipe 3012 as a whole.

The water spout member 3052 integrally includes a cylindrical insertion section 3054. When the insertion section 3054 is pressed into the water supply tube 3038, the water spout member 3052 is connected and fixed to the water supply tube 3038 by a band-shaped clamping member 3056 clamping the water supply tube 3038 from the outer circumferential face.

As shown in FIG. 27, the opening of the tip of the water spout member 3052 is the water spout 3058, and a discharging end member 3060 is placed in the water spout 3058 for making the water stream pass thereof and controlling the discharge pattern of the discharged water from the water spout 3058.

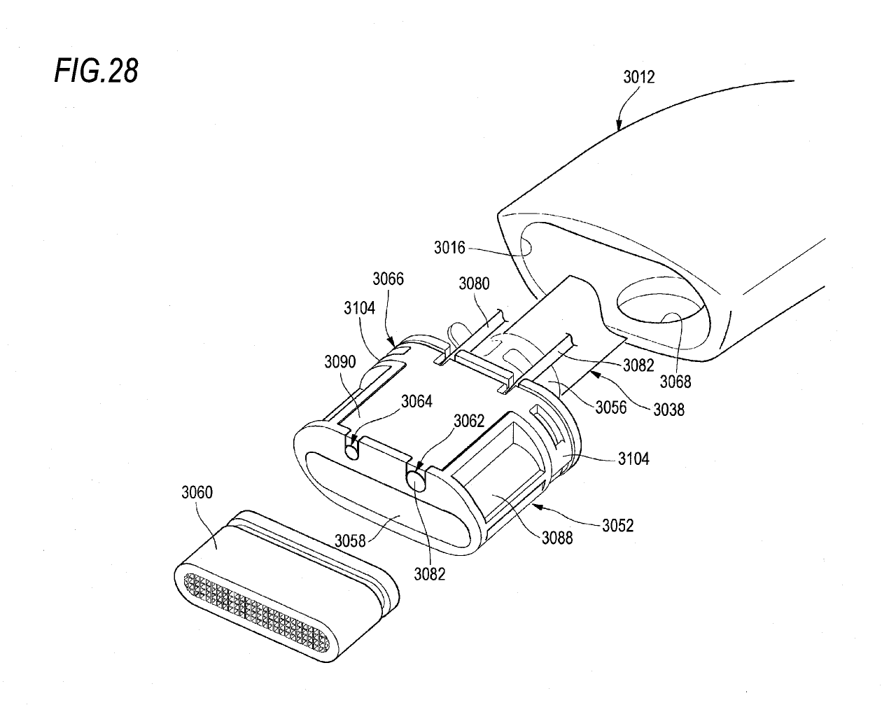

Specifically, the discharging end member 3060 has a cylindrical shape having a transverse cross-sectional shape of a flattened elliptical shape, the discharging end member 3060 is inserted into the inner section of the water spout member 3052 forming the cylindrical shape in the fitted state as shown in FIG. 28, and is held in the water spout member 3052 in the position slightly on the back-side of the water spout 3058.

That is, in the present embodiment, a dedicated housing for the discharging end member 3060, which accommodates and holds the discharging end member 3060 in the inner section in the anti pull-out state, is not provided, and the discharging end member 3060 houses the water spout member 3052 as the housing in the inner section thereof.

In the present embodiment, the discharging end member 3060 rectifies and discharges the water stream sent from the water tube 3038. That is, the discharge pattern of the discharged water is changed into the rectified discharged water of one bundle.

However, the water sent through the water supply tube 3038 can be discharged as the foam stream with the mixed air bubble or the shower stream. Otherwise, the discharged water can be discharged by other various patterns.

In the embodiment, the discharging end member 3060 and the water spout member 3052 configure a water spout unit 3066 together with the light emitting section 3062 and the light receiving section 3064, which is described below.

Moreover, in the water spout unit 3066, the discharging end member 3060 and the water spout member 3052 are commonly fixed in the fixing hole 3068 provided in the water spout pipe 3012 by the fixing member 3067 shown in FIG. 26.

The fixing structure will be described later.

In FIG. 27, reference numeral 3080 is an optical fiber on a light projection side, reference numeral 3082 is an optical fiber on a light receiving side, and the light projection section 3062 and the light receiving section 3064 are configured by the tip section of the optical fiber 3080 of the light projection side and the optical fiber 3082 on the light receiving side.

Additionally, the light projection section 3062 is provided with a lens 3084 for making the projected light have directivity.

Additionally, the optical fibers 3080 and 3082 are integrally provided with an annular convex section 3086 for fixing them to the water spout member 3052 in the axially positioned state.

In the present embodiment, the water spout member 3052 has a main body section 3088 and a cover 3090 that covers the upper face thereof.

The main body section 3088 is provided with deep holding grooves 3092A and 3094A extended in the axial direction of the optical fibers 3080 and 3082. Further, the corresponding shallow holding grooves 3092B and 3094B are also provided on the side of the cover 3090. The optical fibers 3080 and 3082 are fitted and held to the holding grooves 3092A, 3092B, 3094A and 3094B.

The holding grooves 3092A, 3092B, 3094A and 3094B are provided with concave sections 3096A, 3096B, 3098A and 3098B corresponding to the convex section 3086 of the optical fibers 3080 and 3082. The optical fiber 3080 is fixed and held to the water spout member 3052 in the axially positioned state by the concave and convex fitting between the convex section 3086 and the concave sections 3096A and 3096B, and optical fiber 3082 is fixed and held to the water spout member 3052 in the axially positioned state by the concave and convex fitting between the convex section 3086 and the concave sections 3098A and 3098B.

Further, the water spout member 3052 is provided with the U-shaped notched light projection window 3100 and the light receiving window 3102 in the front end thereof.

Further, the cover 3090 is integrally formed a pair of curved elastic arms 3104, and the cover 3090 is assembled to the main body section 3088 by elastically engaging the claws 3106 of the tips of the pair of elastic arms 3104 with the corresponding engaging protrusions 3108 of the main body section 3088.

In the present embodiment, the sensor is configured by the sensor main body 3048 shown in FIG. 24, the cord 3050 extended therefrom, the light emitting section 3062 configured in the tip section of the optical fibers 3080 and 3082, and the light receiving section 3064. When the sensor detects a detection target, normally, a hand provided by a user, the electromagnetic valve 3036 is opened under the control using the control section 3046, and water is automatically discharged from the water spout 3058 of FIG. 26.

When a user retracts a hand from the detection area by the sensor, the sensor does not detect the hand, and then the electromagnetic valve 3036 is closed under the control of the control section 3046, and the water discharge from the water spout 3058 is stopped.

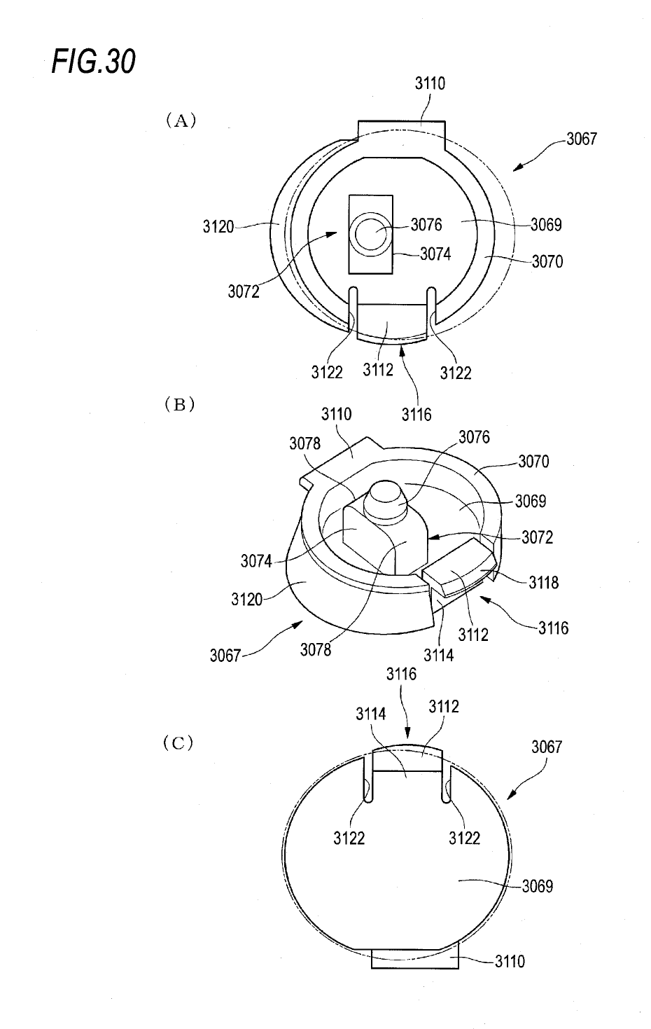

The fixing member 3067 is a push-button type member having a circular plan shape, and, as shown in FIG. 30, integrally has a circular circumferential wall section 3070 standing from the bottom section 3069, and a fitting shaft section 3072 standing from the bottom section 3069 in the inner side of the circumferential wall section 3070.

The fitting shaft section 3072 is placed in a position eccentric from the center of the bottom section 3069 to the left side of the drawing when viewed from the plane shown in FIG. 30(A), and has a first fitting section 3074 of the base end side and a second fitting section 3076 projected upward.

As shown in FIG. 30(A), the first fitting section 3074 has a rectangular shape having the plane shape longer in the up-down direction of the drawing, and the corner section thereof forms the curved shape as shown in FIG. 30(B). Reference numeral 78 in FIG. 30(B) indicates the curved section.

The second fitting section 3076 has the plane circular shape having the diameter substantially similar to the width size (the left-right direction size of FIG. 30(A)) of the first fitting section 3074, and the upper section thereof forms the taper shape.

In the circumferential wall section 3070 of the fixing member 3067, in a position separated circumferentially by 180 degrees, in other words, in the end section of the opposite side of the bottom section 3069, in a position facing the radial direction, claw sections 3110 and 3112 caught in an edge section of a fixing hole 3068 mentioned below are provided in the shape of projecting in the radial direction.

One claw section 3110 is integrally formed in the circumferential wall section 3070 in the fixed state, and the other claw section 3112 is integrally formed in the tip section of the elastic piece 3114 formed in a part of the circumferential wall section 3070. The elastic pieces 3114 and the claw section 3112 configure the elastic claw 3116 having the elastic deformability in the radial direction.

Herein, the outer face of the elastic piece 3114 is positioned to be retracted on the inside in the radial direction than the other section of the circumferential wall section 3070, and the claw section 3112 is provided with a sloped cam face 3118.

Further, the claw section 3110 has the large catching margin with respect to the edge section of the fixing hole 3068 compared to the claw section 3112.

As shown in FIG. 26(B), the fixing member 3067 is fixed to the water spout pipe 3012 in the direction positioning the claw sections 3110 and 3112 left-right when viewed from the front side with respect to the water spout pipe 3012.

In FIG. 30(A), reference numeral 3122 is a recess which formed on the circumferential wall section 3070 to give the elastic piece 3114 the elastic deformability.

Further, as shown in FIG. 30(B), the outer circumferential face of the circumferential wall section 3070 is a partial taper face 3120, in which a radius of a section of a left side of the drawing between the claw sections 3110 and 3112 is gradually reduced, as proceeding toward an end section of the opposite side of the bottom section 3069.

Additionally, a section of an opposite side of the taper face 3120 of the outer circumferential face of the circumferential wall section 3070 between the claw sections 3110 and 3112 is a face formed in a straight shape in the axial direction.

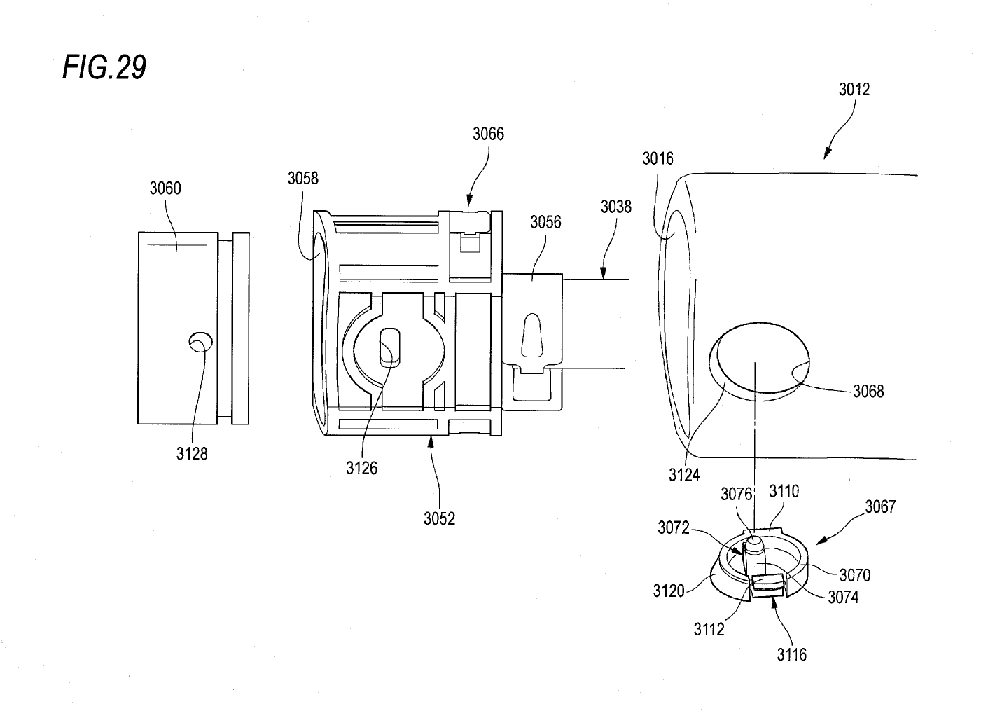

Meanwhile, in the fixing hole 3068 formed in the water spout pipe 3012, the plane shape is an elliptical shape having a hole radius corresponding to the fixing member 3067 as shown in FIG. 29.

However, the shape of the inner circumferential face of the fixing hole 3068 is configured so that the section corresponding to the taper face 3120 of FIG. 30(B) in the fixing member 3067 has a inclined face 3124 that is inclined at the same angle as that of the taper face 3120, and the inner circumferential face of the opposite side thereof has a inclined face that is inclined at the same angle in the same direction as that of the inclined face 3124 as shown in FIG. 26(A).

The water spout member 3052 and the discharging end member 3060 inserted therein in the fitted state are provided with fitting holes 3126 and 3128 each corresponding to a first fitting section 3074 and a second fitting section 3076 in the fitting shaft section 3072 of the fixing member 3067 as shown in FIGS. 26 and 29.

Herein, the fitting hole 3126 is formed in a shape penetrating through the circumferential wall of the water spout member 3052, and the fitting hole 3128 of the side of the discharging end member 3060 is provided in a shape with a bottom and is not penetrating the cylinder wall of the discharging end member 3060.

Herein, the fitting hole 3126 of the water spout member 3052 and the fitting hole 3128 of the discharging end member 3060 are provided in a form which overlap each other in a direction penetrating the pipe wall through the fixing hole 3068 in the water spout pipe 3012.

Specifically, herein, the fitting holes 3126 and 3128 are placed in an eccentric position corresponding to the placing position of the fitting shaft section 3072 in the fixing member 3067 with respect to the center of the fixing hole 3068.

Further, the fitting hole 3126 of the water spout member 3052 has a size corresponding to the first fitting section 3074 in the fitting shaft section 3072. The fitting hole 3128 of the side of the discharging end member 3060 is formed in a shape smaller than the fitting hole 3126 when viewed from the front in FIG. 26(B) and in a shape corresponding to the second fitting section 3076 (however, the fitting holes 3126 and 3128 are formed to have the same size in the front-back direction as shown in FIG. 26(A), that is, in the pipe axial direction of the water spout pipe 3012).

In the embodiment, by only pushing the fixing member 3067 from a downside and the outside of the water spout pipe 3012 to the fixing hole 3068 of the water spout pipe 3012, the discharging end member 3060 and the water spout member 3052 can be fixed to the water spout pipe 3012 by the common fixing member 3067.

In FIG. 26, when pushing the fixing member 3067 upward, the circumferential wall section 3070 of the fixing member 3067 is fitted to the fixing hole 3068, the first fitting section 3074 of the fitting shaft section 3072 in the fixing member 3067 is fitted to the fitting hole 3126 of the water spout member 3052, and the second fitting section 3076 is fitted to the fitting hole 3128 of the discharging end member 3060. In this state, by the concave and convex fitting, the fixing member 3067 is fixed to the water spout pipe 3012 in the fixing hole 3068, and the water spout member 3052 and the discharging end member 3060 are fixed to the water spout pipe 3012.

At this time, as shown in FIG. 26, the water spout member 3052 and the discharging end member 3060 are in a fixed state in the front-back direction with respect to the water spout pipe 3012, that is, the pipe axial direction and in the left-right direction.

However, the gap between the fitting shaft section 3072 and the fitting holes 3126 and 3128 is small in the pipe axial direction as shown in FIG. 26(A) and is large in the left-right direction as shown in FIG. 26(B). In this manner, the shapes of the fitting holes 3126 and 3128 are defined in advance.

The reason thereof will be described later.

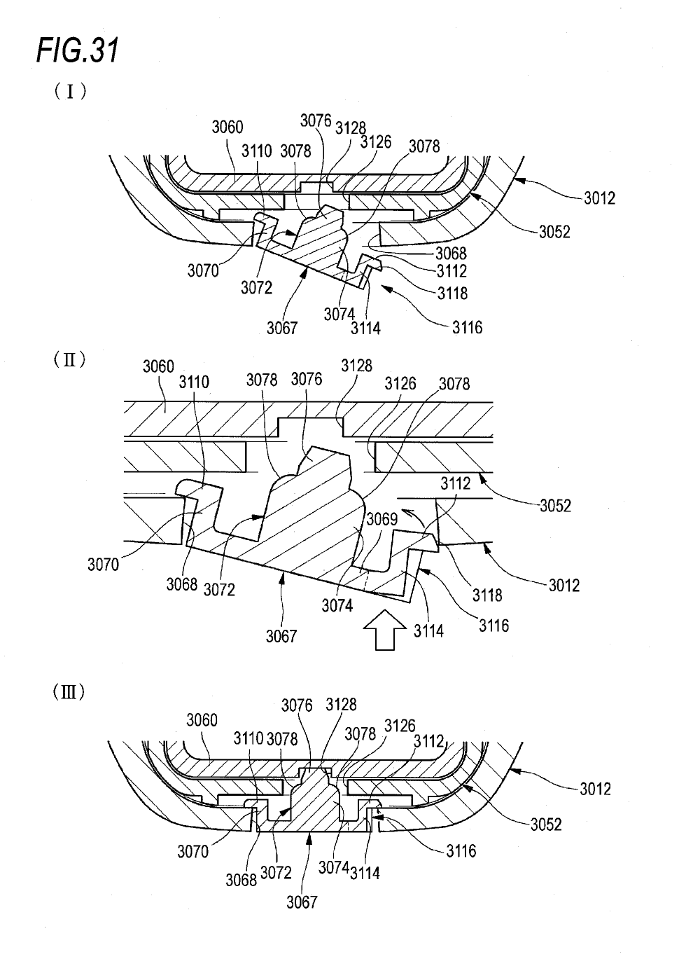

FIG. 31 shows a process of fixing the fixing member 3067 to the water spout pipe 3012 in the fixing hole 3068.

As shown in FIG. 31(I), herein, the fixing member 3067 is inclined so that the claw section 3110 of the fixing side of the pair of claw sections 3110 and 3112 is positioned on the upper side, and the claw section 3110 is firstly caught in the edge section of the fixing hole 3068 to be inserted from the side of the claw section 3110 to the fixing hole 3068.

Additionally, at this time, when inserting the claw section 3110 to the fixing hole 3068 and catching the edge section of the fixing hole 3068, a specific resistance is not generated. Thus, the operation can be easily performed at weak force.

Next, as shown in FIG. 31(II), the elastic claw 3116 positioned on the opposite side of the claw section 3110 is elastically deformed, and is pushed into the inner section of the fixing hole 3068.

At this time, there is a need for force, which elastically deforms the elastic claw 3116, specifically, the elastic piece 3114, but the claw section 3112 of the elastic claw 3116 has the small catching margin relating to the edge section of the fixing hole 3068, and thus, the resistance of this time can be made as small as possible.

Further, since the claw section 3112 is formed with a cam face 3118 performing the guidance act when pushing the elastic claw 3116, this can be smoothly pushed into the fixing hole 3068.

In this manner, when pushing the fixing member 3067 into the fixing hole 3068, the pair of claw sections 3110 and 3112 in the pushed state is caught in the edge section of the fixing hole 3068, and the circumferential wall section 3070 is fitted into the fixing hole 3068 in the fitted state. Accordingly, the fixing member 3067 is fixed to the water spout pipe 3012.

At the same time, the fitting shaft section 3072 is fitted to fitting hole 3126 of the water spout member 3052 and the fitting hole 3128 of the discharging end member 3060, and the water spout member 3052 and the discharging end member 3060 are fixed to the water spout pipe 3012.

As shown in FIGS. 31(I) and (II), when pushing and fixing the fixing member 3067 to the fixing hole 3068, the fixing member 3067 is pushed into the fixing hole 3068 while slightly being rotated and moved, centered on the claw section 3110 caught in the fixing hole edge section.

At this time, since the fitting shaft section 3072 is also similarly slightly rotated and moved, the size of the fitting hole 3126 in the left-right direction with respect to the first fitting section 3074 is greatly formed to allow the rotation movement thereof.

Similarly, the fitting hole 3128 of the discharging end member 3060 has the large size in the left-right direction with respect to the second fitting section 3076.

For this reason, as shown in FIGS. 26(B) and 31(III), a fixed gap is generated between the first fitting section 3074 and the fitting hole 3126 and between the second fitting section 3076 and the fitting hole 3128 under the state fixing the fixing member 3067.

On the contrary, as shown in FIG. 26(A), in the front-back direction, the gap is nearly generated between the fitting shaft section 3072 and the fitting holes 3126 and 3128.

The sizes of the fitting holes 3126 and 3128 are defined in advance.

For example, in a case where the fixing member 3067 is attached and fixed to the water spout pipe 3012 so that the pair of claw sections 3110 and 3112 is positioned in the front-back direction of FIG. 26(A), a relatively large gap shown in FIG. 26(B) is generated in the front-back direction. In this case, the water spout member 3052 and the discharging end member 3060 generate the backlash in the front-back direction with respect to the water spout pipe 3012, and the assembling position is varied in the front-back direction. Depending on cases, the water spout member 3052 may be assembled in a position projected forward than the tip of the water spout pipe 3012.

In this case, the water spout member 3052 is appeared to a user, and the appearance of the tip section of the water spout pipe 3012 may be degraded.

In the present embodiment, since the fixing member 3067 is fixed to the water spout pipe 3012 so that the pair of claw sections 3110 and 3112 is positioned in the left-right direction, such a disadvantage is not generated. The water spout member 3052 and the discharging end member 3060 can be correctly assembled in the set position without the backlash, and the appearance of the tip section of the water spout pipe 3012 can be made good.

Further, when fitting the fixing member 3067 to the fixing hole 3068 of the water spout pipe 3012, it is considered that the fixing member 3067 needs to be inserted from the side of the claw section 3110 of the fixing side into the fixing hole 3068, but that is erroneously inserted from the claw section 3112 of the side of the elastic claw 3116 of the opposite side into the fixing hole 3068. Thus, herein, the shape of the fixing member 3067, the positions of the respective fitting holes 3126 and 3128 of the water spout member 3052 and the discharging end member 3060 or the like are defined so that such a problem can be suppressed.

Specifically, the fitting shaft section 3072 of the fixing member 3067 is positioned in an eccentric position from the center thereof, and the fitting holes 3126 and 3128 are placed in the eccentric position in the position corresponding thereof. Thus, even when inserting the fixing member 3067 from the side of the claw section 3112 of the elastic claw 3116 into the fixing hole 3068, since the fitting shaft section 3072 can be fitted to the fitting holes 3126 and 3128, such an operation cannot be performed.

Further, the pushing end of the fixing member 3067 is defined by the fact that the second fitting section 3076 abuts the bottom section of the fitting hole 3128 of the discharging end member 3060 and the partial taper face 3120 of the fixing member 3067 abuts the corresponding inclined face 3124 of the fixing hole 3068.

As mentioned above, according to the present embodiment, there is no need for a dedicated housing which holds the discharging end member 3060 in the inner section in the anti pull-out state required in the related art, the number of the required component can be reduced, each of the discharging end member 3060 and the water spout member 3052 is fixed to the water spout pipe 3012 by the common fixing member 3067. Thus, they can be fixed to the water spout pipe 3012 in one location, the structure can be simplified, and the workability during assembling work and during maintenance work is good, so that it is possible to easily perform the assembling and the maintenance work.

According to the present invention, simply by fitting the fitting shaft section 3072 of the fixing member 3067 to each fitting hole 3126 and 3128 of the water spout member 3052 and the discharging end member 3060, they can be easily fixed and attached to the water spout pipe 3012 by the common fixing member 3067.

According to the present invention, the fixing hole 3068 has the diameter greater than the respective fitting holes 3126 and 3128 of the discharging end member 3060 and the water spout member 3052, the fixing member 3067 is provided with a circumferential wall section 3070 having the corresponding outer diameter, and the circumferential wall section 3070 is fitted to the fixing hole 3068. Thus, the fixing strength with respect to the water spout pipe 3012 of the fixing member 3067 itself can be strengthened, and the fixing strength with respect to the water spout pipe 3012 of the discharging end member 3060 and the water spout member 3052 can be increased.

Additionally, the fixing member 3067 can also be fixed to the water spout pipe 3012 to be projected from the water spout pipe 3012.

Further, according to the present embodiment, the fixing member 3067 can be easily fixed to the water spout pipe 3012 by small force, it is possible to increase the fixing force of the fixing member 3067 to the water spout pipe 3012 and the reliability of the fixing, so that it is possible to avoid the anxiety that the fixing member 3067 is detached from the water spout pipe 3012.

In the present embodiment, when catching the one claw section 3110 provided in the fixed state to the edge section of the fixing hole 3068, there is no need for strong force, and thus it is possible to greatly secure the catching margin of the claw section 3110 to the fixing hole 3068 edge section.

Meanwhile, since the elastic claw 3116 may be provide only in one side in the radial direction, by reducing the catching margin of the claw section 3112 in the elastic piece 3114 to the fixing hole 3068 edge section, the pushing of the elastic piece 3114 can be easily performed by small force. Nonetheless, according to the present embodiment, since the catching margin of the claw section 3110 of the fixing side and the claw section 3112 of the elastic claw 3116 to the entire fixing hole 3068 edge section can be greatly secured, the fixing member 3067 can be easily fixed to the water spout pipe 3012, so that it is possible to appropriately suppress the fixing member 3067 from being detached from the water spout pipe 3012.

Although the present embodiment has been described in detail, this is just a example, and the present invention can be configured in a form with various modifications added without departing from the gist thereof such that the present invention can also use a component other than a bis as the common fixing tool.

Next, another embodiment of the present invention will be described in detail based on the drawings.

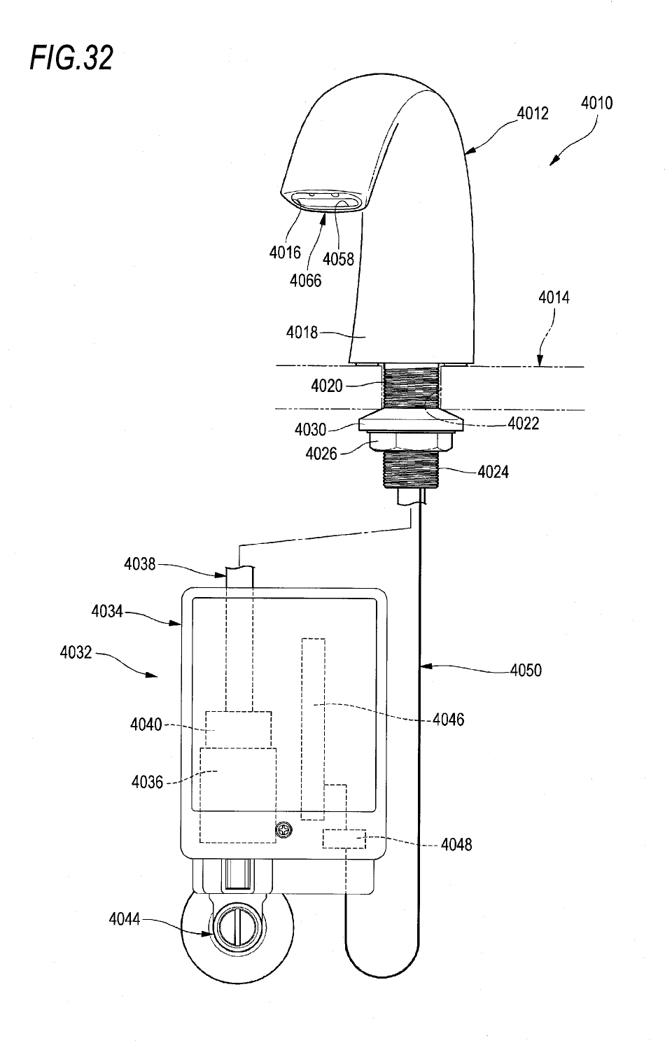

In FIG. 32, reference numeral 4010 is an automatic faucet of the present embodiment, and reference numeral 4012 is a water spout pipe in the automatic faucet 4010. Herein, the water spout pipe 4012 is made of a metal or casting.

The water spout pipe 4012 is installed in the form standing from a counter (an attachment base) 4014, and an upper section forms a goose neck shape that is inverted U-shaped with respect to a user.

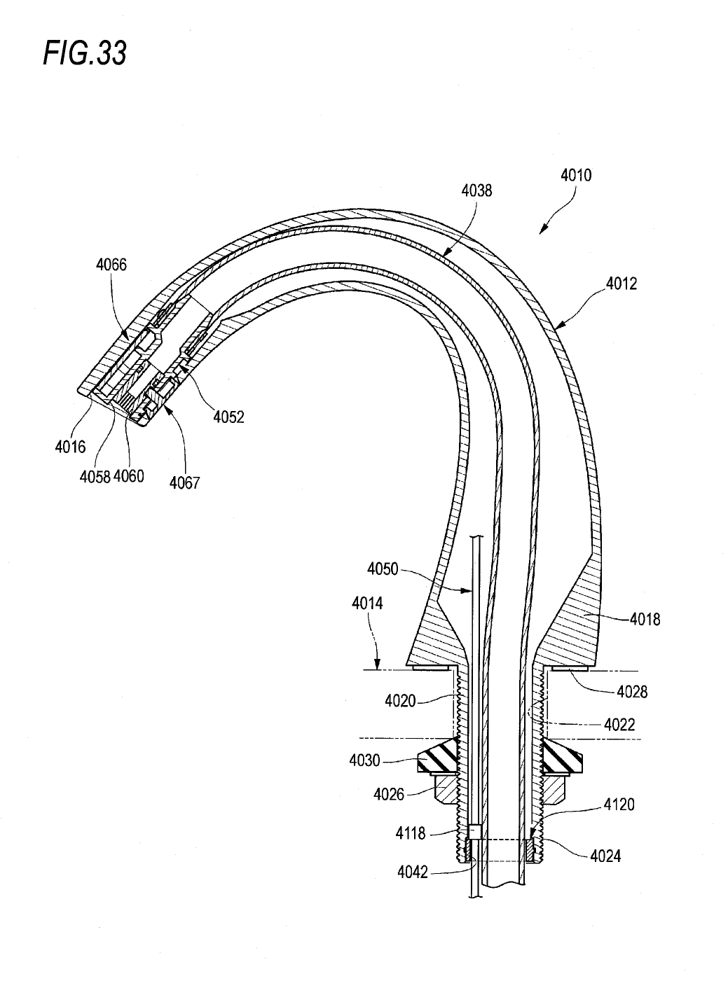

As shown in FIGS. 32 and 33, the water spout pipe 4012 is formed with a substantially elliptical opening 4016 corresponding to the transverse cross-sectional shape of the water spout pipe 4012 on the tip face thereof.

As shown in FIG. 33, the water spout pipe 4012 has a seating section 4018 on a base end side thereof, and an insertion pipe 4020 is extended downward from the seating section 4018.

The insertion pipe 4020 is inserted through an attachment hole 4022 of the counter 4014 and is projected to the lower side of the counter 4014, and a fixing nut 4026 is screwed into a male screw section 4024 provided on an outer circumferential face thereof.

The water spout pipe 4012 is set so that the seating section 4018 seats on the upper face of the counter 4014, and is attached to the counter 4014 in a state of interposing the counter 4014 from both sides of up and down via packings 4028 and 4030 by the seating section 4018 and the fixing nut 4026.

In FIG. 32, reference numeral 4032 is a main body function section placed below the counter 4014, and reference numeral 4034 is a function section box of the main body function section 4032 and an electromagnetic valve 4036 is accommodated therein.

The electromagnetic valve 4036 is a valve that opens and closes the water supply path supplying the water from the water supply source pipe to water spout 4058 (FIG. 33), and the lower end of the water supply tube 4038 is connected to the electromagnetic valve 4036 via the joint 4040.

The water supply tube 4038 is a member forming a part of the water supply path, is extended upward from the function section box 4034, and enters from the opening 4042 of the lower end of the water spout pipe 4012 into the inner section of the water spout pipe 4012.

The water supply tube 4038 extends the inner section of the water spout pipe 4012 up to the front end section,

Additionally, in the example, the water supply tube 4038 has flexibility and thus is formed by a polyurethane resin.

Additionally, in FIG. 32, reference numeral 4044 indicates a stopcock.

In the inner section of the function section box 4034, a control section 4046 including a microcomputer as a main element, and a sensor main body 4048 including the sensor as a main element are accommodated.

The control section 4046 controls the operation of the electromagnetic valve 4036, opens the electromagnetic valve 4036 based on the detection of the detection target using the sensor, and closes the electromagnetic valve 4036 when the sensor does not detect the detection target.

The sensor main body 4048 has a light emitting element such as an LED emitting the light (herein, an infrared light), a photodiode, a light receiving element such as a phototransistor, and a sensor circuit which includes a light emitting driving circuit that performs the light emitting using the light emitting element, and a photoelectric conversion circuit that converts the light received by the light receiving element into the electric signal and processes the signal.

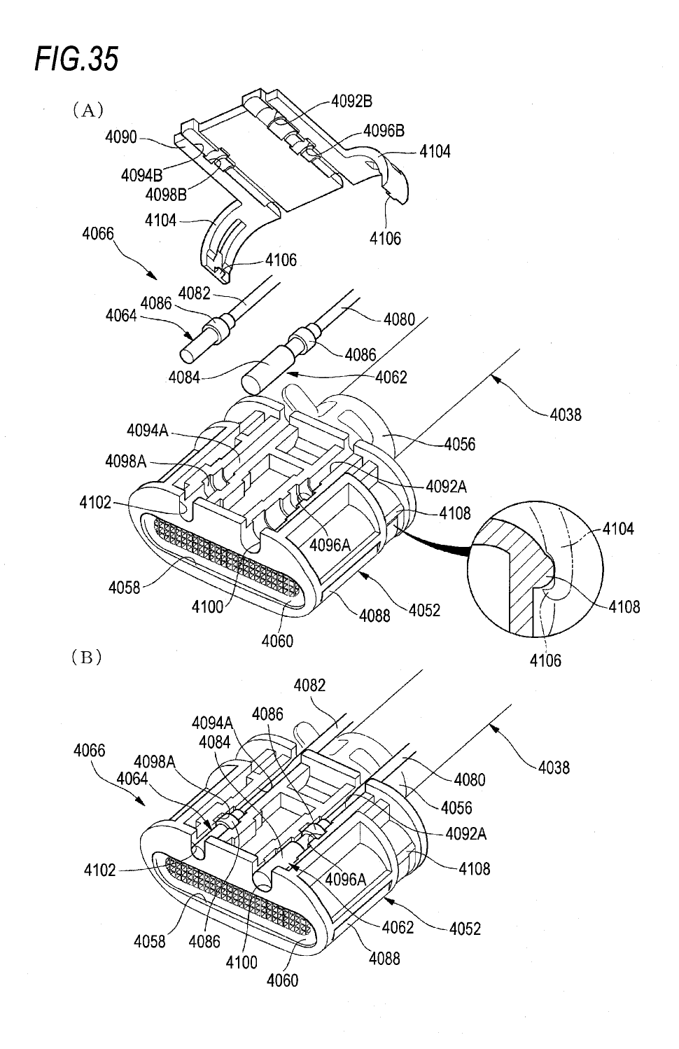

The optical fiber 4080 (see FIG. 35) on the light emitting side is projected from the light emitting element of the sensor main body 4048, and the optical fiber 4082 on the light receiving side is extended from the light receiving element.

Reference numeral 4050 is a cord of an optical fiber which bundles the two optical fibers 4080 and 4082 into one piece. The cord is extended from the sensor main body 4048, and, as shown in FIG. 33, enters from the opening 4042 of the base end of the water spout pipe 4012 into the inner section of the water spout pipe 4012.

The cord 4050 is further extended in the inner section of the water spout pipe 4012 up to the tip section thereof.

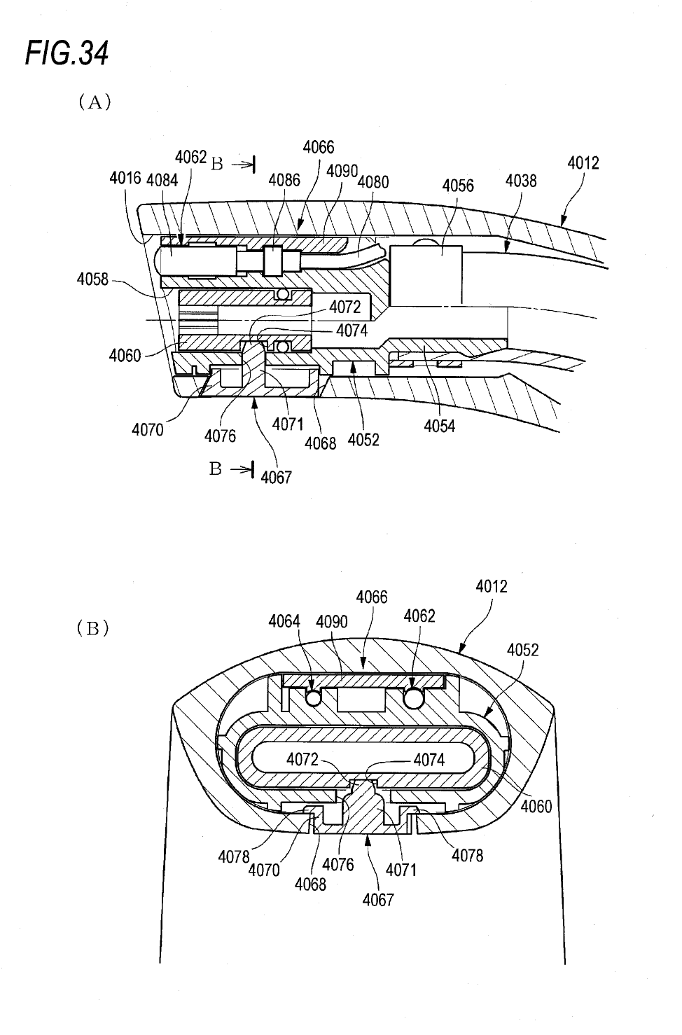

As shown in FIG. 34, in the inner section of the front end section of the water spout pipe 4012, a water spout member 4052 is housed.

In the present example, the water spout member 4052 is made of resin (herein, POM resin (polyacetal resin)), and has a cylindrical shape of a substantially elliptical shape corresponding to the shape of the front end section of the water spout pipe 4012 as a whole.

The water spout member 4052 integrally includes a cylindrical insertion section 4054. When the insertion section 4054 is pressed into the water supply tube 4038, the holding section 4052 is connected and fixed to the water supply tube 4038 by a band-shaped clamping member 4056 clamping the water supply tube 4038 from the outer circumferential face.

As shown in FIG. 35, the opening of the tip of the water spout member 4052 forms the water spout 4058, and the discharging end member 4060 defining the discharging pattern of the discharged water is housed in the inner section of the water spout member 4052, slightly on the back-side of the water spout 4058.

In the present embodiment, the discharging end member 4060 rectifies and discharges the stream of flow sent through the water supply tube 4038. That is, the discharging end member 4060 discharges the discharging pattern as the rectified water of one bundle.

In the embodiment, the discharging end member 4060 and the water spout member 4052 configure a water spout unit 4066 together with the light projection section 4062 and the light receiving section 4064, which is described below.

Moreover, in the water spout unit 4066, the discharging end member 4060 and the water spout member 4052 are commonly fixed in the fixing hole 4068 provided in the water spout pipe 4012 by the fixing member 4067 shown in FIG. 34.

The fixing member 4067 is a circular push-button type member, and integrally has a circular outer circumferential wall section 4070, a first fitting convex section 4071 standing from the center section thereof, and a second fitting convex section 4072 of a small diameter protruding upward from the upper end of the first fitting convex section 4071. The fixing member 4067 is attached to the water spout pipe 4012 in a state of fitting the second fitting convex section 4072 to the through fitting hole 4074 of the discharging end member 4060, fitting the first fitting convex section 4071 to the through fitting hole 4076 of the water spout member 4052, and fitting the outer circumferential wall section 4070 to the circular fixing hole 4068 of the water spout pipe 4012. Thus, the fixing member 4067 fixes the discharging end member 4060 and the water spout member 4052 to the water spout pipe 4012 in the positioned state.

Additionally, as shown in FIG. 34(B), the fixing member 4067 has a pair of left-right claws 4078 when viewed from the front, and is stopped from the water spout pipe 4012 by engaging the claws 4078 to the edge section of the fixing hole 4068.

In FIG. 35, reference numeral 4080 is an optical fiber on a light emitting side, reference numeral 4082 is an optical fiber on a light receiving side, and the light projection section 4062 and the light receiving section 4064 are configured by the optical fiber 4080 on the light emitting side and the optical fiber 4082 on the light receiving side.

Additionally, the light projection section 4062 is provided with a lens 4084 for making the projected light have directivity.

Additionally, the optical fibers 4080 and 4082 are integrally provided with an annular convex section 4086 for fixing them to the water spout member 4052 in the axially positioned state.

In the present embodiment, the water spout member 4052 has a main body section 4088 and a cover 4090 that covers the upper face thereof.

The main body section 4088 is provided with deep holding grooves 4092A and 4094A extended in the axial direction of the optical fibers 4080 and 4082. Further, the corresponding shallow holding grooves 4092B and 4094B are also provided on the side of the cover 4090. The optical fibers 4080 and 4082 are fitted and held to the holding grooves 4092A, 4092B, 4094A and 4094B.

The holding grooves 4092A, 4092B, 4094A and 4094B are provided with concave sections 4096A, 4096B, 4098A and 4098B corresponding to the convex section 4086 of the optical fibers 4080 and 4082. The optical fiber 4080 is fixed and held to the water spout member 4052 in the axially positioned state by the concave and convex fitting between the convex section 4086 and the concave sections 4096A and 4096B, and optical fiber 4082 is fixed and held to the water spout member 4052 in the axially positioned state by the concave and convex fitting between the convex section 4086 and the concave sections 4098A and 4098B.

Further, the water spout member 4052 is provided with a light projection window 4100 of a U-shaped notch shape and a light receiving window 4102 in the front end thereof.

Further, the cover 4090 is integrally formed a pair of curved elastic arms 4104, and the cover 4090 is assembled to the main body section 4088 by elastically engaging the claws 4106 of the tips of the pair of elastic arms 4104 with the corresponding engaging protrusions 4108 of the main body section 4088.

In the present embodiment, the sensor is configured by the sensor main body 4048 shown in FIG. 32, the light projection section 4062 configured in the cord 4050 and the optical fibers 4080 and 4082 extended therefrom and the tip sections thereof, and the light receiving section 4064. When the sensor detects a detection target, normally, a hand provided by a user, the electromagnetic valve 4036 is opened under the control using the control section 4046, and water is automatically discharged from the water spout 4058 of FIG. 34.

When a user retracts a hand from the detection area by the sensor, the sensor does not detect the hand, and then the electromagnetic valve 4036 is closed under the control of the control section 4046, and the water discharge from the water spout 4058 is stopped.

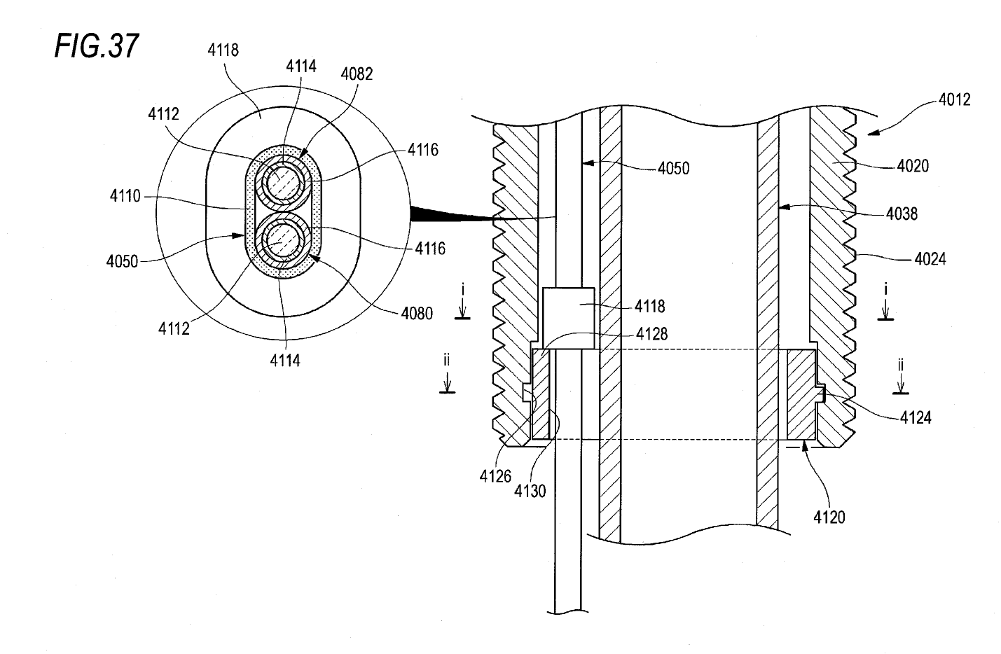

As shown in FIG. 37, the cord 4050 accepts the optical fibers 4080 and 4082 in the tube 4110 to form one cord.

In the present embodiment, the tube 4110 is formed from a thermal contraction tube.

The thermal contraction tube is known, by applying the heat to the inner section thereof in a state of passing the optical fibers 4080 and 4082, the thermal contraction tube is formed to a shape stored in advance, and wraps the optical fibers 4080 and 4082 from the outside in the close contact state.

In the present example, the thermal contraction tube is subjected to the bonding processing, and the inner face is bonded and fixed to the outer face of the optical fibers 4080 and 4082 in the contracted state.

Herein, as the thermal contraction tube 4110, a SUMI tube C (made of polyurethane) manufactured by Sumitomo Electric Industries, Ltd. is used.

In FIG. 37, reference numeral 4112 is a cord in the optical fibers 4080 and 4082, reference numeral 4114 is a clad, and reference numeral 4116 is a covering film covering them and is made from resin herein.

In the present embodiment, as shown in FIG. 37, in the inner section of the water spout pipe 4012 and in the position near the base end of the water spout pipe 4012, the cord 4050 is integrally formed with an engaging convex section 4118 protruding from the outer face thereof to the outside in the radial direction.

The engaging convex section 4118 is also made by the thermal contraction tube.

Specifically, by applying the heat in a state of setting the thermal contraction tube having a predetermined size in the axial direction to the outer face of the cord 4050, the thermal contraction tube is formed in a shape stored in advance, and, the engaging convex section 4118 is formed by bringing the tube close contact with the outer face of the cord 4050.

Herein, the bonding processing is performed in advance on the thermal contraction tube forming the engaging convex section 4118, and the tube contracted by the heating is bonded and fixed to the outer face of the cord 4050 by the adhesive and is integrated.

Thus, the engaging convex section 4118 substantially cannot be moved in the axial direction on the upside and the downside of FIG. 37 with respect to the outer face of the cord 4050. That is, the engaging convex section 4118 is integrally moved with respect to the cord 4050 in the axial direction.

Additionally, as the thermal contraction tube forming the engaging convex section 4118, SUMI tube W3C (made of polyurethane) manufactured by Sumitomo Electric Industries, Ltd. is used.

As shown in FIG. 37, the anti pull-out member 4120 is attached to the base end section (the lower end section) of the water spout pipe 4012.

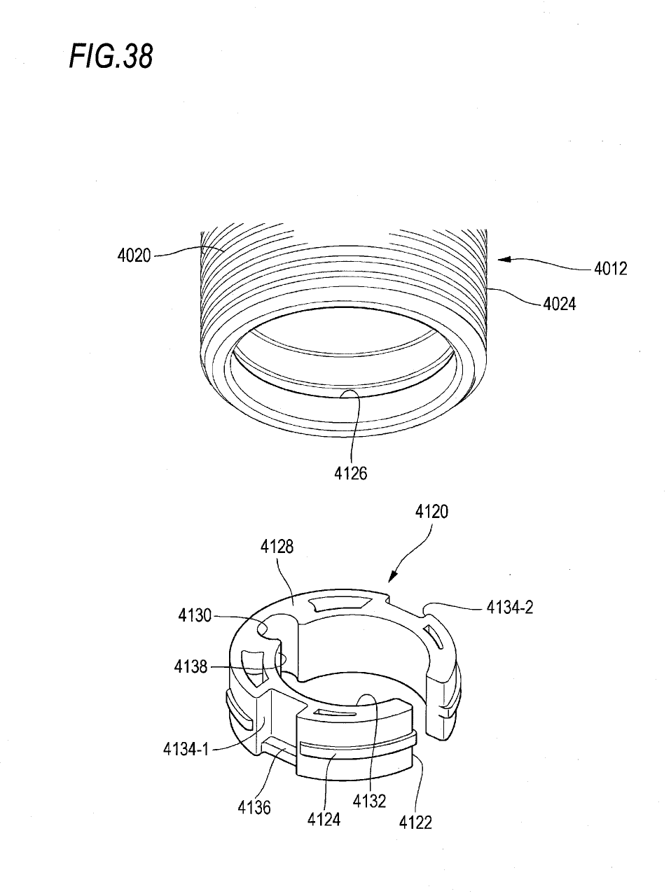

As shown in FIG. 38, the anti pull-out member 4120 is made of resin (herein, POM resin (polyurethane resin)) of a circular and C ring shape having an opening 4122 in a predetermined location in the circumferential direction, and thus has elastic deformability.

Herein, the anti pull-out member 4120 is in a free shape state before being attached to the water spout pipe 4012, and the outer diameter thereof is greater than the inner diameter of the insertion pipe 4020 in the water spout pipe 4012.

In the anti pull-out member 4120, a protrusion 4124 is integrally formed in a band shape along the outer circumferential face.

Meanwhile, the insertion pipe 4020 is formed with a groove 4126 corresponding to the protrusion 4124 extended along the inner circumferential face.

The anti pull-out member 4120 is pushed into the inner section of the insertion pipe 4020 in a state of being contracted and deformed, and fits the protrusion 4124 to the groove 4126 in the diameter-expanded state after the pushing and is attached to the insertion pipe 4020.

The anti pull-out member 4120 is integrally formed with a receiving section 4128 abutting the engaging convex section 4118 of FIG. 37 to the downward of the drawing. The receiving section 4128 is provided with a cord insertion port 4130 through which the cord 4050 is inserted.

The anti pull-out member 4120 is also provided with a tube insertion port 4132 through which a water supply tube 4038 is inserted adjacent to the cord insertion port 4130, and the cord 4050 and the water supply tube 4038 is inserted into the tube insertion port 4132.

The anti pull-out member 4120 axially positions the cord 4050 and the water supply tube 4038 in the inner section of the water spout pipe 4012, specifically, in the inner section of the insertion pipe 4020, by inserting the cord 4050 to the cord insertion port 4130, and by inserting the water supply tube 4038 to the tube insertion port 4132.

Herein, the anti pull-out member 4120 is housed in the inner section of the water spout pipe 4012 in a state of not being exposed to the outer section of the water spout pipe 4012.

On the outer circumferential face of the anti pull-out member 4120, longitudinal grooves 4134-1 and 4134-2 are provided in two locations separated by 180 degrees.

One groove 4134-1 is provided with catch section 4136 in the lower end of the drawing. Further, the similarly other groove 4134-2 is provided with a catch section 4136 in the upper end of the drawing.

The grooves 4134-1 and 4134-2 are used when detaching the anti pull-out member 4120 attached to the inner section of the insertion pipe 4020 from the insertion pipe 4020. Specifically, after inserting the tip of a tool such as a driver to the grooves 4134-1 and 4134-2, by applying the downward force to the catch section 4136, the anti pull-out member 4120 can be detached from the insertion pipe 4020 to the outside of the lower side.

Herein, the reason for providing the catch section 4136 in the reverse position up and down by the grooves 4134-1 and 4134-2 is that, even in a case where the anti pull-out member 4120 is reversed up and down and is attached to the insertion pipe 4020. That is, even in a case of attaching the anti pull-out member in either direction, by using all the groove and the catch section 4136, the anti pull-out member 4120 can be detached from the insertion pipe 4020. In other words, even when the anti pull-out member 4120 is in either direction in the up-down direction, it is attached to the insertion pipe 4020.

As shown in FIG. 38, the cord insertion port 4130 is configured so that a section of the side of the tube insertion port 4132 is partially formed as the opening section 4138, and the cord insertion port 4130 and the tube insertion port 4132 is continued in the opening section 4138.

Thus, when inserting the cord 4050 to the cord insertion port 4130, the cord 4050 can be fitted from the opening section 4138 to the cord insertion port 4130 and can be inserted thereto.

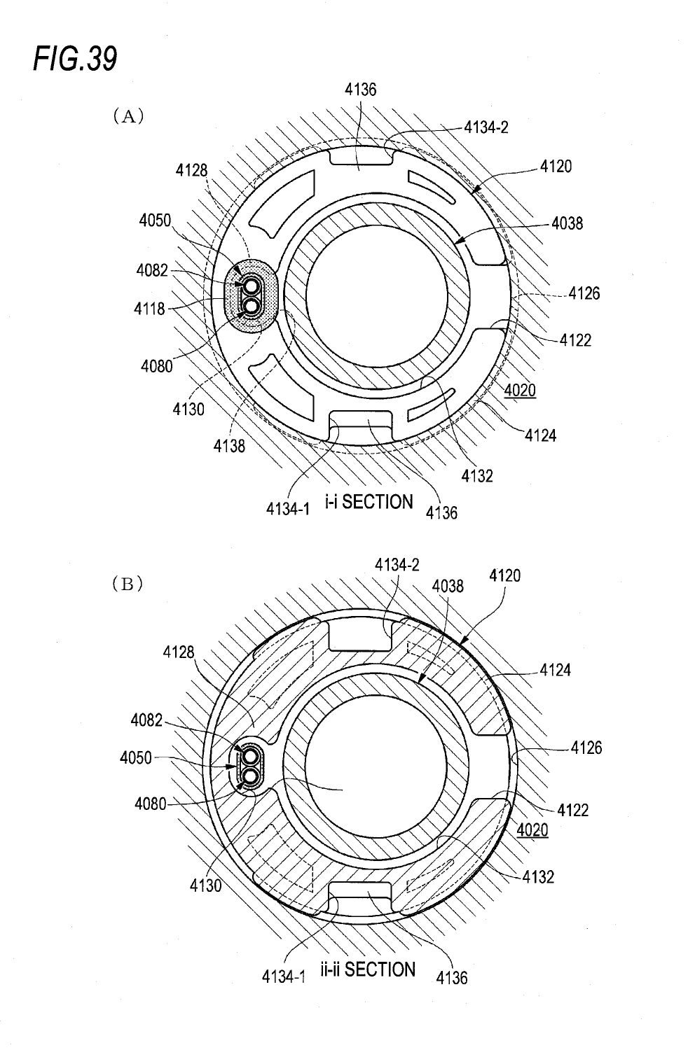

Further, the opening section 4138 is configured so that the opening width thereof is slightly narrower than the size of the long diameter side of the cord 4050 as shown in FIG. 39(B) and has the size of the opening width.

However, as shown in FIG. 39(B), under the state of inserting the water supply tube 4038 into the tube insertion port 4132, the water supply tube 4038 acts as a wall, and thus, it is substantially difficult to extract the cord 4050 from the cord insertion port 4130 through opening section 4138.

That is, in the present embodiment, the water supply tube 4038 inserted to the tube insertion port 4132 acts as a wall which suppresses the cord 4050 from being extracted from the cord insertion hole insertion port 4130.

Further as shown in FIG. 39(A), the cord insertion port 4130 has naturally the size in the radial direction smaller than that of the engaging convex section 4118 integrally provided in the cord 4050.

In the present embodiment, even when tension is applied to the cord 4050 in the extraction direction in the space of the lower section of the water spout pipe 4012, the tension is received by the contract between the engaging convex section 4118 and the receiving section 4128 of the anti pull-out member 4120, and the cord 4050 is stopped from the water spout pipe 4012.

That is, the engaging convex section 4118 and the receiving section 4128 has an extraction structure which suppresses the cord 4050 from being extracted from the water spout pipe 4012.

Moreover, by the anti pull-out mechanism, even when the downward tension is applied to the cord 4050 in the lower space of the water spout pipe 4012, the tension is not applied to the section of the inner section of the water spout pipe 4012 in the cord 4050, and thus the force is not applied to the light projection section 4062 and the light receiving section 4064 of the tip section of the water spout pipe 4012.

Meanwhile, the engaging convex section 4118 and the receiving section 4128 face each other in the up-down direction of the drawing as shown in FIG. 37, but they are not joined to each other. Thus, when the upward force is applied to the cord 4050, the cord 4050 can separates the engaging convex section 4118 from the receiving section 4128 to be moved in the upward direction.

In the present embodiment, the water spout unit 4066, the water spout tube 4038 and the cord 4050 can be assembled to the water spout pipe 4012 as below.

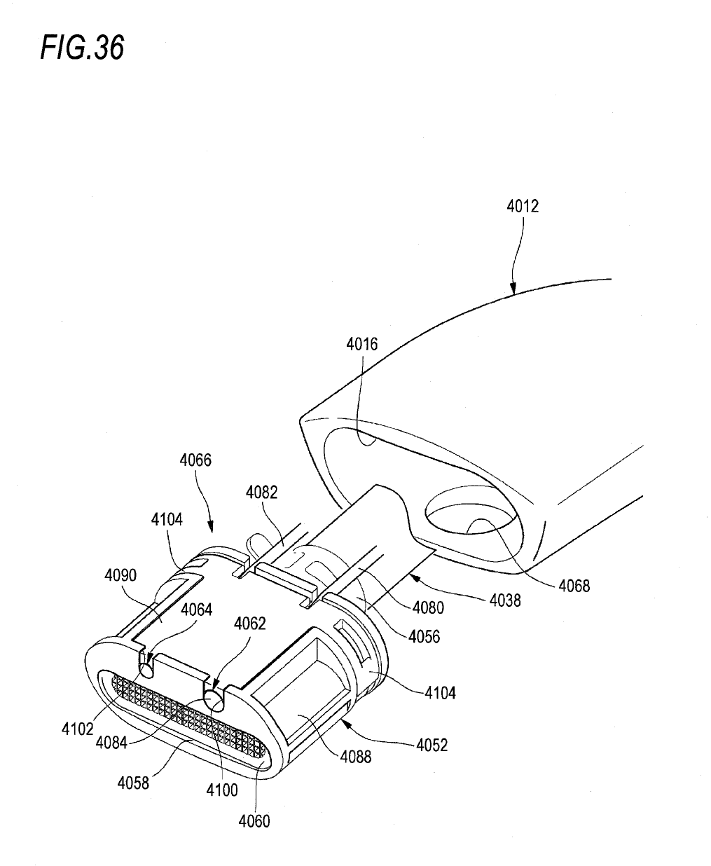

That is, as shown in FIG. 36, the discharging end member 4060, the water spout member 4052, the light projection section 4062 and the light receiving section 4064 are integrally assembled to form the water spout unit 4066, and in that state, the water supply tube 4038 and the cord 4050 are inserted into the water spout pipe 4012 than the opening 4016 of the tip of the water spout pipe 4012. Further, at the same time, the water spout unit 4066 is inserted from the opening 4016 into the water spout pipe 4012.

Moreover, the anti pull-out member 4120 forming the ring shape is assembled to the water supply tube 4038 and the cord 4050 projected downward from the water spout pipe 4012, and in that state, the anti pull-out member 4120 is pushed into the insertion pipe 4020 of the water spout pipe 4012 in the contracted and deformed state, thereby releasing the contraction force.

Then, the anti pull-out member 4120 returns to an original shape, and the diameter thereof is expanded. At this time, the protrusion 4124 of the outer circumferential face is fitted to the groove 4126 of the inner circumferential face of the insertion pipe 4020, and the anti pull-out member 4120 is assembled to the insertion pipe 4020, that is, the water spout pipe 4012.

At the same time, the cord 4050 and the water supply tube 4038 are inserted to the cord insertion port 4130 of the anti pull-out member 4120 and the tube insertion port 4132 in the inner section of the water spout pipe 4012, and they are radially positioned in the water spout pipe 4012.

In the present embodiment, in a case where there is a need to exchange the components of the light projection section 4062, the light receiving section 4064, the water spout member 4052 and the discharging end member 4060 due to the breakdown or when there is a need for other maintenances, the operations can be easily performed.

Specifically, in a state of being detached the lower end of the water supply tube 4038 and the cord 4050 from the function section box 4034 of FIG. 32, or in a state of detaching the fixing member 4067 from the water spout pipe 4012 and being released the fixing to the water spout unit 4066, by pulling out the water spout unit 4066 from the opening 4016 of the tip of the water spout pipe 4012 as shown in FIG. 36, the component exchanging and other maintenance works can be easily performed. 36, the component exchanging and other maintenance works can be easily performed.

At this time, since the cord 4050 can be freely moved upward in the inner section of the water spout pipe 4012, there is no problem that the anti pull-out mechanism causes the breakdown.

According to the present embodiment as mentioned above, even when the cord 4050 is stretched on the lower outside of the water spout pipe 4012, by the action of the anti pull-out mechanism, the tension is suppressed from being applied to the cord 4050 in the inner section of the water spout pipe 4012.

Thus, it is possible to suppress that the light projection section 4062 and the light receiving section 4064 are damaged by the tension, or the optical fibers 4080 and 4082 are cut or damaged in the connection section to the water spout pipe 4012.

Further, in the present embodiment, since the cord 4050 can be freely moved upward in the water spout pipe 4012, it is possible to easily perform the component exchanging and maintenance work without hindrance and at good workability when breaking down of the light projection section 4062 attached to the water spout pipe 4012, the light receiving section 4064, the water spout member 4052 and the discharging end member 4060.

In the present embodiment, the cord insertion port 4130 and the tube insertion port 4132 are provided in the anti pull-out member 4120, and the cord 4050 and the water supply tube 4038 can be radially positioned in the water spout pipe 4012 by the cord insertion port 4130 and the tube insertion port 4132.

Further, the cord insertion port 4030 is configured so that a part of the side of the tube insertion port 4132 is partially the opening section 4138 and the cord insertion port 4130 and the tube insertion port 4132 are continued in the opening section 4138. Thus, the cord 4050 can be fitted and inserted to the cord insertion port 4130 through the opening section 4138, and the water supply tube 4038 acts as a wall under the state inserting the water supply tube 4038 to the tube insertion port 4132. Accordingly, it is possible to appropriately suppress that the cord 4050 in the cord insertion port 4130 is extracted to the tube insertion port 4132 through the opening section 4138.

According to the present embodiment, since the cord 4050 is suppressed from being extracted from the opening section 4138, it is possible to avoid the need of separately providing a closing member in the opening section 4138. Thus, there is no problem that the number of the component is increased due to the provision of the closing member and the number of the process for the assembling thereof is increased.

Further, the water supply tube 4038 acts as the wall, thereby suppressing the cord 4050 from being extracted from the opening section 4138. Thus, the opening section 4138 can be formed to have a wide width. Accordingly, it is possible to more easily perform the fitting work of the cord 4050 to the cord insertion port 4130 through the opening section 4138.

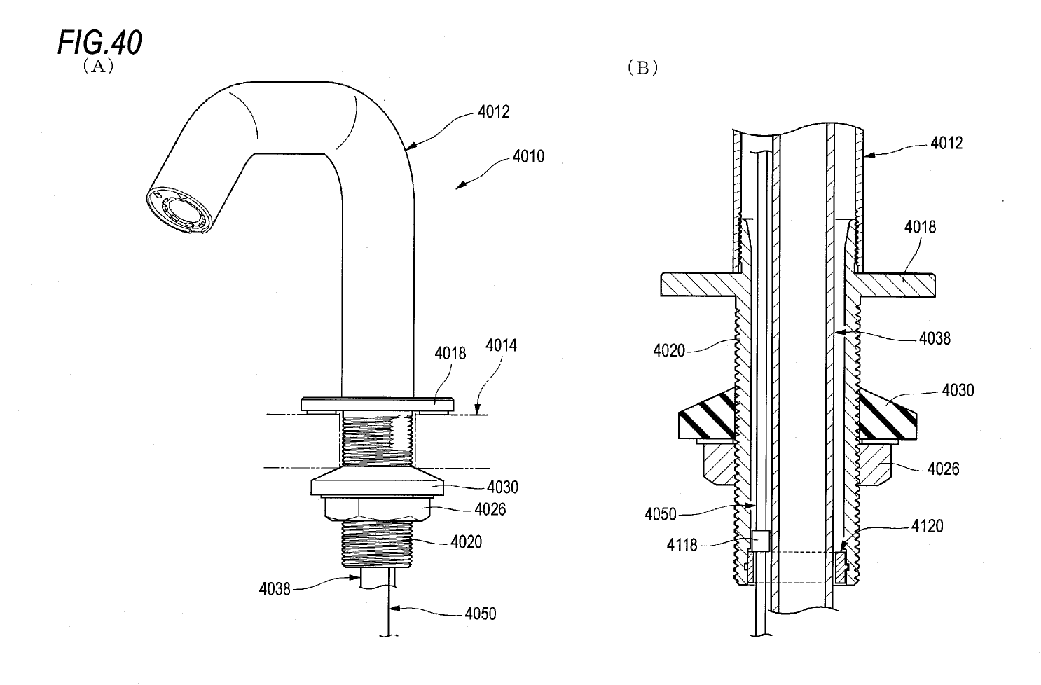

FIG. 40 shows another embodiment of the present invention.

This example is basically similarly to the embodiment mentioned above except that the water spout pipe 4012 has a taper shape of a circular cross-section, the insertion pipe 4020 is provided as a separate body with respect to the upper section positioned above the counter 4014 and is screwed to the upper section and that the flange-shaped seating section 4018 is provided in the insertion pipe 4020. The descriptions of the details thereof will be omitted.

The present embodiments of the present invention have been described in detail, but the present invention is not limited thereto.

For example, the present invention can also be applied to an automatic faucet of a type, in which a sensor main body is placed in a front end section, the cord of the electric wire is extended therefrom to the inner section thereof along the water spout pipe and is connected to the function section box in the lower space of the water spout pipe. Further, in the present embodiment, the anti pull-out member separated from the water spout pipe is attached to the water spout pipe, and the receiving section of the inner section of the water spout pipe is provided. However, it is also possible to provide the receiving section integrally with the water spout pipe according to the circumstances.

In addition, the present invention can be configured by the form added with various modifications in the scope without departing from the gist thereof.

The present invention has been described in detail or with reference to specific embodiments, but it will be appreciated by those skilled in the art that various modifications and alterations can be added without departing from the gist and the scope of the present invention.

This application claims priority to and the benefit of Japanese Patent Application No. 2009-281031 filed on Dec. 10, 2009, Japanese Patent Application No. 2010-125402 filed on May 31, 2010, Japanese Patent Application No. 2010-125401 filed on May 31, 2010, Japanese Patent Application No. 2009-281029 filed on Dec. 10, 2009, Japanese Patent Application No. 2009-281028 filed on Dec. 10, 2009, the contents of which are incorporated herein by reference.

### REFERENCE SIGNS LIST

10: automatic faucet
12: water spout pipe
16: opening
60: water spout member
66: sensor
1010: automatic faucet
1012: water spout pipe
1016: opening
1052: holding member
1058: water spout
1060: water spout member
1062: light emitting section
1064: light receiving section
1080, 1082: optical fiber
1100: light emitting window
1102: light receiving window
1156: receding face
2010: automatic faucet
2012: water spout pipe
2016, 2042: opening
2018: seating section
2038: water supply tube
2052: water spout member
2058: water spout
2060: water stream passing member
2062: light emitting section
2064: light receiving section
2100: light emitting window
2102: light receiving window
2112: air suction hole
2114A: standard face
2116: canopy section
2118: concave section
2122: through opening
2128: guide section
2128L: left guide section
2128R: right guide section
2130: longitudinal groove
2132: longitudinal guide face
2134: transverse guide face
3010: automatic faucet
3012: water spout pipe
3038: water supply tube
3052: water spout member
3054: insertion section
3058: water spout
3060: discharging end member
3067: fixing member
3068: fixing hole
3070: circumferential wall section
3072: fitting shaft section
3074, 3076: fitting section
3110, 3112: claw section
3114: elastic piece
3116: elastic claw
3126, 3128: fitting hole
4010: automatic faucet
4012: water spout pipe
4016: opening
4038: water supply tube
4050: cord
4058: water spout
4062: light projection section
4064: light receiving section
4066: water spout unit
4118: engaging convex section
4120: catch member
4128: receiving section
4130: cord insertion port
4132: tube insertion port
4138: opening section

1. An automatic faucet, which is provided with a water spout member and a sensor in a front end section that is a tip section of a water spout pipe, and which discharges water from the water spout member due to a detection of a detection target using a sensor,
wherein the water spout pipe has a shape, in which a portion of the front end side is directed forward and obliquely downward with respect to a user and an opening, which has an opening face intersecting with a pipe axis and forms a face facing obliquely downward, is formed on the front end face of the water spout pipe, and
wherein the water spout member and the sensor are inserted from the opening into the water spout pipe in a pipe axial direction, and the sensor is installed above the water spout member in a state where the front end face of the water spout member is positioned on the back-side of the water spout pipe than the front end face of the sensor.

2. The automatic faucet according to claim 1,
wherein the water spout member is placed in the water spout pipe so that the front end face of the water spout member is positioned on the back-side than the front end face of the water spout pipe.

3. An automatic faucet, which is provided with a light emitting section and a light receiving section of an optical sensor, and a water spout member in a front end section that is a tip section of a water spout pipe, and which automatically discharges water from a water spout due to a detection of a detection target using an optical sensor,
wherein the water spout pipe has a shape, in which a portion of the front end side is directed forward and obliquely downward with respect to a user and an opening, which has an opening face intersecting with a pipe axis and forms a face facing obliquely downward, is formed on the front end face of the water spout pipe, and
wherein the light emitting section, the light receiving section and the water spout member are inserted from the opening into the inner section of the front end section of the water spout pipe in a pipe axial direction in a state of being held by the holding member, each of the light emitting section, the light receiving section and the water spout member is extended to forward and obliquely downward, the light emitting section and the light receiving section are positioned above the water spout member, and the water spout of the front end of the water spout member is mounted in a state of being positioned in back-side of the water spout pipe than the light emitting window of the light emitting section side and the light receiving window of the light receiving section side, and
wherein a lower section leading to the light emitting window of the front face of the holding member is a face having a shape, which shifts to the back-side of the water spout pipe, as separating from the light emitting window toward the water spout side.

4. The automatic faucet according to claim 3,
wherein a lower section leading to the light receiving window of the front face of the holding member has a face having a shape which shifts to the back-side of the water spout pipe as separating from the light receiving window toward the water spout side and.

5. The automatic faucet according to claim 3,
wherein the light emitting window and the light receiving window are positioned to be projected forward from the front face of the holding member.

6. The automatic faucet according to claim 3,
wherein the light emitting section is configured by a tip section of the optical fiber on the light emitting side, and the light receiving section is configured by a tip section of the optical fiber on the light receiving side.

7. An automatic faucet, which is provided with a sensor which has a light emitting section and a light receiving section, and which automatically discharges water from a water spout based on a detection of a detection target using the sensor,
wherein a light emitting window for emitting light from the light emitting section toward the detection target and a light receiving window for receiving a reflected light from the detection target by the light receiving section are independently provided on the front face of an installation section of the light emitting section and the light receiving section to be separated from each other, and
wherein a portion of the front face of the installation section between the light emitting window and the light receiving window is a concave section having a recessed shape to the back-side as an opposite direction of a detection direction using the sensor than a flat standard face.

8. The automatic faucet according to claim 7,
wherein the light emitting window and the light receiving window are provided to be projected to a front side of the detection direction from a standard face in the front face of the installation section.

9. The automatic faucet according to claim 7,
wherein a cylindrical spout member forming the water spout is mounted to an inside of a tip section of the water spout pipe, the light emitting section and the light receiving section are installed in the water spout member, the light emitting window and the light receiving window are provided on the front face of the water spout member as the front face of the installation section, and
wherein the section of the front face of the installation section between the light emitting window and the light receiving window is the concave section.

10. The automatic faucet according to claim 9,
wherein the water spout pipe has a shape, in which a section of the front end side close to a user is directed forward and obliquely downward with respect to a user, the water spout member is inserted from the opening of the tip of the water spout pipe into the water spout pipe in a state of setting the front face forming the front face of the installation section to face obliquely downward, and in a state of positioning the front face to the back-side than a front end and a upper section of the water spout pipe, and
wherein in a position adjacent to the end of the water spout pipe and the upper section, the light emitting window and the light receiving window are placed on the upper section of the front face of the water spout member.

11. The automatic faucet according to claim 9,
wherein a water stream passing member, which is positioned in the tip of the water path to pass the water stream and controls a form of the discharged water, is held inside the water spout member forming a cylindrical shape, and
wherein the water stream passing member sucks the air from an air suction hole, involves the air in the passing water flow and discharges the air as a foam flow of a mixed air bubble from the water spout, and
wherein the concave section communicates with the air suction hole.

12. A water discharging device comprising:
(a) a water spout pipe;
(b) a cylindrical water spout member, which is mounted to an inside of a tip section of the water spout pipe and forms a water spout of a tip of a water path in the water spout pipe; and
(c) a discharging end member, which is placed in the water spout to pass a water stream and controls a water discharging pattern from the water spout,
wherein the discharging end member is inserted into the device by using the cylindrical water spout member as a housing, and each of the discharging end member and the water spout member is fixed to the water spout pipe by a common fixing member.

13. The water discharging device according to claim 12,
wherein a fitting shaft section is provided in the fixing member, a fixing hole passing through a pipe wall is provided in the water spout pipe and a fitting hole fitting the fitting shaft section is provided in the discharging end member and the water spout member in a state of overlapping each other in a direction of passing through the fixing hole and penetrating through the pipe wall of the water spout pipe, and
wherein the fitting shaft section of the fixing member is fitted from the outside of the water spout pipe through the fixing hole to the fitting holes of the water spout member and the discharging end member, respectively, and the discharging end member and the water spout member are fixed to the water spout pipe.

14. The water discharging device according to claim 13,
wherein the fixing hole has a hole diameter greater than the fitting holes of the discharging end member and the water spout member, and the fixing member is provided with a circumferential wall section of an outer diameter corresponding thereto, and
wherein the fixing member is attached to the water spout pipe in a state of fitting the circumferential wall section to the fixing holes.

15. The water discharging device according to claim 14,
wherein, in a position facing each other in the radial direction of the circumferential wall section, claw sections caught to an edge section of the fixing hole is provided in a shape projecting in the radial direction,
wherein one claw section is fixed to the circumferential wall section, the other claw section is provided in the tip of an elastic piece, and then an elastic claw is configured by the elastic piece and the claw section of the tip, and
wherein a claw section of the elastic claw is caught to the end section due to an elastic deformation of the elastic piece by the pushing of the water spout pipe.

16. The water discharging device according to claim 15,
wherein the fixing member is attached in a state where the pair of claw sections is positioned in a left-right direction when viewed from a front with respect to the water spout pipe.

17. The water discharging device according to claim 12,
wherein the water spout member has a cylindrical insertion section, and the insertion section is inserted into a flexible water supply tube arranged in the water spout pipe and is connected to the water supply tube.

18. An automatic faucet, which is provided with a sensor that projects light from a light projection section provided in a water spout pipe and receives a reflected light from a detection target by a light receiving section provided in the water spout pipe to detect a detection target, and which automatically discharges water based on the detection of the detection target using the sensor,
wherein an optical fiber or a cord of an electric wire configuring a part of the sensor is extended into the water spout pipe through an opening of a base end side of the water spout pipe,
wherein, in the cord, an engagement convex section projecting from an outer face of the cord to the outside in a radial direction is provided in a fixed state, a receiving section, which brings the cord into contact with the engagement convex section through the opening in a direction of being detached from the water spout pipe, is provided in the water spout pipe, and then an anti pull-out mechanism is configured to receive tension of the detaching direction applied to the cord by the engagement convex section and the receiving section and stops the cord, and
wherein the anti pull-out mechanism restricts the movement of the cord in the extraction direction, and allows the movement of the cord to separate the engagement convex section from the receiving section in an opposite direction.

19. The automatic faucet according to claim 18,
wherein an anti pull-out member separately formed from the water spout pipe is attached to an inner face of the water spout pipe, and the receiving section is formed of the anti pull-out member.

20. The automatic faucet according to claim 19,
wherein a water supply tube guiding the supplied water to the water spout is provided in the water spout pipe,
wherein a cord insertion port inserting the cord is provided in the receiving section of the anti pull-out member, and a tube insertion port inserting the water supply tube is provided in the anti pull-out member, and
wherein the anti pull-out member positions the cord and the water supply tube in the radial direction by the cord insertion port and the tube insertion port.

21. The automatic faucet according to claim 20,
wherein the cord insertion port and the tube insertion port are provided to be adjacent to each other, and the cord insertion port is configured so that a part of the side of the tube insertion port is partially formed as an opening section, and the cord insertion port and the tube insertion port are continued in the opening section.

22. The automatic faucet according to claim 19,
wherein the anti pull-out member has a ring shape having elastic deformability in the radial direction,
wherein the anti pull-out member is to be pushed into the water spout pipe in a diameter-reduced state and is attached to the inner face of the water spout pipe in a diameter-expanded state after the pushing.

23. The automatic faucet according to claim 19,
wherein the anti pull-out member is housed in the inner section of the water spout pipe in a state of not being exposed to the outer section of the water spout pipe.
